(19) United States
(12) Patent Application Publication
(10) Pub. No.: US 2015/0170209 A1
(43) Pub. Date: Jun. 18, 2015

(54) SYSTEM AND METHOD FOR ADVERTISING

(71) Applicant: ASTARICKS GROUP PTY LTD, Devonport (AU)

(72) Inventors: Allen Smith, Devonport (AU); David Smith, Devonport (AU)

(21) Appl. No.: 14/404,144

(22) PCT Filed: May 31, 2013
(86) PCT No.: PCT/AU2013/000576

§ 371 Date: Nov. 26, 2014

(30) Foreign Application Priority Data
May 31, 2012 (AU) 2012902270

(51) Int. Cl. G06Q 30/02

(52) U.S. Cl. CPC G06Q 30/0267

(57) ABSTRACT

A system and method for generating advertisements is described. The system and method selects from one or more advertisement templates. One or more advertisement types are selected from the one or more advertisement templates. One or more unique primary identifiers are associated with the advertisement and a secondary identifier is associated with each of the one or more unique primary identifiers.

### TECHNICAL FIELD

The present invention generally relates to a method, system, computer readable medium of instructions and/or computer program product for advertising.

### BACKGROUND ART

Advertising takes a number of formats and can, for example, be broadcast via internet, print or television. From a consumer point of view, it can be difficult to quickly and easily obtain information about the product and/or service that is being advertised. There exists systems such as QR codes which allow for information from an advertisement to be captured by a user for later reference, but a problem with these systems is that they require a mobile communication device which can read the codes and the codes themselves generally only provide basic information—none of which may be relevant to the consumer. QR codes also suffer from the drawback that they are difficult to capture with a mobile communication device in low light and impossible to capture at speed (such as driving past an advertisement with a QR code). Further, QR codes may be vulnerable to tampering (such as placing an alternative QR code over an existing QR code).

A further problem with advertising is that it can be difficult to obtain analytics of who has viewed the advertisement or who has interacted with the advertisement (particularly in print advertising).

Further, from an advertiser's point of view, it is difficult to control the dissemination of information once it has been released, if for example, details of the advertisement change (e.g. out of stock or in the case of a business card, a change of name or address).

It would therefore be desirable to provide a method system in computer readable medium of instructions which can alleviate or at least ameliorate one or more of the above problems.

Reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which the specification relates.

### DISCLOSURE OF INVENTION

According to a first aspect, the present invention provides a computer implemented method for generating advertisements including the steps of: selecting from one or more advertisement templates; selecting an advertisement type from the one or more advertisement templates; associating one or more unique primary identifiers with the advertisement; and associating a secondary identifier with each of the one or more unique primary identifiers.

Advantageously, the use of a primary and secondary identifier alone avoids the need to congest the advertising space with unnecessary details, all of which can be obtained simply by using the primary and secondary identifier.

In a further advantage, advertisements can be updated at any time by the owner of the advertisement. The primary and secondary identifiers may also be used in places of business as business cards or advertising cards, i.e., coupons, discounts etc. in which upon entering a store the user obtains and/or inputs the primary and secondary identifier such as on their mobile communication device for example and the coupon or business card or advertising card is then stored on their mobile communication device.

Preferably, the secondary identifier comprised of one or more of the advertising type, an advertising medium, a publication; a geographic location or an internal reference ID.

Part of the secondary identifier may indicate an advertising type, and another part of the secondary identifier contains an internal reference ID. Advantageously, an advertiser will know the type of advertisement as well as other data associated with the internal reference ID (for example, franchisee code, number of advertisements in that calendar year to identify that particular advertisement etc).

Preferably, the method further includes the step of modifying uploaded content in response to a request.

Preferably, upon receiving modified uploaded content, the method further includes the steps of providing the modified content to one or more users who have engaged with the advertisement. Advantageously, any user who has engaged with the advertisement can elect to receive a “push” notification when information associated with the advertisement has been updated.

Preferably, the method further includes uploading content to the advertising template and storing content in a database on a computer network.

Preferably, the advertising type includes advertising type includes a business card, online advertisement, physical advertisement, coupon, recipe, attractions, events, tours, advertisements for real estate, motor vehicles, accommodation, business listings, business departments, business divisions, classified advertisements, product information and specifications, catalogue, newspaper, magazine advertisements, timetables, resume's, billboard advertisements, personal contact information, yard sale advertisements, advertisements for apps, air, rail, road and/or sea travel advertisements, points of interest, dating or social media profiles, newspaper articles, magazine articles, restaurant menus, television and/or radio advertisements.

Preferably, the method further includes the step of providing one or more privacy options associated with the advertisement.

Preferably, the method further includes the step of providing one or more privacy options associated with the unique primary identifier.

Preferably, the method further includes the step of indexing the advertisement in the database such that the advertisement is searchable over the computer network.

Preferably, the unique primary identifier is any one or more of, a telephone number or an alias code associated with the telephone number.

Preferably, the alias code is alphanumeric text.

Preferably, the method further includes the step of providing payment for the advertisement based on any one or more of: advertising type, number of images associated with an advertisement, changes to details of an existing advertisement, time and date range of the advertisement, position of advertisement (e.g. top of page, bottom of page, first in list, last in list etc.), size of the advertisement or enhancements to the advertisement (e.g. bold text, extra color, a border, a frame, icon such as star or flag or tick or placard etc.)

Preferably, the method further includes the step of associating geographic coordinates with the advertisement.

Preferably, the method further includes the step of determining a location, address or geographic coordinate and associating it with the advertisement.

Preferably, the location, address or geographic coordinate is associated with the advertising content via one or more uploaded images, the uploaded images including geo-datum, extracting the geo-datum from each image and associating the geo-datum with the advertisement.

Preferably, the method further includes the step of dynamically updating an advertisement's geographical location via a GPS enabled device, RFID tag and/or wireless device.

According to a second aspect, the present invention provides a method of obtaining information from an advertisement including the steps of: receiving, via a mobile device, one or more unique primary identifiers and secondary identifiers, associated with one or more advertisements; storing the unique primary identifiers, secondary identifiers and GPS information on the mobile communication device.

The primary and secondary identifiers associated with the advertisement may be manually entered by a customer or may be automatically gathered.

Preferably, the one or more unique primary identifiers and secondary identifiers, associated with one or more advertisements are received on the mobile device via near field communication.

Advantageously, a user when walking or driving around a geographic location, can, without actively seeking any information, obtain information relating to an advertisement.

Preferably, the method further includes the retrieving via the unique primary identifier, advertisements associated with the unique primary identifier.

Advantageously, via the primary and secondary identifier, the user can either immediately obtain all of the information associated with the primary and secondary identifiers (i.e., the advertising—including pictures, audio, video etc.) or delay this decision for later so as to download the advertisements of interest on a Wi-Fi network for example (to save data usage on their mobile communication device). Advantageously, the use of the primary and secondary identifier allows the user the option to do both.

Preferably, the method further includes the step of selectively retrieving via the unique primary identifier, advertisements associated with the unique primary identifier based on GPS location.

Preferably, the method further includes the step of selectively retrieving via the unique primary identifier and secondary identifier, advertisements associated with the unique primary identifier based on a date range.

Preferably, the method further includes the step of selectively retrieving via the unique primary identifier and secondary identifier, advertisements associated with the unique primary identifier based on a time period.

According to a third aspect, the present invention provides a method of obtaining information from an advertisement including the steps of: receiving, via a mobile device, at least one primary identifier and at least one secondary identifier, associated with at least one advertisement; and storing the unique primary identifier and secondary identifier on the mobile communication device.

Preferably, the method further includes the retrieving via the unique primary identifier, advertisements associated with the unique primary identifier.

Advantageously, retrieving the primary and secondary identifier, does not require much data and a user can either immediately obtain all of the information associated with the primary and secondary identifiers (i.e., the advertising—including pictures, audio, video etc) or wait and download it at a later time.

According to a fourth aspect, the present invention provides a method of retrieving analytic information related to one or more advertisements including the steps of: providing one or more advertisements created according to the method of the first aspect; updating a database record each time a primary and secondary identifier associated with an advertisement is requested; identifying the advertisement data from the primary identifier; identifying analytical data from the secondary identifier; storing the number of requests associated with the advertisement; and providing analytical data based on the secondary identifier.

Preferably, the secondary identifier is comprised of on one or more of: the advertising type, an advertising medium, a publication, a geographic location or an internal reference ID.

Advantageously, the present invention assigns unique identifiers to each advertisement type to get more exact analytics for a given advertisement (e.g. that is published in one or more publications or advertising means in one or more countries, states, regions, cities or suburbs).

Preferably, the database record is further updated with the date, time and geographic location of the advertisement request.

According to a fifth aspect, the present invention provides a system for generating advertisements including: a client-server component for selecting from one or more advertisement templates; the client-server component providing one or more advertisement type for selection from the one or more advertisement templates; the client-server component associating one or more unique primary identifiers with the advertisement; and the client-server component associating a secondary identifier with each of the one or more unique primary identifiers.

According to a sixth aspect, the present invention provides a system for obtaining information from an advertisement including: a client-server component for receiving, via near field communication on a mobile device, one or more unique primary identifiers and secondary identifiers, associated with an advertisement; the client-server component storing the unique primary identifier, secondary identifiers and GPS information on the mobile communication device.

According to a seventh aspect, the present invention provides a system for obtaining information from an advertisement including: a client-server component for receiving, via a mobile device, at least one primary identifier and at least one secondary identifier, associated with at least one advertisement; the client-server component storing the unique primary identifier and secondary identifier on the mobile communication device.

According to an eighth aspect, the present invention provides a system for retrieving analytic information from an advertisement including: a database component for updating a database record each time a primary and secondary identifier associated with an advertisement is requested; the database component identifying the advertisement data based on the primary identifier; the database component identifying analytical data based on the secondary identifier; the database component storing the number of requests associated with the advertisement; and the database component providing analytical data based on the secondary identifier.

### BRIEF DESCRIPTION OF THE DRAWINGS

The invention will now be described in further detail with reference to the accompanying drawings. It is to be understood that the particularity of the drawings does not supersede the generality of the preceding description of the invention.

FIG. 1 is a schematic diagram showing a system and method for advertising according to the invention;

FIG. 2 is a schematic diagram of the architecture of the system and method for advertising including geographic location data according to the invention;

FIG. 3 is a schematic diagram showing the advertising creation process according to the invention;

FIGS. 4a and 4b is a flow diagram illustrating an example method of the invention in which an advertisement is created;

FIG. 5 is a flow diagram illustrating an example method of the invention in which advertisements are browsed;

FIGS. 6a and 6b is a flow diagram illustrating an example method of the invention for searching advertisements based on a primary and secondary identifier;

FIG. 7 is a flow diagram illustrating an example method of the invention for searching advertisements based on a keyword;

FIG. 8 is a schematic diagram illustrating the advertisement update process according to the invention;

FIGS. 9a and 9b is a flow diagram illustrating an example method of the invention for updating the advertisement;

FIG. 10 is a schematic diagram of security features associated with the advertisement according to the invention;

FIGS. 11a and 11b is a schematic diagram of card update according to the invention;

FIG. 12 is an exemplary screen shot of an advertisement in the form of a business card according to the invention;

FIG. 13 is a further screen shot of a number of business cards created by the method and system of the present invention;

FIG. 14 is a schematic diagram showing an advertising retrieval process according to the invention;

FIG. 15 is a flow diagram illustrating an example method of advertisement retrieval according to the invention;

FIG. 16 is a schematic diagram of proximity advertising according to the invention;

FIGS. 17 to 19 are further schematic diagram of examples of advertising by proximity;

FIG. 20 is a flow diagram illustrating an example method of analytics associated with the advertisements;

FIG. 21 is a schematic diagram showing a system and method for retrieving advertising without reference to proximity according to the invention;

FIGS. 22a and 22b illustrates a method of retrieving advertising without reference to proximity as shown in the system of FIG. 21;

FIG. 23 is a schematic diagram showing a system of the present invention for retrieving ‘push’ advertising based upon a user's saved search criteria with reference to proximity; and

FIGS. 24a and 24b illustrates a method of retrieving advertising with reference to proximity as shown in the system of FIG. 23.

FIG. 25 is a schematic diagram illustrating a user receiving an advertisement based upon a set proximity distance (radius);

FIG. 26 illustrates a method of a general (ad-hoc) search for advertisements based upon search criteria and limited by user defined proximity distance;

FIGS. 27a, 27b and 27c illustrates a method of distributing advertisements according to users' demographics, thresholds and/or users' location based upon wireless/RFID device tracking and proximity;

FIG. 28 is a sub-process associated with FIGS. 9a and 9b and illustrates the method of updating the geographical location of an advertisement;

FIG. 29 illustrates a method for the creation of user accounts associated with the advertising system;

FIGS. 30a and 30b illustrates a method of for determining the options and preferences available to a user within their advertising system account;

FIGS. 31a to 31g illustrates a method of sending and receiving advertisements via an email server and client configuration as shown in the system of FIGS. 11a and 11b.

FIG. 32 is an example screen shot of a web browser search result preview based upon an advertisement ‘real estate card’ template; and

FIG. 33 is an example screen shot of a web browser displaying the details within an advertisement search result based upon a ‘listing card’ advertisement template.

### DETAILED DESCRIPTION

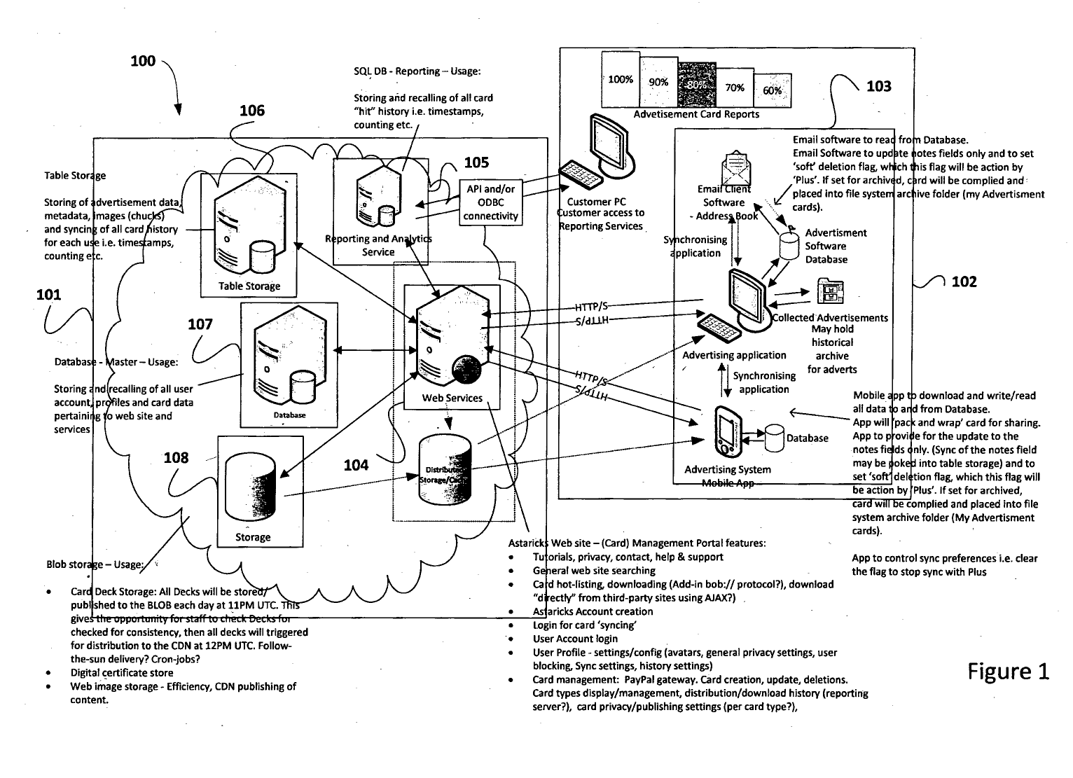

Referring to FIG. 1, there is shown an example system for generating advertisements 100.

The term advertisements may include print advertisements, internet advertisements, billboard advertisements, poster advertisements, business cards, company brochures, pamphlets, leaflets, television advertisement, radio advertisement, but for ease of reference, the term advertisement will be used.

When an advertisement template and any corresponding advertisement data is published via the advertisement system of the present invention, (whether the advertisement is published online or distributed to computer or mobile communication devices, or via printed media) this published data (and any associated graphical representation) may be referred to as a ‘Card’ for ease of reference.

The system 100 includes a server component 101, user component 102 and a customer component 103. The user 102 is typically the advertiser wishing to place an advertisement and the customer 103 is typically the customer who is interacting with the advertisement however, User 102 and customer 103 may be the one of the same and it will be appreciated that when the customer is also a user, user 102 may interact with the server 101 directly for the purposes of creating\editing\deleting advertisement and to receive\retrieve enhanced analytical data pertaining to user 102 advertisements. As an analogy, the user\customer being the same entity is similar to how one may perceive users of social networking\media computer systems where a user provides input and content yet the same user also receives and interacts with the input and content. The user 102 is connected to the server 101 through the usual means including the internet and using the method and system of the present invention can place or create one or more advertisements for use and offer to customers 103. The user 102 may be connected via computer software programs such as windows live, lotus live, office 365 or the like. The server 101 includes a number of components which may be included on a single server or may be spread out over a network and includes an Web Role 104 which is connected to the user 102 (which may include an API [Application Program Interface]) and customer 103 (client-side). The web role 104 is connected to a number of other components, namely a reporting service 105, storage table 106, master database 107 and storage blob 108. Reporting services 105 may interact with the customer/client-side 103 directly to report through the Reporting Services component 105 and so that the customer/client-side 103 can also connect via standard Open Database Connectivity (ODBC) and use third-party reporting software such as Crystal Reports. The storage blob 108 includes storage for individual cards or a group of cards, web image storage and temporary image staging during advertisement creation. The master database stores and recalls user account profiles and advertising data. The storage table 106 stores and synchronises all advertising history for each use (time stamps, card counting). The reporting service 105 provides reporting and analytical services such as advertisement “hit” history, time stamp counting and the like. It will be appreciated that the architecture of the server 101 may be implemented in any number of ways and this is but one example. The customer 103 connects to the server 101 via a computer or mobile communication device and in the case of advertisements in the form of business cards may interact via a computer and email program such as Microsoft® Outlook®. Alternatively, via a mobile communication device, the customer 103 can sync advertisements or business cards with a personal computer. The group of cards may be a collection of up to 100 cards in one ‘file’ that all relate to a particular product (or service) category (e.g. electronics, hardware, magazines, motors, classifieds or coupons). A group of Cards in one ‘file’ will hereafter be referred as a ‘deck’. Users may subscribe to one or more decks and will receive the one or more decks automatically via the software application on a predetermined time schedule, which could be on a daily basis depending on parameters or preferences.

Customers (business or personal, depending on the deck) may bid for the top slot (card #1) and then depending on the order of the bidders the highest bidder wins top slot and the others are allocated to slot positions in descending order depending on their bidding price. Also, there may include two ‘wild’ cards which the system will randomly pick out and insert into the end slots for each deck's category. The decks are preferably pre-built and stored on BLOB/CDN storage to ensure fast delivery to users hourly or daily.

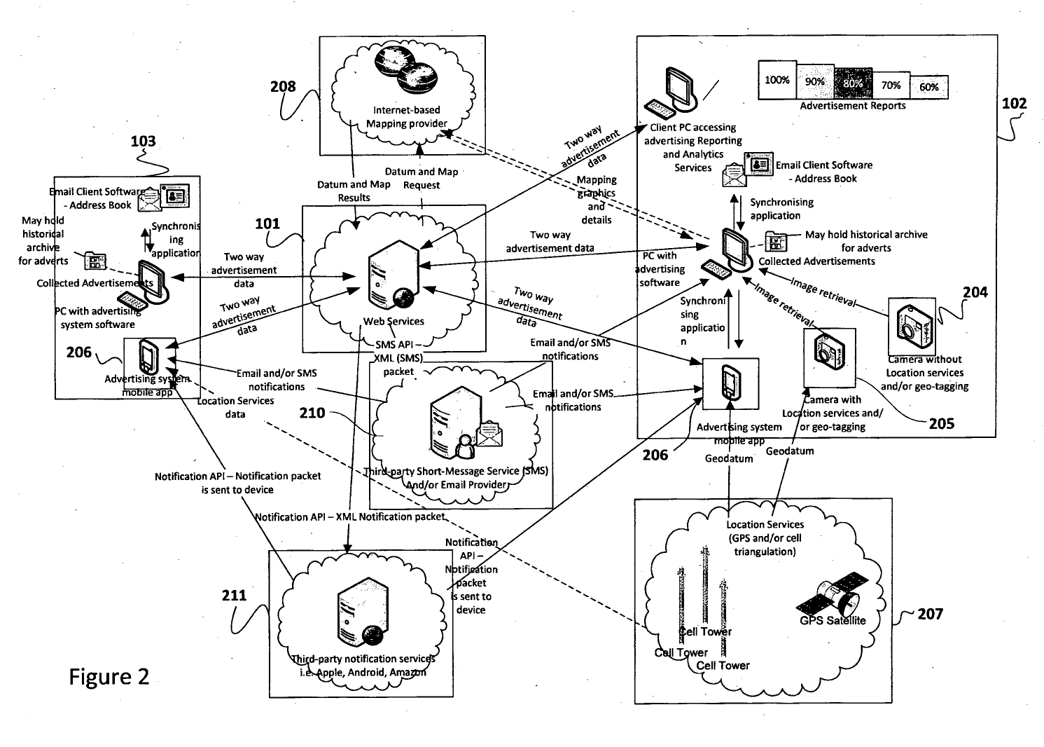

FIG. 2 is a schematic diagram of the general architecture for creating an advertisement according to the invention and utilising location services, such as GPS, wireless triangulation or mapping. The system includes a user 102 who may wish to create an advertisement by accessing the system via a personal computer or via mobile communication device 206. As noted above, it will be appreciated that user 102 and customer 103 may be one and the same and that a customer 103 may interact as a user 102 with the server 101 directly for the purposes of creating\editing\deleting advertisement and to receive\retrieve enhanced analytical data pertaining to user 102 advertisements. Customer 103 may access the system via a personal computer or via a mobile communication device 206, digital camera 205 having GPS data or a digital camera without GPS. The system includes a server 101, third party SMS or email provider 210, third party notification services 211 and an internet based mapping provider 208 all of which are connected to the server 101. The user 102 interacts with the web server 101 or 104 to place or create an advertisement and may associate this advertisement with a particular geographic location. The location of the user 102 and the advertisement may be determined by location services 207, such as via GPS and cell tower triangulation using a programmatic location update feature (check-in) contained within the software application or web site the user 102 can manually assign coordinates using an internet-based mapping provider 208 to determine the coordinates or assign the coordinates to the advertisement via a mobile communication device 206 or digital camera 205 having location services features or a digital camera without location services 204. If the user 102 chooses to use digital camera device without location services 204 the user 102 transmits (uploads) to the server 101 the desired digital images and the associated longitude and latitude coordinates for each image's subject matter, whereby the coordinated were manually obtained via internet-based mapping provider. The user 102 then completes the advertising updating process by reviewing the location of the item on the displayed digital map. If the location is accurate the user 102 then confirms the advertising update, web server 101 receives the update confirmation and triggers the database server 107 to set an ‘update’ flag against all records pertaining to each customers 103 with the advertisement, customer 103 will then receive a notification from email server 210 and\or notification server 211. In the event that a customer 103 doesn't hold the update advertisement, if the customer 103 has proximity enabled advertisements on device 103 or device 206 then depending on the customer 103 advertisement proximity preferences the user can receive the advertisement when the proximity thresholds have been met.

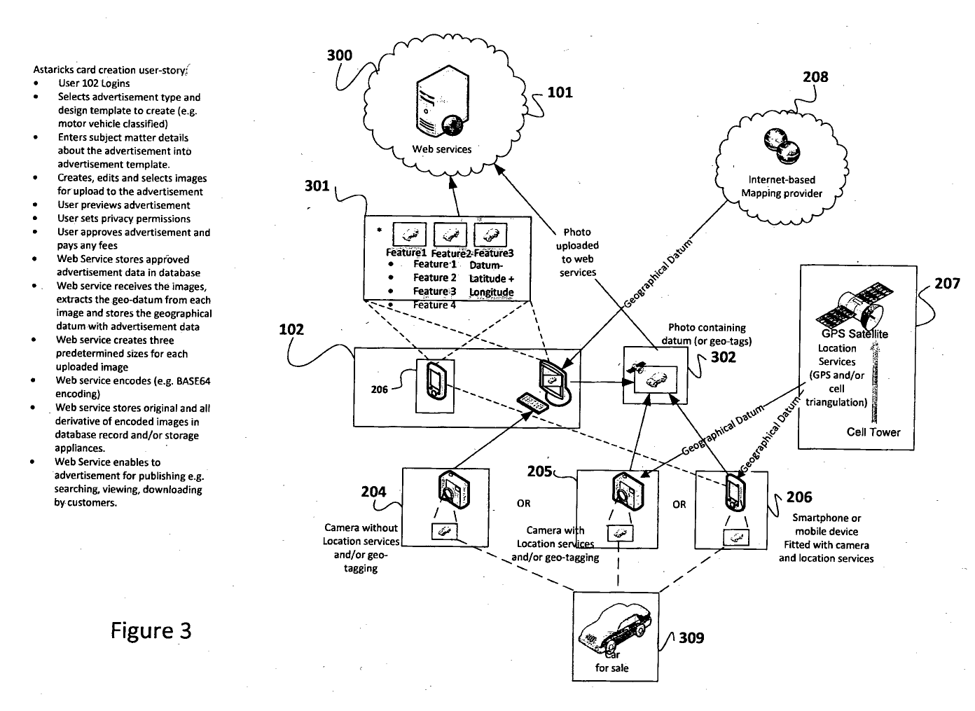

FIG. 3 shows an advertisement creation process in which a user 102 logs into the system via server 101 and selects one or more types of advertisements 301, 302 or 303 to create. At this point the user 102 may also select a template associated with the advertisement type and uploads information including images, sounds, video as required by the template. The user may also set privacy permissions associated with the advertisement and once satisfied with the advertisement, pays for the advertisement and the web server stores the advertisement and the details and optionally stores geographic location information associated with the advertisement. The advertisement is publicly available and is associated with a unique primary identifier and a secondary identifier. The primary identifier may include a phone number, for example but the secondary identifier will identify the type of advertisement or location of the advertisement. Various customers in the form of customers associated with a computer 304, or a camera 305 in a shop 306 in a location based enabled camera device 307 or in a mobile communication device 308 or in a vehicle 309 can interact with the advertisement and obtain details of the advertisement via GPS 310 when required.

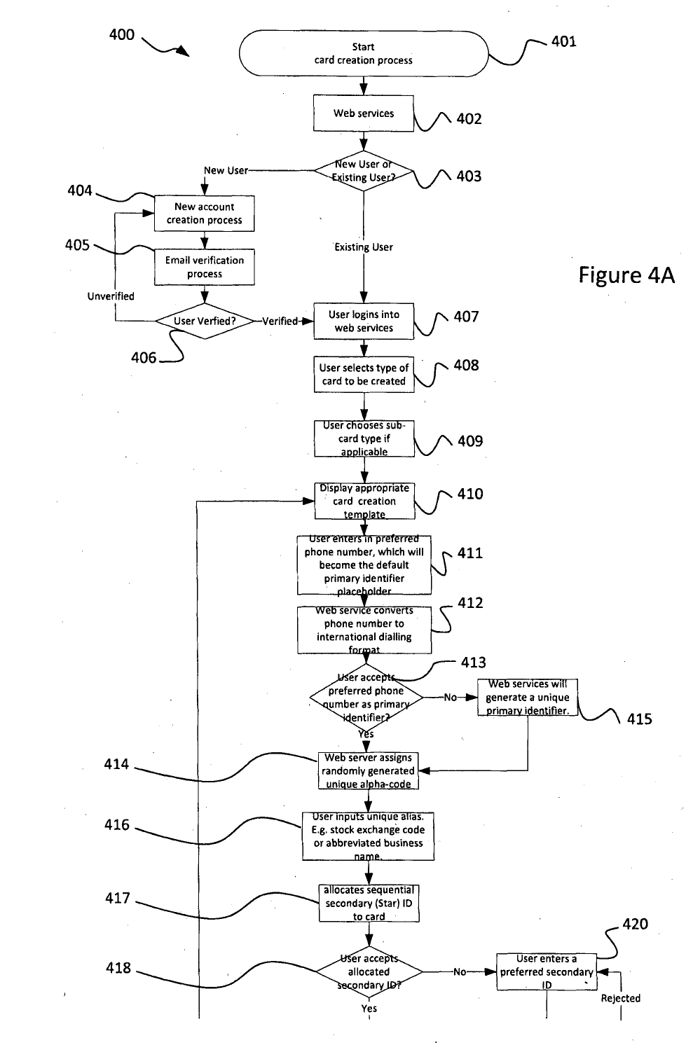

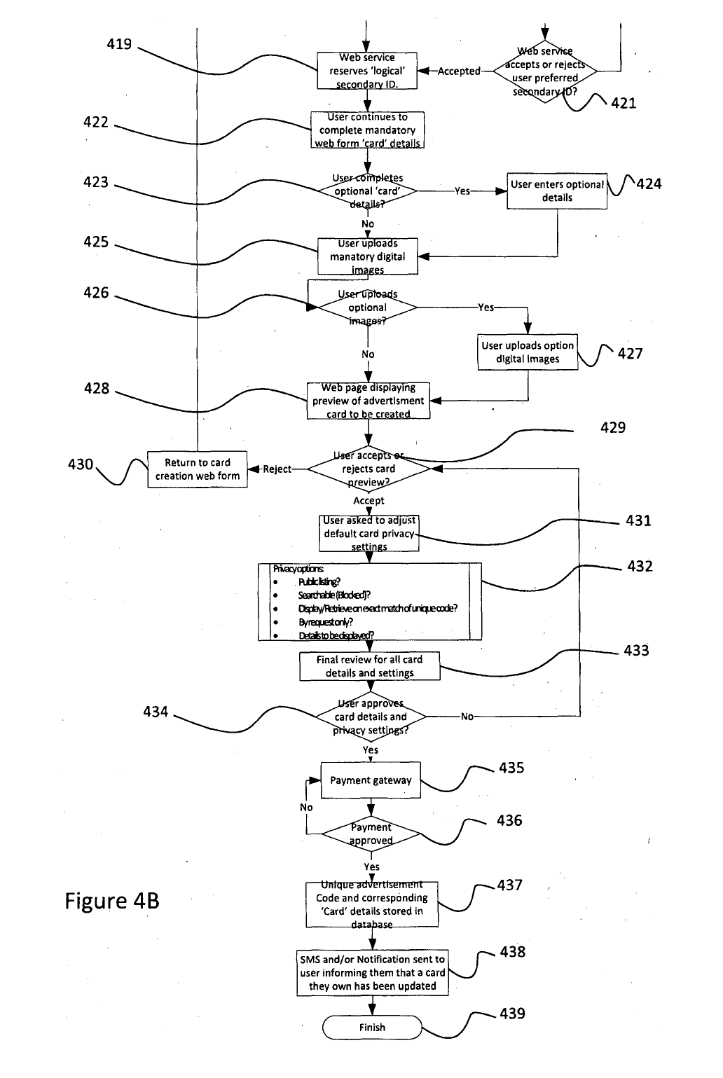

FIGS. 4a and 4b shows a method 400 for creating an advertisement by user 102. The method starts at step 401 where the user 102 contacts the server 101 and the server determines whether or not the user is an existing user or a new user at step 403. In the event the user is a new user control moves to step 404 where a new account creation process is carried out and then at step 405 the user is verified via email. At step 406 it is determined whether or not the user is verified. If the user is not verified control moves back to step 404, otherwise control moves to step 407 where the user logs into the server 101. Control then moves to 408 where the user selects the type of advertisement they wish to create and at step 409 the user can select a further sub-type of advertising where relevant. Sub-type advertisements may be the categories for the main advertisement (or card) types, for example the main category ‘Advertisement’ has multiple sub-categories such as Radio Advertisement, TV Advertisement, Newspaper Advertisement. Advantageously, the present invention assigns unique identifiers to each advertisement type to get more exact analytics for a given advertisement (e.g. that is published in one or more countries, states, regions, cities and suburbs).

At step 410 an advertisement template is displayed and the user is prompted for their corresponding, preferred phone number, which will become the placeholder default for a unique primary identifier at step 411.

Control moves to step 412 where the system then converts the telephone number, into an International dialling format. At step 413 the user is prompted to accept the preferred phone number as the default primary unique identifier. In the event they accept, control moves to 414 or if there is an error, control moves to 415 whereby the web services will generate a unique primary identifier. The unique primary identifier is preferably a telephone number but may include a number generated by the database 104 or on the server 101 which can then be assigned as the ‘unique identifier’ data type′ and input to a field for each database record\advertisement. The “public” unique primary ID is preferably a phone number, but advantageously there may be not one but two unique aliases—whereby control moves to 414 whereby the system may randomly generates one alias (which may be a unique alpha-code a such as ‘QsdEDt’) and, for the second alias, control moves to step 416 to allow for a customer chosen keyword (which must be unique). Advantageously, these aliases may conceal the telephone number type primary identifier in the event an owner doesn't want to have their phone number publicly available. This also means that there is the opportunity to have all three primary identifiers or just one primary identifier published for each advertisement. In a further advantage, the use of an alias may allow the advertiser to more easily engage with a potential customer since the primary identifier could be text related to the product (e.g. PIZZA) or to the brand itself (e.g. PIZZAHUT). Advantageously, a customer viewing the advertisement need only remember the details of the secondary identifier to obtain access to an advertisement for example (since presumably the brand will be memorable).

At step 417 the server 101 allocates a secondary identifier to the advertisement. The secondary identifier may include a numerical value that is preferably unique (or at least unique in combination with the primary identifier). A unique primary identifier may have one or more secondary identifiers. At step 418 the user is prompted to accept or reject the proposed secondary identifier. The secondary identifier must be unique for each associated primary identifier. In the event the user accepts, control moves to step 419, otherwise at step 420 the user is allowed to enter a preferred secondary identifier. Control then moves to step 421 where the server 101 accepts or rejects the preferred secondary identifier added by the user. In the event the secondary identifier is accepted by the server 101 control moves to step 41917, otherwise control returns to step 420 where the user is prompted to enter another star secondary identifier. At step 419 the server 101 reserves “logical” secondary identifier. Preferably, the secondary identifier is reserved and recorded in the system such as storing the information in a cookie on the user's system but verify its uniqueness each time the creation method is carried out (in the event there are multiple administrators for each account and to avoid a ‘reserved’ code conflict.

At step 422 the user 102 continues to complete any mandatory web form advertising details. Mandatory details may be, for example, the advertisement (sub) type, product or service categories, user contact details and advertisement title. For each type there maybe additional predetermined mandatory fields in order to stop users from paying once and then editing an advertisement to display a new advertisement for the same code. For example a motor vehicle ad might have a mandatory VIN field but not the registration number because it's no longer registered. For a house, the address field may be mandatory, but there are many household features available for selection in the creation form. Specifying mandatory fields simplifies and speeds up the advertisement creation process. Then the user can log back in and add/update the features and upload images when they have more time.

Control then moves to step 423 where the user 102 completes optionally advertising details which will be dependent on advertising type. In the event the user wishes to complete optional details control moves to step 424, otherwise control moves to step 425 where the user 102 uploads mandatory images associated with that template. Mandatory images will be dependent on advertising type. For example advertising types with mandatory images may include: listing cards: business logo and generic business card or, personal portrait if one or the other are not available (i.e. a sole trader my not a have registered business name); business cards: business logo or personal Business card or personal portrait; advertising cards: item/product image and, business logo or generic business card; tourism cards: item/product image and, business logo or generic business card; real estate cards: front of house and, if a commercial seller must include business logo or generic business card; motors vehicle advertisements: image displaying no less than 50% of vehicle and, if a commercial seller must include business logo or generic business card. It will be appreciated that all cards will have a linked business or personal card to enhance security and traceability. Some types of advertisements may not include mandatory images such as personal cards or dating cards/advertisements.

Control then moves to step 426 where the user is prompted to upload optional images. Optional images will be dependent on advertising type. Optional images may include for example: listing cards, tourism cards, real estate cards, motor vehicle cards and business cards may include: shop front, map, web site thumbnail, product #1, product #2, product #3 etc.; general advertising cards: shop front, map, web site thumbnail, product image #2 and up to 20 images;

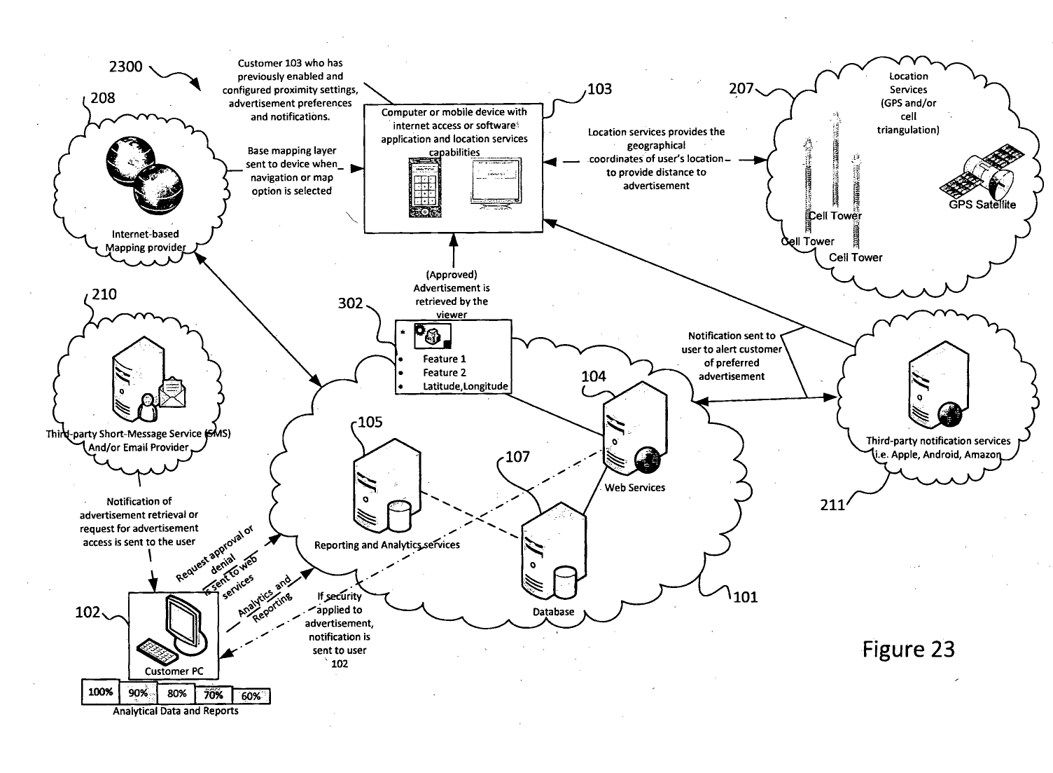

In the event the user accepts control moves to step 427 otherwise control moves to step 428. Server 101 displays a preview advertisement to be created. At step 429 the user has the option to accept or reject the preview provided by the server 101. In the event the user rejects the preview, control moves to step 43028 where the user is then prompted to return to the creation web form at step 410. In the event that the user accepts the preview control moves to step 431 where the user 102 is ask to adjust default advertisement privacy settings. Typically, all advertising types will have the same privacy settings. In the context of a coupon, for example, if there are coupons that a user wants to put some publishing/visibility restraints on then they our choose “request only” so they can collect the email address (and perhaps details) from the customer before offering the coupon. Alternatively or in addition, they can request PIN protection for the coupon and change the PIN when necessary so control the release of the coupon. Furthermore, they can choose not to list/display the coupon on the web site. This means that they can distribute an alias code to their own internal email distribution lists. This is in effect the same principle applied to all types, and could include a business card, or any other type of advertising. It is also possible by using location services/proximity distribution of coupons, users put in shopping preferences, interests, wants, needs and desires and if an advertisement is created matching those products these advertisements may pushed to the users. Advantageously, the advertisement creator can specify to push ads based on proximity-push only (which will be described further with reference to FIG. 23), to try and capitalise on an impulse purchase for example.

At step 432 the user can set a number of privacy options relating to the advertisement they have created, namely whether or not the advertisement is publicly listed, whether or not the advertisement is searchable, whether or not the advertisement is visible only on an exact match of the primary and secondary identifiers, whether or not the advertisement is visible by request only and finally whether or not details of the user are displayed or which details of the user are displayed.

Once the user 102 has made these selections control moves to step 433 where there is a final review for all advertising details and advertising settings and then control moves to step 434 where the user is prompted to approve the advertising details and the privacy settings. At step 434 if the user disagrees, control returns to step 429 where they can accept or reject the advertising preview, otherwise control moves to step 435 which is a payment gateway and the user makes payment. If the payment is approved at step 436 control moves to step 437, otherwise control returns to step 435. At step 437 the primary and secondary identifier associated advertising details are stored in the database on the server 101. At step 438 a notification may be sent to the user 102 informing them that the advertisement they own has been created or updated (as the case may be). This notification may be by SMS or via email. Control then moves to step 439.

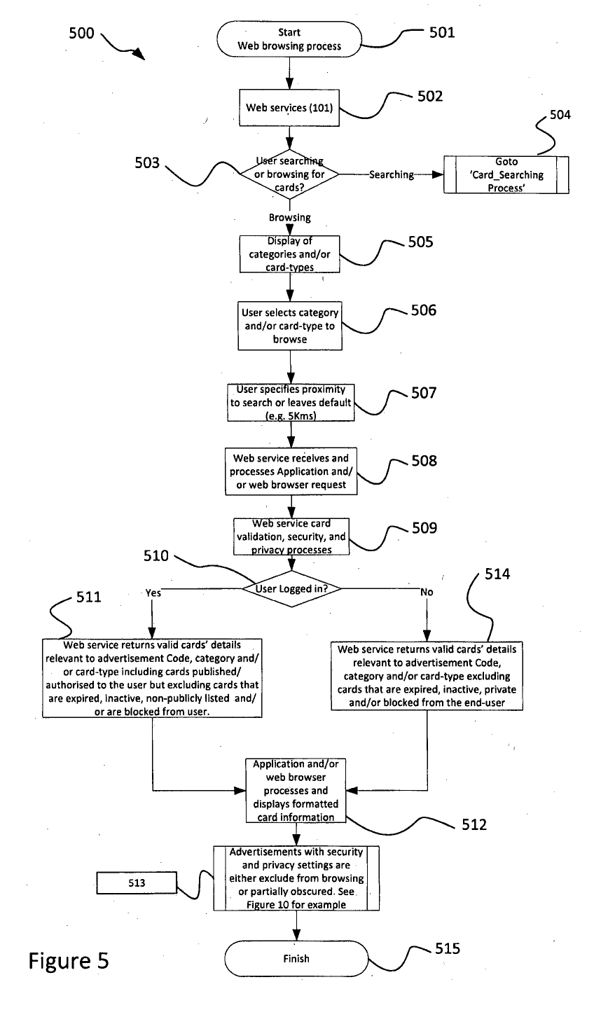

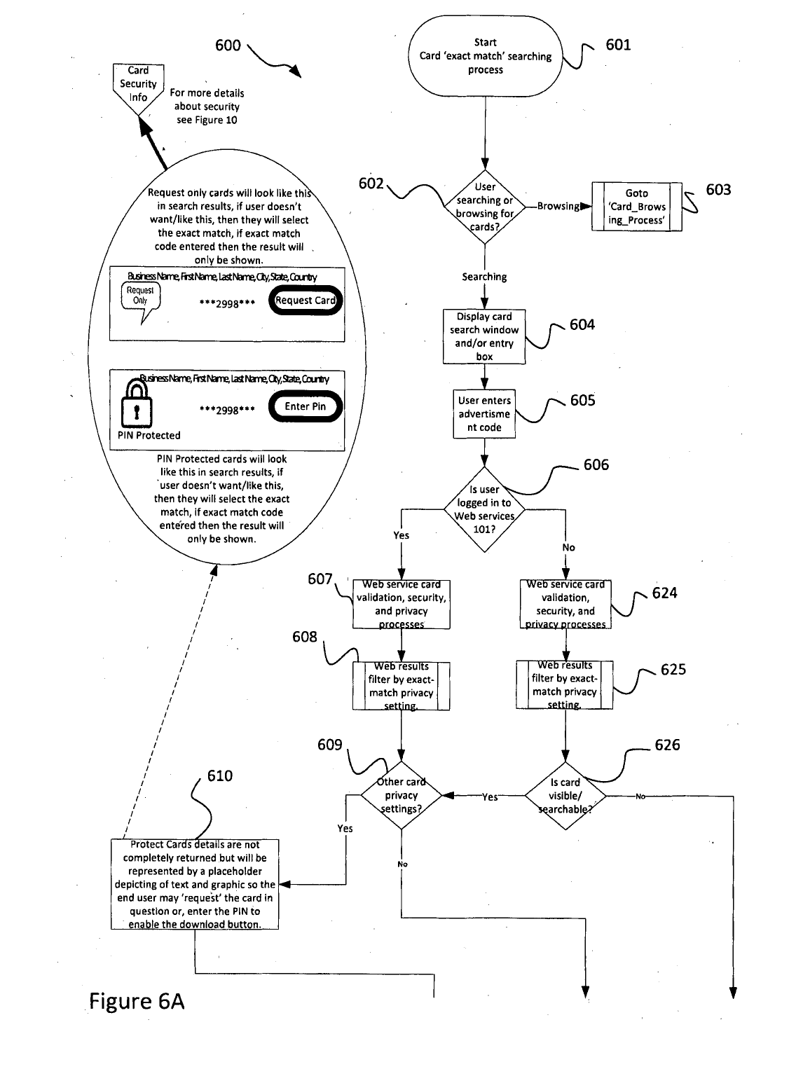

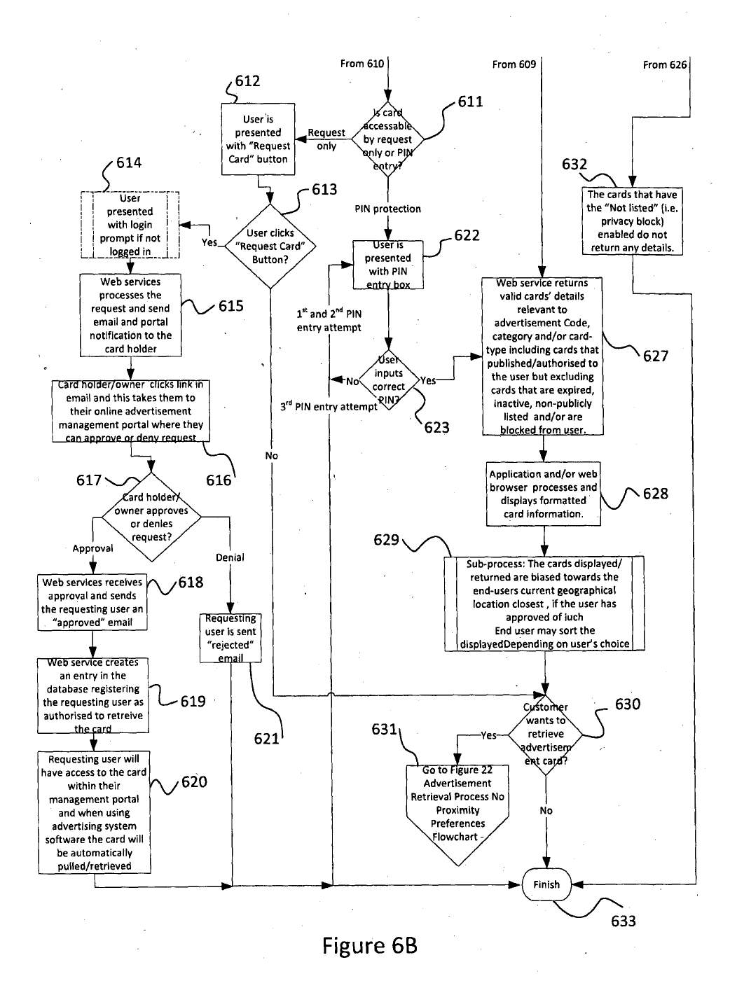

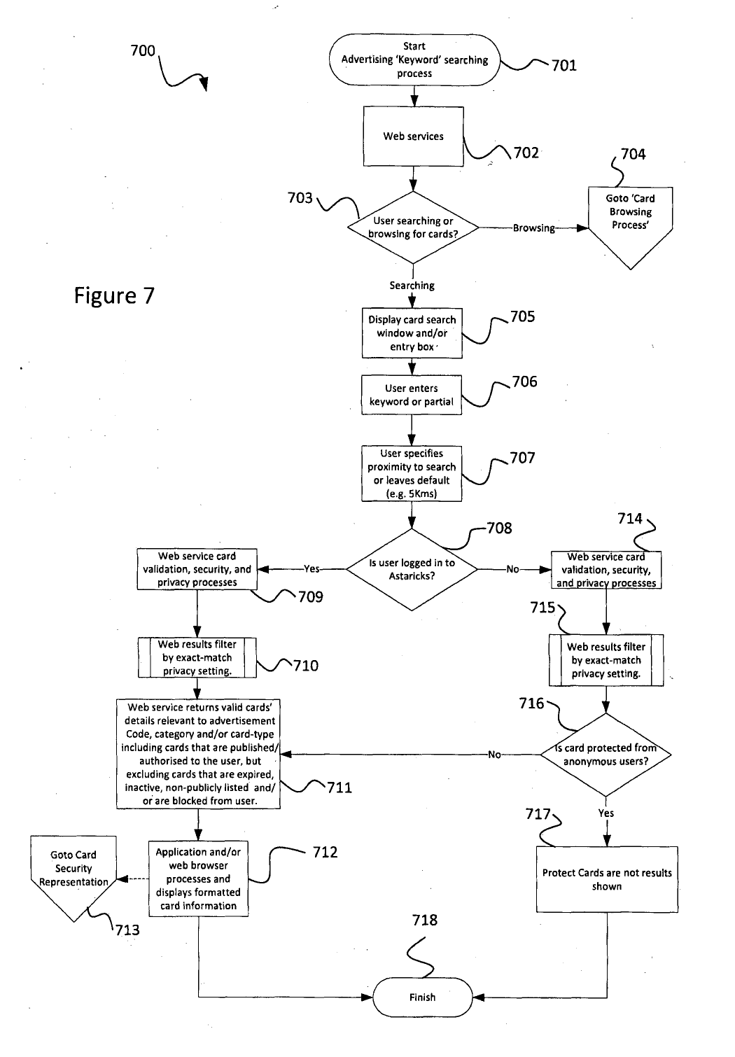

FIG. 5 is a flowchart illustrating a method of browsing one or more advertisements which were created by the process of FIG. 5. The method 500 starts at step 501 in which a user 102 or a customer 103 wishes to browse advertisements. At step 502 the user or customer accesses the web services which may be associated with server 101 and may be viewed by the user or by the customer on a computer or on a mobile communication device. At step 503 it is determined whether or not the user or customer wishes to search or browse for advertisements. In the event the user wishes to search for advertisements, control moves to step 504 which initiates a searching process which will be further described with reference to FIGS. 6a, 6b and 7.

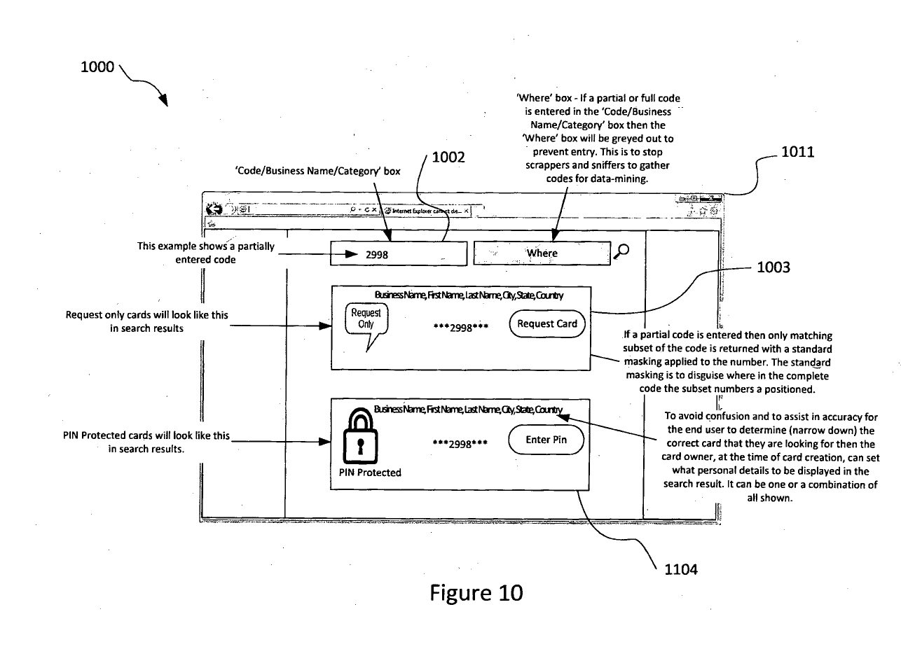

In the event the user wishes to browse for advertisements, control moves to step 505 where a display of categories and/or advertising types is provided. Control then moves to step 506 where the user may select the category and/or advertising type to browse. Control then moves to step 507 where the user may specify a proximity to searching or leave as default. For example the user may elect to have a default radius of 5 km from their location (which may be provided by the user or may be via GPS location services on a mobile communication device). Control then moves to step 508 where the server 101 receives and processes the request from the user and control moves to step 509 where the server 101 checks the advertising validation, security and privacy (further described with reference to FIG. 10), in that only advertisements which have been determined to be viewable under certain circumstances will be viewable by a user depending on who the user is, for example. At step 510 the method queries whether or not the user or customer is logged in since this may determine whether or not the user or customer can see certain advertisements. If at step 510 the user is not logged in, control moves to step 514 where the server 101 returns advertising details relevant to code or category or advertising type based on the fact that the user is not logged in and then at step 512 the information is displayed to the user. If at step 510 the user or customer was logged in, the server 101 returns advertising details relevant to the unique primary and secondary identifier category or card or advertising type but excludes advertising that is expired, inactive, non-publicly listed and/or blocked from that user

Following step 512 depending on the visibility of the various results of advertisements, control moves to step 513 whereby any security and privacy settings applied to an advertisement may prevent the advertisement being display or obscure details, all of which will be further described with reference to FIG. 10. Control then moves to step 515.

FIGS. 6a and 6b shows a method according to the invention for searching for an advertisement based on a unique primary and secondary identifier. The method starts at 601 where an exact match is requested by a customer or user. Control then moves to step 602 where it is determined whether or not the user/customer is searching or browsing for advertisements. In the event the user is browsing for advertisements control moves to step 603 which is further described with reference to FIG. 5. However, in the event the user/customer is searching for advertisements control moves to step 604 where a search window or dialog box is provided. At step 605 the user/customer enters the unique primary and secondary identifiers relevant to the advertisement.

Primary and secondary identifiers in advertising may include façade signage on a place of business, for example in which a phone number is provided as a primary identifier and a secondary identifier is provided on the signage such that the customer can obtain information about the business and possibly a coupon or voucher depending on what the business has to offer. Alternatively, the primary and secondary identifier could uniquely identify a business card in which one or more users can exchange business cards on a mobile communication device for example without the need for physical transfer of the cards. Advantageously, these cards can be updated at any time essentially by the owner of the advertisement or cards. The primary and secondary identifiers may also be used in places of business as business cards or advertising cards, i.e., coupons, discounts etc. in which upon entering a store the user obtains the primary and secondary identifier such as on their mobile communication device for example and the coupon or business card or advertising card is then stored on their mobile communication device. The advertising card or coupon or discount can be updated from time to time by the owner of the advertisement (or coupon or card) and may have an expiry date for example.

Primary and secondary identifiers may be used in print advertising and for example, a primary and secondary identifier may be provided next to a product or service or a recipe or competition for a customer to act upon. Advantageously, the use of a primary and secondary identifier alone avoids the need to congest the advertising space with unnecessary details, all of which can be obtained simply by using the primary and secondary identifier and the method and system of the present invention. By entering the primary and secondary identifier from the print advertisement, the customer then can obtain further detail in relation to the print advertisement. In a further advantage, the primary and secondary identifier in a print advertisement allows the user to obtain data related to that advertisement including one or more links to unique URLs associated with products or services contained within the advertisement. Preferably, only a limited amount of data relating to the advertisement is stored on the customer computer or mobile device; namely the primary and secondary identifier and any information (such as a tag) that the customer may add at the same time as entering the primary and secondary identifier. Further information relating to the advertisement (i.e. the substance of the advertisement including pictures, links audio or video etc. may be optionally downloaded by a customer at a later time. It is also envisaged that classified advertisements may advantageously use the primary and secondary identifiers so that minimal information needs to be provided in the classified (reducing cost to the seller) and the customer can for example, upon entering the primary and secondary identifier into their mobile communication device or computer using the system and method of the present invention, view further images (for example) of something for sale in the classified advertisement. The primary and secondary identifier may be used in advertisements for real estate (either in front of a property or in a real estate agent shop window) in which for each property there is an associated primary and secondary identifier. The primary identifier may be the telephone number of the real estate agent and the secondary identifier is the property. Advantageously, the customer can easily obtain details of the property without needing to copy down information or take a paper brochure. The primary and secondary identifier can also advantageously be used in television advertising since the primary and secondary identifiers are numbers, for example an advertisement may be on a television broadcast for a particular product and for a limited time that product may be available at a reduced price provided the customer obtains the primary and secondary identifier and presents this in store. The primary and secondary identifier may also be used in digital radio since the primary and secondary identifier is a number. The customer for example may hear the advertisement and the primary and secondary identifier may appear on the screen of the digital radio. Alternatively, a particular song may be associated with a primary and secondary identifier and the customer can enter in the details of the primary and secondary identifier, identify the song and purchase the song. It will be appreciated that all of these primary and secondary identifiers can be entered in manually by the user (by way of a keypad on their mobile communication device) at the time they see the advertisement or may be obtained by near field communication. In any event, the user can either on the fly or later obtain all of the information associated with the primary and secondary identifiers (i.e., the advertising). One reason the user may wish to do download the advertisements of interest at a later time (such as on their home Wi-Fi network) is to save data usage on their mobile communication device. Advantageously, the user has the option to do both.

At step 606 the system then determines whether or not the user is logged into the server 101. In the event the user is logged in, control moves to step 607 where the server 101 checks for validation security and privacy settings against the primary and secondary identifier associated with that advertisement. Control then moves to step 608 where the results from the server 101 are provided to the user based on privacy settings. At step 609 the system determines whether or not there are other privacy settings. For example, other security settings may include PIN restriction and\or ‘request only’ required in addition to the ‘exact match’ code being input. ‘Exact Match’ typically means that the advertisement isn't searchable via a part code or keyword search, it can only be found via ‘exact match’ (i.e. if you know the primary code and/or secondary code). Downloading of the advertisement may also be restricted as mentioned above by a PIN or ‘request only’ privacy setting. A pin may include, for example, a mobile telephone number in the event the advertisement is to be limited to a group of friends. Only friends who know the mobile telephone number or PIN will be able to access the advertisement.

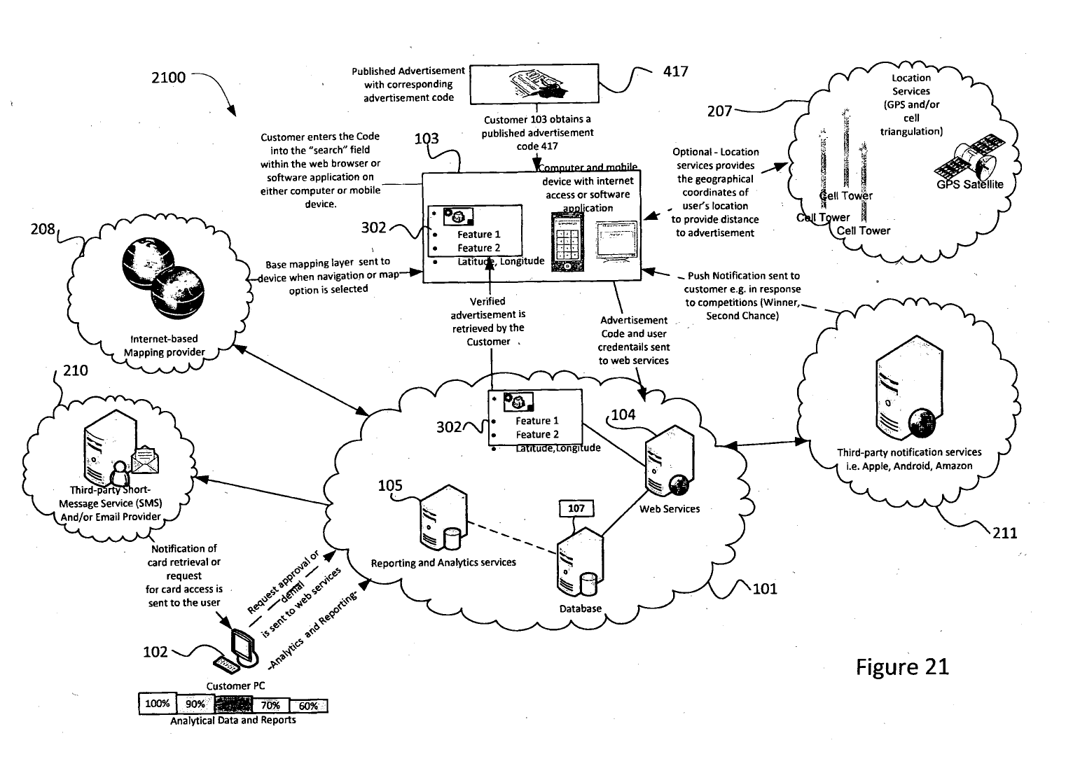

In the event there are further privacy settings control moves to step 610 where results relating to protected advertisement details are not returned to the user but a place holder depicting that the user may request the advertisement or enter in a pin number his provided and shown in FIG. 10. At step 611 it is determined whether or not the advertisement is accessible by request only or via pin entry. In the event the advertisement is request only, control moves to step 612 where the user/customer is presented with a “request card” button and control then moves to step 613 where it is determined whether or not the user has clicked the request card button. In the event the user has clicked the request card button control moves to step 615 where the server 101 processes the request and sends an email and notification to the advertising holder. In the event the user is not logged in at step 614 the user may be prompted to be logged in. Control then moves to step 617 where it is determined whether or not the advertising holder/owner approves or denies the customer request for the advertisement. In the event they approve the request control moves to step 618 where the server 101 receives the approval request and sends the requesting customer and “approved” email. Control then moves to step 619 where the server 101 creates an entry in the database registering the requesting customer as authorised to retrieve the advertisement. Control then moves to step 620 where the customer will then have access to the advertisement within their system. Control then moves to step 638 where it is determined whether or not the user wishes for the advertisement to be downloaded. In the user wishes this to be downloaded control moves to step 631 where the advertisement is retrieved. This will be further described with reference to FIG. 21.

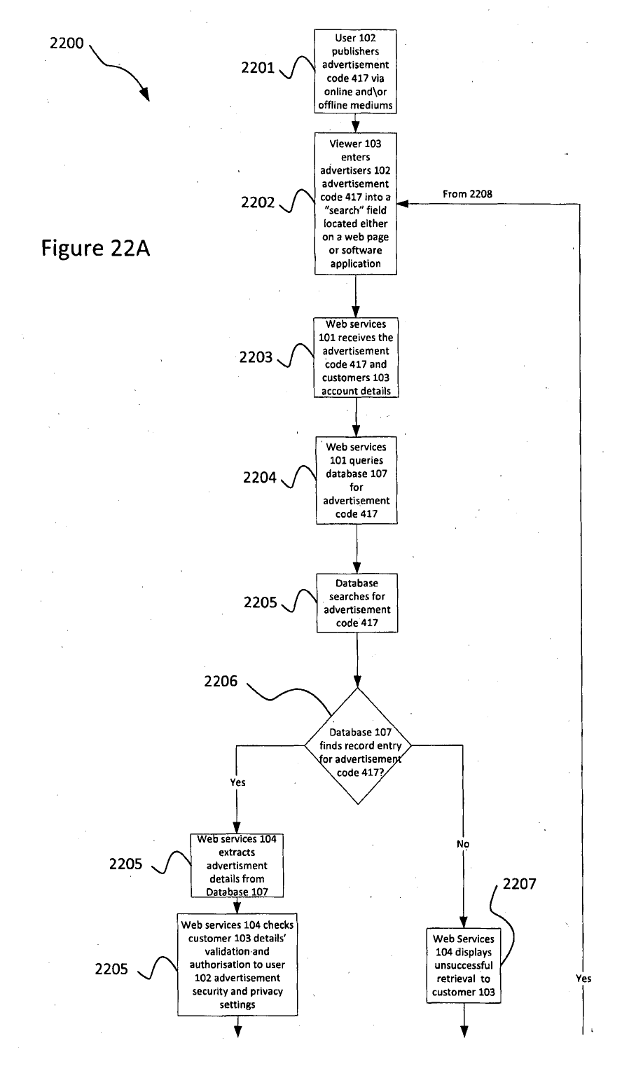

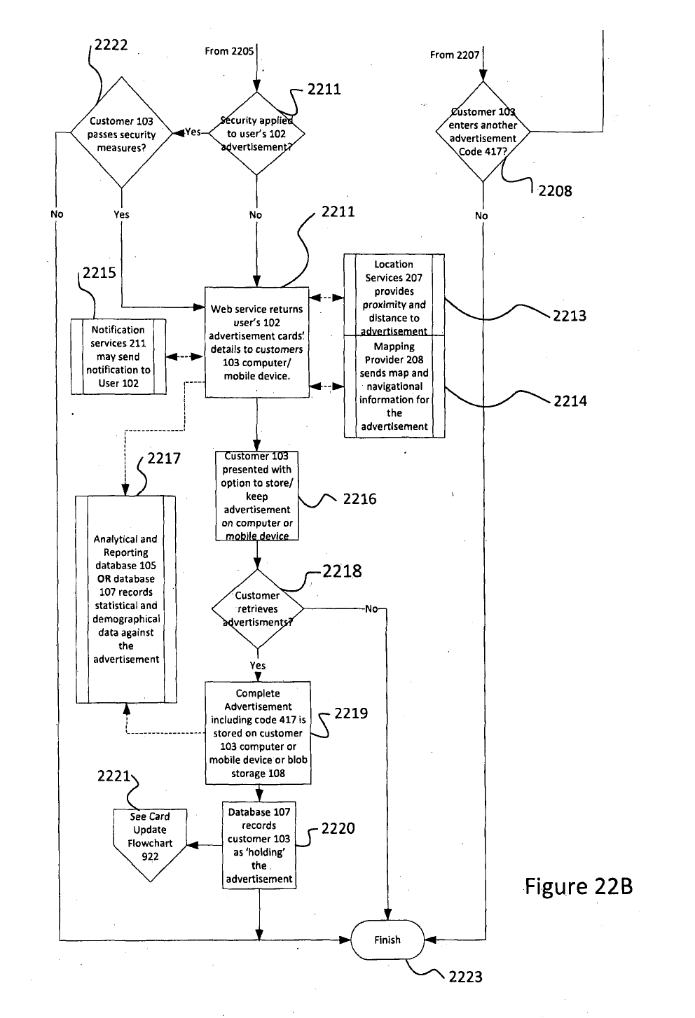

If at 626 the advertisement is not visible or searchable, control moves to step 632 where advertisements that have a privacy block (i.e., are not listed enabled) do not return any details to the customer and the process finishes at step 633. If at step 609 there are no other privacy card settings control moves to step 627 where the server 101 returns valid advertising details relevant to that unique primary and secondary identifier entered by the customer or the category or advertising type including advertising that is published/authorised to the customer but excluding any advertisements that are expired, inactive not publicly listed and/or blocked from the user. Control then moves to step 627 where the information is displayed to the customer. Then control moves to step 629 where the advertisements displayed/returned are based on the customer's current geographical location (providing the customer has approved) and the customer may sought the results as they see fit. Control then moves to step 630 and the customer is prompted to either download the advertisement or not. If the customer choses to download the advertisement, control moves to step 631 relating to the advertisement retrieval process without proximity preferences, which will be described further with reference to FIGS. 22a and 22b. If the customer chooses not to retrieve the advertisement control moves to step 633. At step 613 if the advertisement is accessible by pin only the customer is presented at step 622 with a pin entry box. The customer then enters the pin number and control moves to step 623 where it is determined whether or not the pin number is correct. If the pin number is correct control moves to step 627 otherwise they are permitted another attempt at step 622 with a maximum of three attempts. In the event three attempts have been unsuccessfully tried control moves to step 633.

FIG. 7 is a method for searching for advertising based on keywords. The method 700 includes the following steps: In step 702 a user or customer accesses a website associated with server 101. Control moves to step 703 where it is determined whether or not the customer is searching or browsing for advertisements. In the event they are browsing control moves to step 704 and the method of FIG. 5 is carried out.

Otherwise if at step 703 the user elects to search for advertisements control moves to step 705 where a search window is provided. Control then moves to 706 where the user enters a keyword or partial keyword. Two search options may be provided for example a “What” and “Where”. The “What” may include—product name, product type, business name, business alias name(s), business/service type i.e. plumbing, and part phone number. The “Where” search option may include typical location related data (country, state, city, suburb, post code etc.)

At step 707 the user also specifies a proximity to which they wish to receive results and may dictate that they wish to have results within a certain range of distance. This may be determined by the user entering their geographical location or by automatically determining the geographical location of the user through GPS, location services on a mobile communication device or the like.

Control then moves to step 708 where it is determined whether or not the user is logged into the system via server 101. In the event the user is not logged in, control moves to step 714 where advertising validation, security and privacy processes are reviewed and at step 715 results are provided to the user based on those validation, security and privacy processes in step 714. It will be appreciated that the user having not been logged in may receive a more limited set of results than if they were logged in. At step 716, it is determined whether or not the advertising is protected from anonymous users. In this case it would typically be a business card for example if the business card was the advertising because it may be that the business card is protected from viewing by anonymous users, although it could equally apply to advertising or to a coupon or the like where the advertiser does not want someone who has not signed up to be able to take advantage of the coupon. For example, in the event the advertising is protected from anonymous users, control moves to step 717 and protected advertising is not shown to the user. The method finishes at step 718. If at step 716 the advertising was not protected from anonymous users, control would move to step 711 where valid advertising details would be returned relevant to the unique identifier category advertising type as requested by the user but excluding any advertising that has expired is inactive, not properly listed or blocked from the user. Control then moves to step 712 where the advertising information is displayed to the user. If at step 708 the user was logged into the server 101, control moves to step 709 where like step 714 the advertising validation, security and privacy processes are checked. The control then moves to step 710 where results are filtered by privacy setting and at step 711 valid advertising details are returned based on the primary and secondary identifiers, category or advertising type. Control then moves to step 712 where the browser user is using display to see results. Some results may not be displayed or may be displayed in a different manner as shown in step 713 (better shown with reference to FIG. 10).

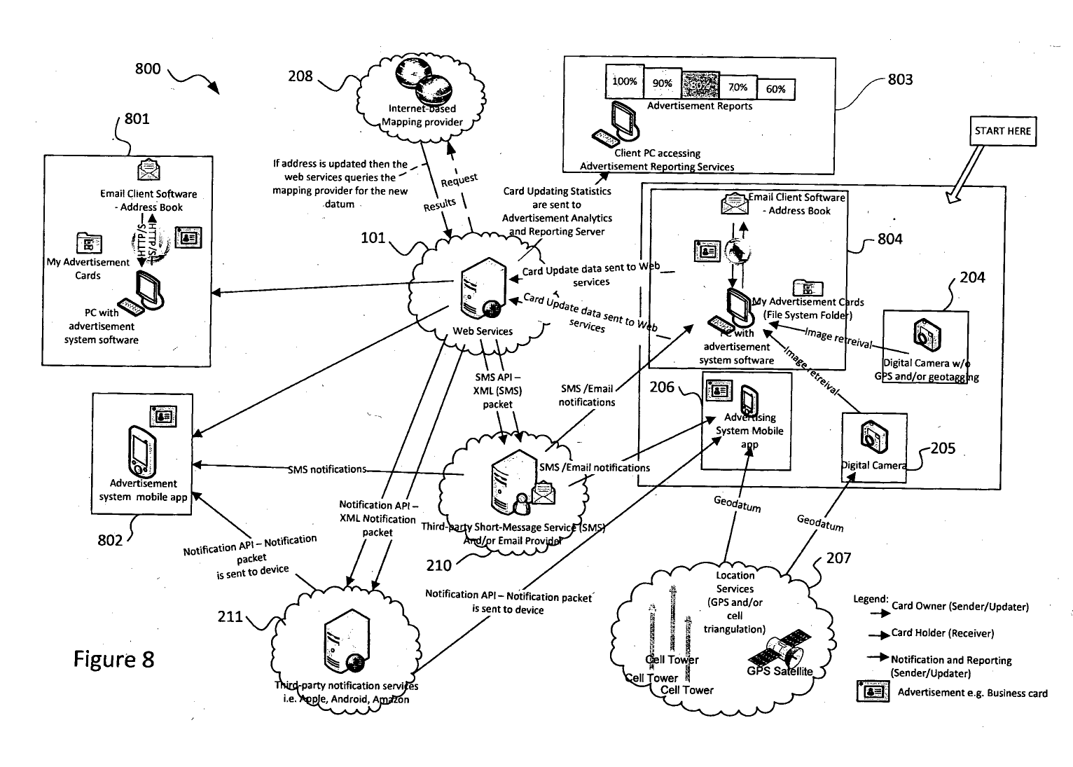

FIG. 8 is a schematic diagram of the advertising update feature of the system and method of the present invention. The system 800 allows for an advertisement which has being created by a user 803 to be updated and that update is then pushed to any customer 801, 802 who has downloaded or received the advertisement as well as to the any customer who receives the advertisement in the future. In the context of business cards this may include redacting an employee who has left the company and sending a replacement business card with the details of the new contact, or it may simply be a change of phone number or office location for an individual. In the case of the advertising taking the form of a coupon or advertisement, the change may be to extend or modify the offer, etc. In the context of advertising this may include a parent company modifying an offer based on particular geographic locations or by franchisee for example. Included is a web server 101 connected to a third party SMS or email provider server 210 also connected to a third party notification service 211 and an internet based mapping provider 208. A user 803 may access the web server 101 to obtain analytics and reports. User 804 can create and modify advertisements previously created via web server 101 and in particular devices associated with user 804 such as digital camera without GPS 204, digital camera with GPS 205 and mobile communication device 206 may update geographic information or photos as required. Mobile communication device 206 and GPS enabled camera 205 may be connected to a location service 207 which allows for capture of geographic information which is then uploaded to the web server 101. Once the user 804 has updated their advertisement, this information is pushed via SMS or email or other notification service to a customer's mobile communication device 802 and/or a customer's PC 801. Advantageously, the changes to the advertisement are applied and updated automatically to every customer who has a copy of the advertisement. Advantageously, all downloaded versions of the advertisement may be kept for historical purposes and discarded when necessary. Historical advertisements may be stored in a user's cloud account or on a device but not synched. The user can then pull all versions down onto another device as required. Downloading old versions to a new device may be restricted for security purposes relating to the privacy setting changes can occur over time.

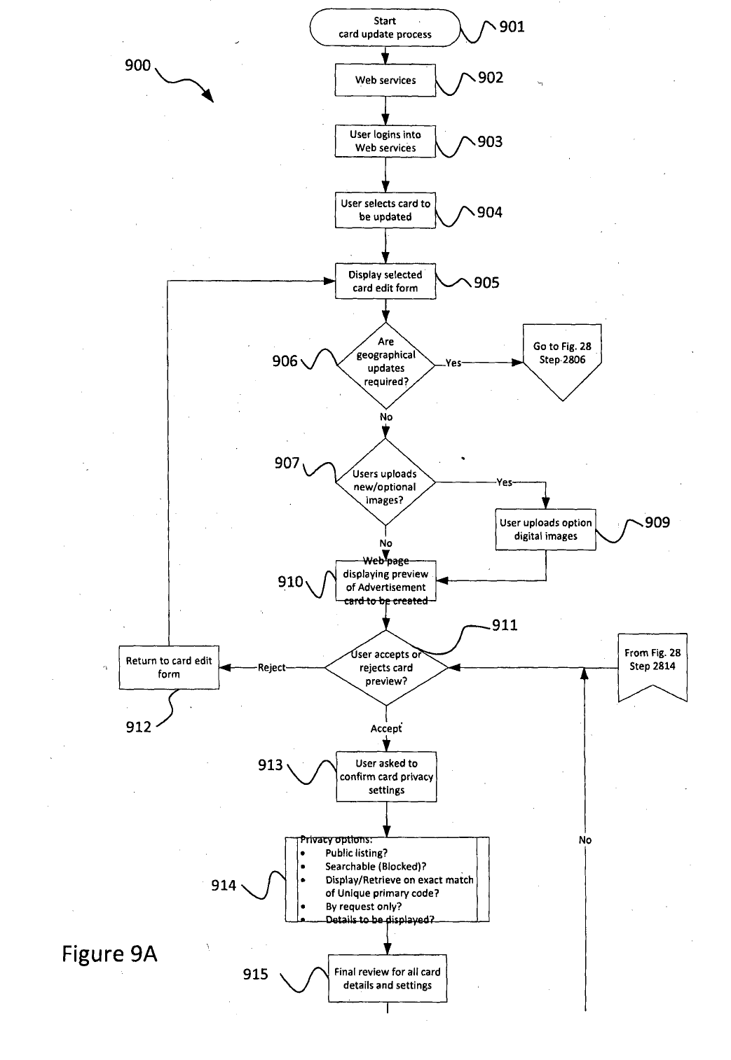

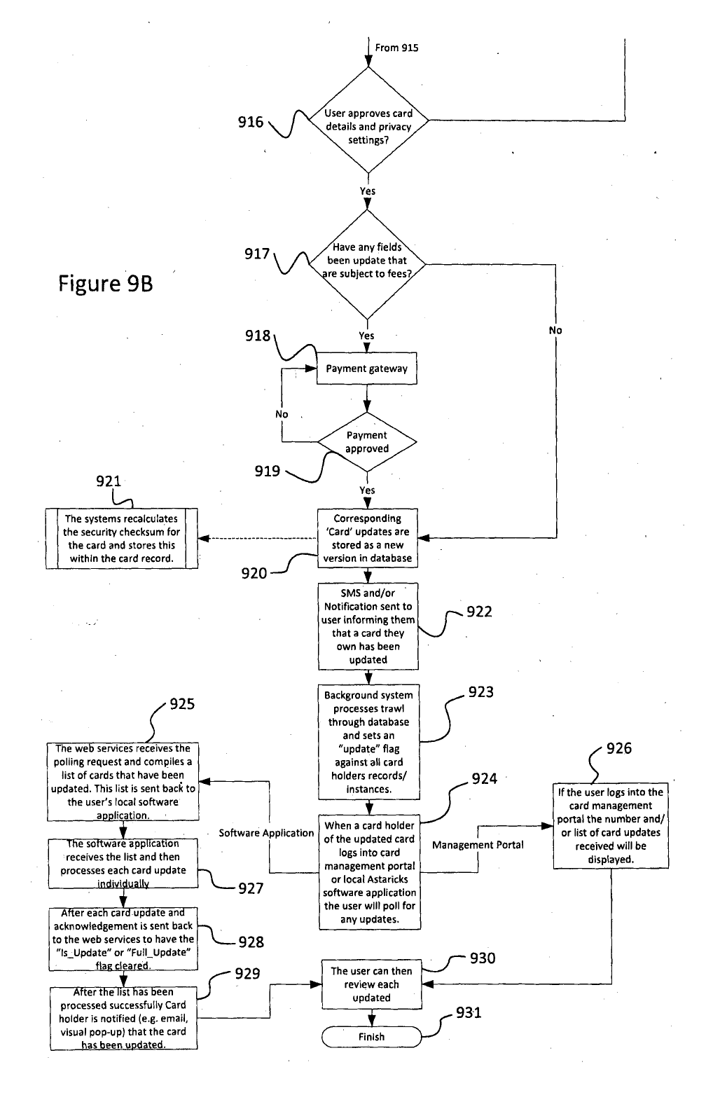

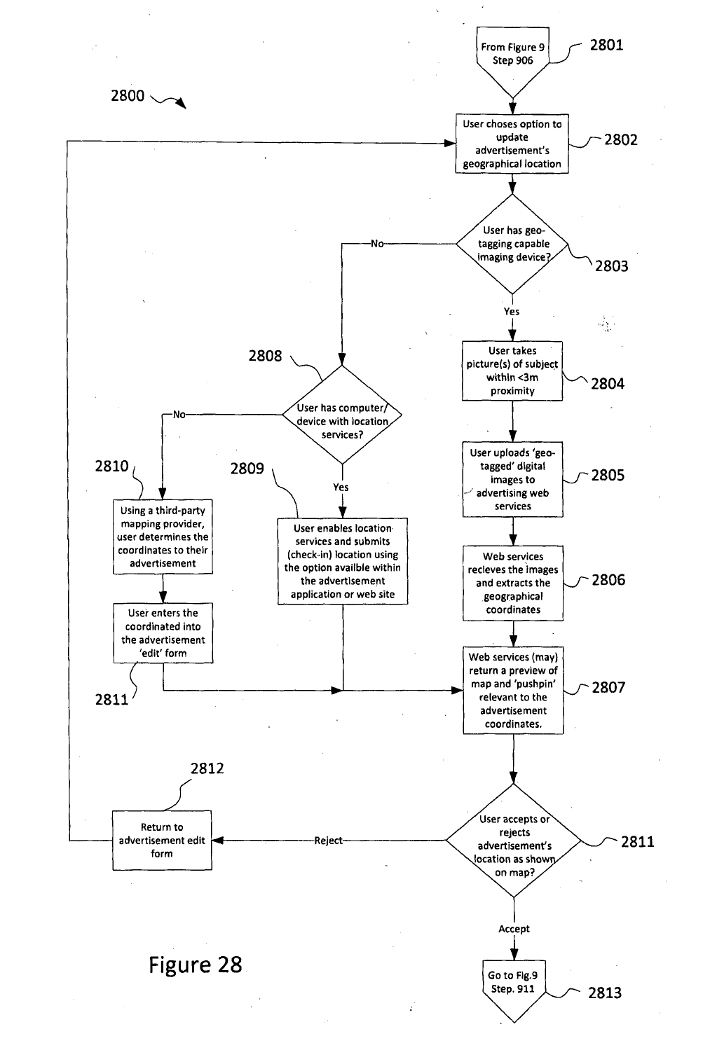

FIGS. 9a and 9b is a flow diagram showing a method 900 according to the invention for updating an advertisement. At step 901, the advertising update process commences and control moves to step 902 where the user 903,904 accesses the web server 101. At step 903 the user logs into the account and at step 904 selects the advertisement to be updated. At step 905 the system presents the selected card to edit and the user edits the advertisement as required. It is not possible for the user to alter the unique primary and secondary code which was provided upon creation of the advertisement unless the advertisement is deactivated. It is envisaged that this would incur a fee for example. Depending on the type of advertisement, other fields may or may not be edited or may be edited for a fee. Optional information may be edited for a fee and some information such as mandatory information such as product title, name and image titles may not be altered, nor can the primary identifier. At step 906 the editing process provides the ability for the user to update an advertisement's geographical location whether manually or via geo-tagged photographs. If the user requires the location to be changed, control moves to FIG. 28, step 2806, as FIG. 28 is a sub-process flowchart that explains the workings for geographical updates. As a security measure, namely to prevent fraud, the physical address may not be altered on the fly, but a request in writing may be made to have a business address altered depending on the vetting requirements set by various jurisdictions. Control then moves to step 907 where it is determined whether or not the user wishes to uploaded new or optional images. If they have images to upload, control moves to step 909 where the user is prompted to upload images. Control then moves to step 910 where a page is presented to the user for review. The user may have the option to purchase more image slots, for example in case they need to as it might help the get the sale across the line. Alternatively, to cater for alterations to a house advertisement (i.e. they have put up a new fence, painted a room, new kitchen) added a bull-bar in the case of a car advertisement since posting the advertisement.

In the event at step 907 there are no images to update control then moves to step 910 where the changes are shown to the user. At step 911, the user is prompted to accept or reject the preview. In the event the user rejects the preview, control moves to step 912 where they are returned to step 905 to enter in the information they wish to change, otherwise control moves to step 913 where the user is again asked to confirm privacy settings associated with the advertisement.

At step 914 the privacy settings may be edited such as whether or not the advertisement is a public listing, if it is searchable, whether it can be displayed and retrieved on a match of the primary and secondary identifier, whether or not the advertisement is visible by request only and what details of the advertisement are to be displayed. Control then moves to step 915 where a final review for all details and privacy settings are provided to the user. At step 916 the user is prompted to approve the details on privacy settings. In the event the user disagrees, control returns to step 911. However, in the event the user is satisfied with the changes, control moves to step 917 where it is determined whether or not any of the changes the user has made incurs fees. In the event fees are incurred, control moves to step 918 which is a payment gateway. Control then moves to step 919 where it is determined whether or not payment is approved. If payment is not approved the control moves to step 918 again otherwise control moves to step 920 where the advertising updates are stored as a new version in the database on the server 101. At step 921 the system recalculates a security checksum for the advertisement still assist within the advertisement record. Following step 920, control moves to step 922 where an SMS or email notification is sent to the user informing them that an advertisement they are in has been updated. Control then moves to step 923 where the server 101 checks the database and sets an “update” flag against all advertising holders, records and instances. Advantageously if only a text portion of the advertisement has been updated, then a flag in the database may be set as “is_update” otherwise if one or more images have been edited (irrespective of any text that has been updated), then the flag is set as “full_update”. Advantageously, this reduces download bandwidth where possible for end customers 901, 902. Control then moves to step 924 which occurs when a person who holds the advertisement which has been updated logs into their phone or email program and the systems polls the server 101 for any updates to any of the advertisements. Depending on the type of user whether it's a user or a customer, the customer may use the software application and control moves to step 925 where the server 101 receives a polling request from the customer and compiles a least the advertisements that have been updated. This list is then sent back to the customer's local software application. Control then moves to step 927 where the software application receives a list and processes each advertising update individually. Control then moves to step 928 in which after each advertising update and acknowledgement is sent back to the server 101 the “is_update” or “full_update” flag is cleared to indicate that the change has been made. Control then moves to step 929 where the customer who holds the advertising is notified preferably in an unobtrusive way but it could be by email or a visual pop up that the advertising has been updated. This is most useful in a situation where the advertising is in the form of a business card that the customer is aware that a change has been made. Control then moves to step 930 where the user reviews each updated advertisement as required before moving to step 931 where the process finishes. The user is logging in via a management portal, control moves to step 928 after step 924 and that will be able to see the number of advertisements or a list of advertisement updates received is displayed. Control then moves to step 930 where the user can review each of the updated advertisements.

FIG. 10 is a sample screen shot of an advertising security screen which will be presented to a customer upon browsing or searching for an advertisement (as described with reference to FIGS. 5, 6a, 6b and 7. Each advertisement which is identified and/or created may have one of four security settings that can be applied individually or in combination:

Blocked (advertising that has this setting will never be searchable or displayed).

Exact Match (for advertising that has this setting the advertising will only be displayed when a complete unique primary identifier and unique secondary identifier is entered and it matches a valid listed advertisement i.e., one that is not blocked).

Request (advertising that has this setting enabled are displayed with a “request” button associated with the search result. In the event a user clicks the button they are presented to be log-in (if not already logged in) and will then be presented with a log in. If they have already logged in they will receive an acknowledgement saying that the request has been submitted.

Pin protected (advertising that is pin protectable will be displayed with a enter pin button. When the button is clicked the user is presented with a login (if not already logged in) or if when they are logged in they will be presented with a key pad to enter in the pin number. If the pin entry is successful the advertisement will be displayed. As shown in FIG. 10, the dialog box 1001 includes a code entry box 1002 in which a user will have entered a primary and secondary identifier or partial primary and secondary identifier. Results box 1003 and 1004 show example search results for the partial code ‘2998’. Results in 1003 indicates that this advertisement or in this case business card is request only. The unique primary and secondary identifier for the advertisement in 1003 is also partially masked only showing the partial code which the user has entered in the box 1002. The second result 1004 is an advertisement which is pin protected and the user has the option of entering in a pin number. In order to avoid confusion and to assist accuracy for the end users to determine or narrow down the correct advertisement that they are looking for and in turn the owner of the advertisement at the time of advertisement creation the owner can set which personal details may be displayed in the search result which could include any one or more business name, first name, last name, city, state or country.

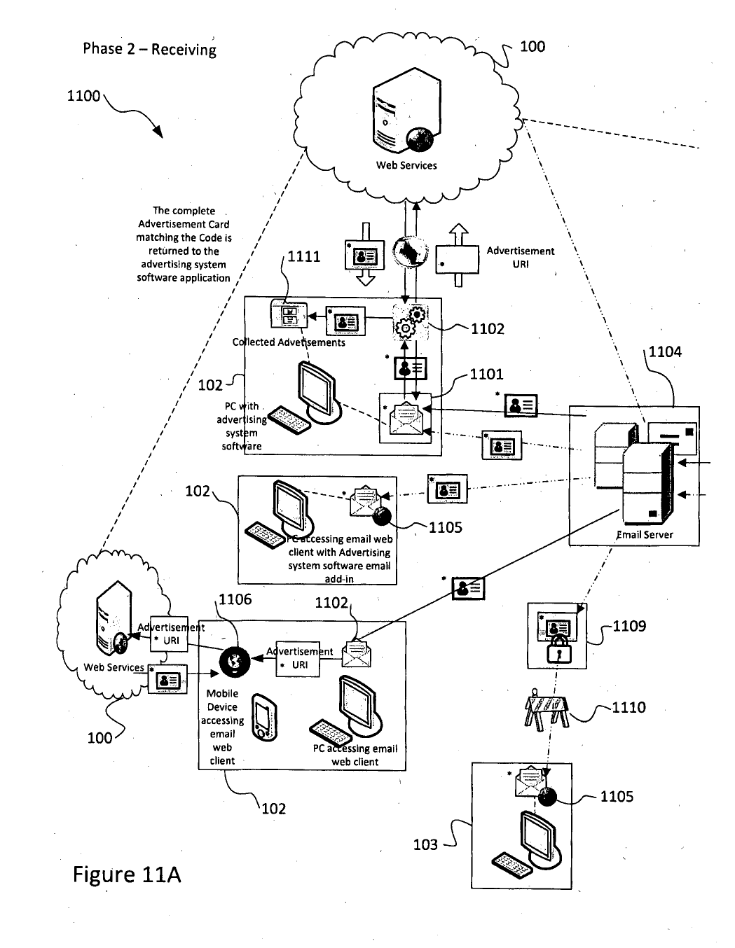

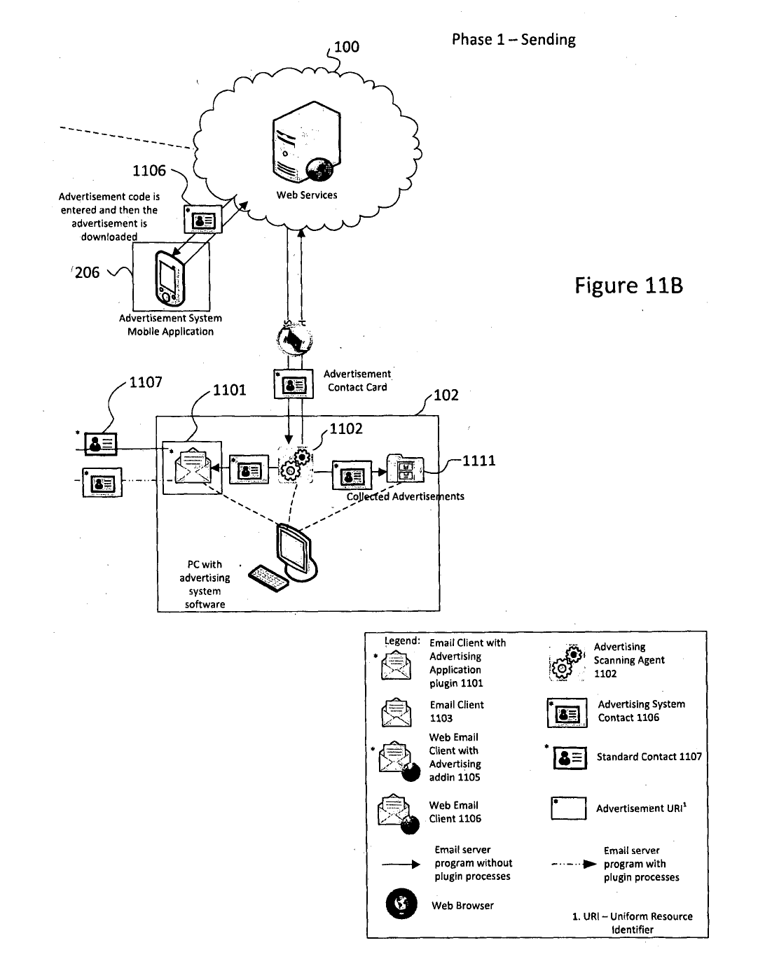

FIGS. 11a and 11b shows one possible option for synchronising advertisements using an email program plugin. In an attempt to remove visual complexity, FIG. 11 is broken up into halves, 11a and 11b: The right hand side (FIG. 11a), is the starting point of this process example, is the ‘Sending’ process and, the left hand side is the ‘Receiving’ process. Futher, for ease of reference, a ‘contact card’ based upon an advertisement template has been used in this example although, this process is by no means limited to only contact card type advertisements, all advertisement system templates are able to be viewed via this email program plugin method.

FIGS. 11a and 11b represents a general overview of a typical email server and email client arrangement showing how contact card advertisements can be sent/shared/synched between email clients with the plugin 1101 and between email clients without the plugin 1103. Also shown on this diagram is the Advertising Software Agent 1102, which is an integral component of the Advertising System Software (not shown) that the email program plugin “hooks” into to transfer\translate\synchronise\verify advertisement content received from Web Services 101.

The email server 1104, either on premises, remote site or “cloud-based”, may be configured with an email server program version of the plugin, programmed specifically for the type of email server, which will enable a web-access email client 1104, which is associated with an email server, to display a contact card as per the chosen advertisement contact card template.

The workflow of FIG. 11a begins with the right hand side sending process whereby the user 102 interacts with any published contact card 1106 and requests\retrieves this contact card 1106 via web services 100. Web services 100 records this contact card download against user 102. When user 102 next opens an email client with plugin 1101, and the user fulfils any advertising system user account login process, the contact card 1106 is retrieved by the advertising scanning agent 1102, which the agent 1102 may extract\store the contact card data locally, and then the email client with plugin 1101 received the contact card data and then either create a new contact, merge\update any existing contact, or purge any duplicated contact. In addition, the retrieved contact card 1107 may be stored within the local file storage system 1111 on the device or computer for the purposes of viewing the contact via the installed advertising system software application, if any. However if and when the contact card is stored, may be dependent on the contact card privacy settings configured during the advertisement creation 432 or amended afterwards 916.

In the middle of FIGS. 11a and 11b is the email server 1104, which manages all the email clients shown. A typical function of an email server, especially when configured for business networks, is the synchronisation of shared and personal address books and the contacts contained within. As such, in the present invention, when a user 102 receives a new or updated contact card 1106 the typical synchronisation process of the email server and client detects the change and the contact card 1106 is stored within the email server 1104. As the diagram shows to the immediate right of the email server, there are two instances of an advertising system contact card that may be transferred to the email server and these instances are dependent on whether or not the email server has the email server program plugin installed or not. For an email server with the server plugin, contact card 1106 containing the full advertising system contact card dataset is transferred, or, in the event that the server plugin is not installed then contact card 1107, being a specific contact card dataset tailored to the type of email server program, or, a standard email system contact is transferred. Furthermore, in the instance where the email server 1104 is configured with the email server program plugin, the email server can interact directly with web services 101 to retrieve updated contact card, which enables direct contact card 1106 verification, security and the transfer of up-to-date contact data, which may be synchronised throughout the email system if and where necessary.

The left hand side (FIG. 11b) depicts the advertisement receiving process for the user 102 and a customer 103 and shows how email clients, with or without the advertising email program plugin installed on different devices, receive and display contact cards. In this receiving process, for the email client with plugin 1101 and email client 1103, these clients will interact with the server 1104 and synchronise the contact card 1106 with full dataset or, contact 1107 with limited dataset according to the email server program has the plugin installed or not. In the instance where the email client with plugin 1101 receives either contact card 1106 or 1107 the scanning agent 1102 scans the email program and detects the received card and, if necessary, registers the contact card against their account, or sends out contact card request (or prompts for PIN) before registering and viewing. The agent 1102 then instigates a download of the latest contact card dataset if applicable. For those users/customers/systems without a plugin they can still access the contact data by viewing the contact using the email program 1103 standard contact display and\or via a web browser 1106, but they will not receive (automated) contact card (advertisement) updates from the web services 100.

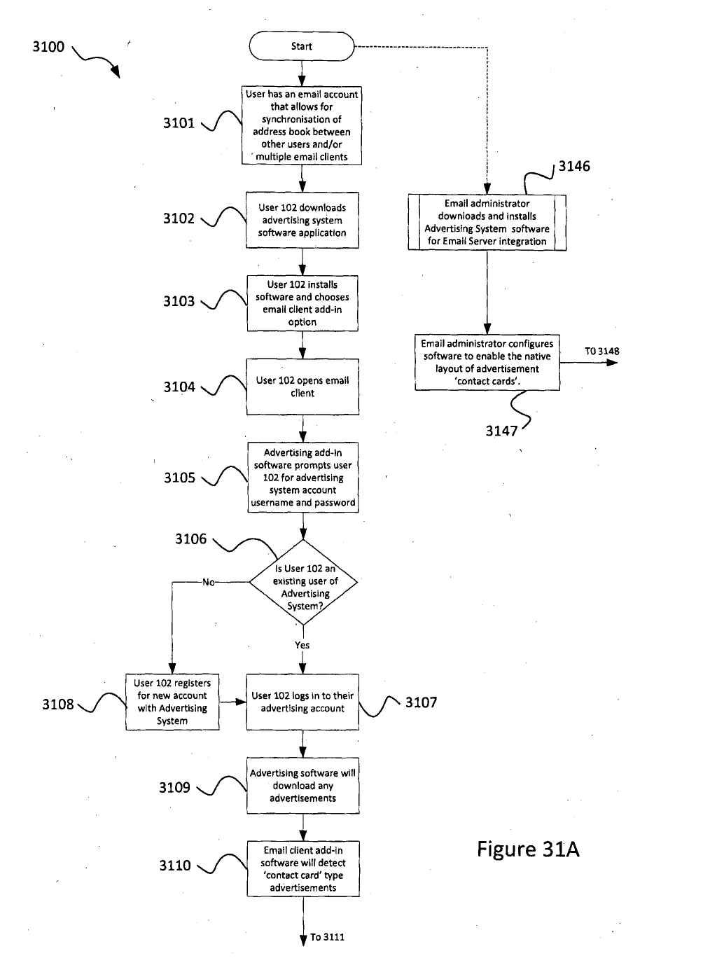

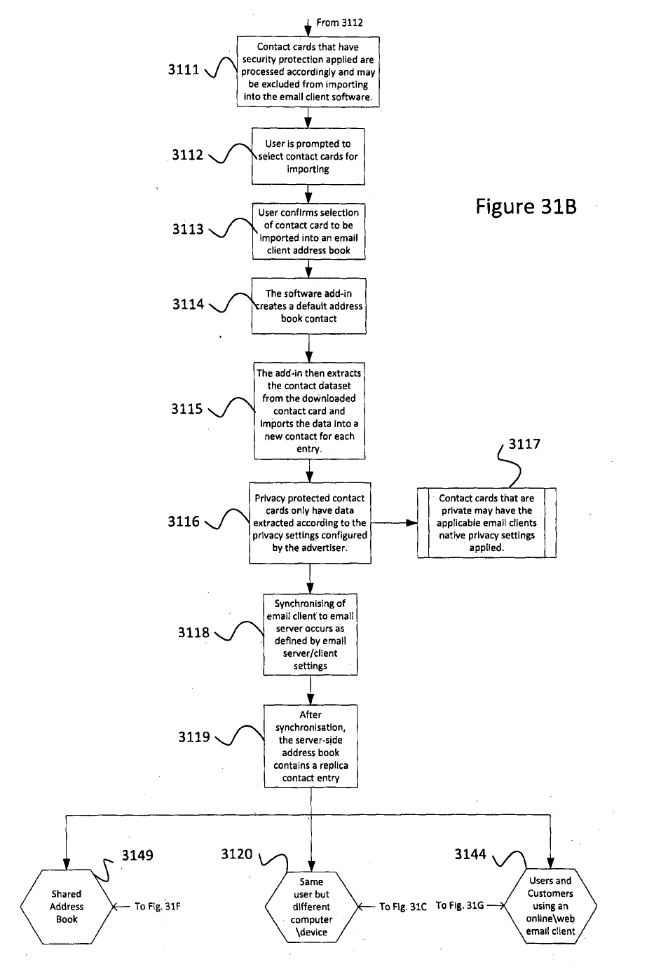

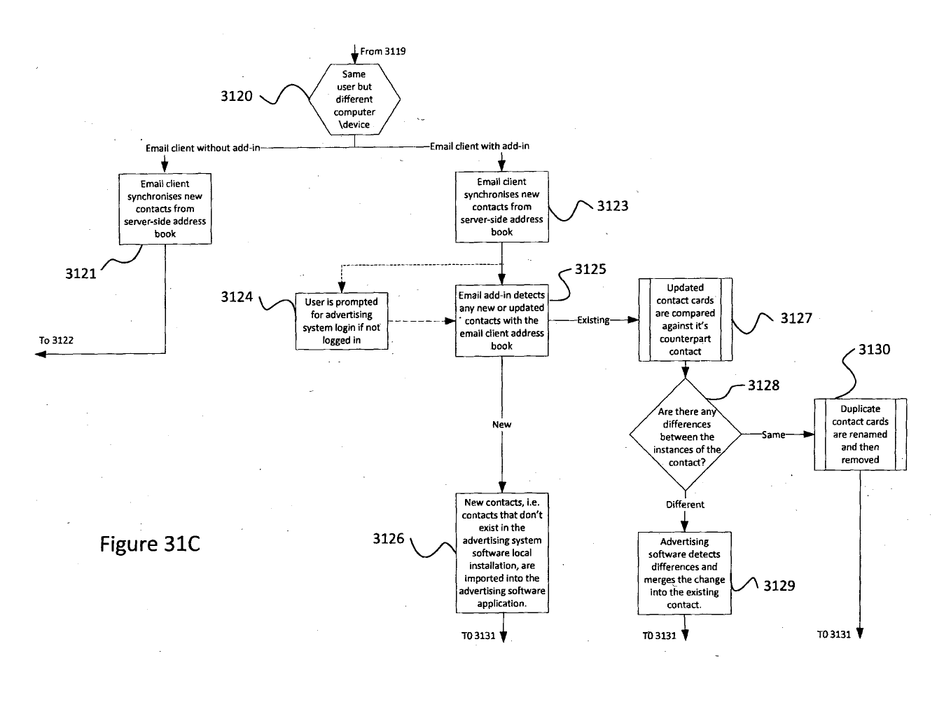

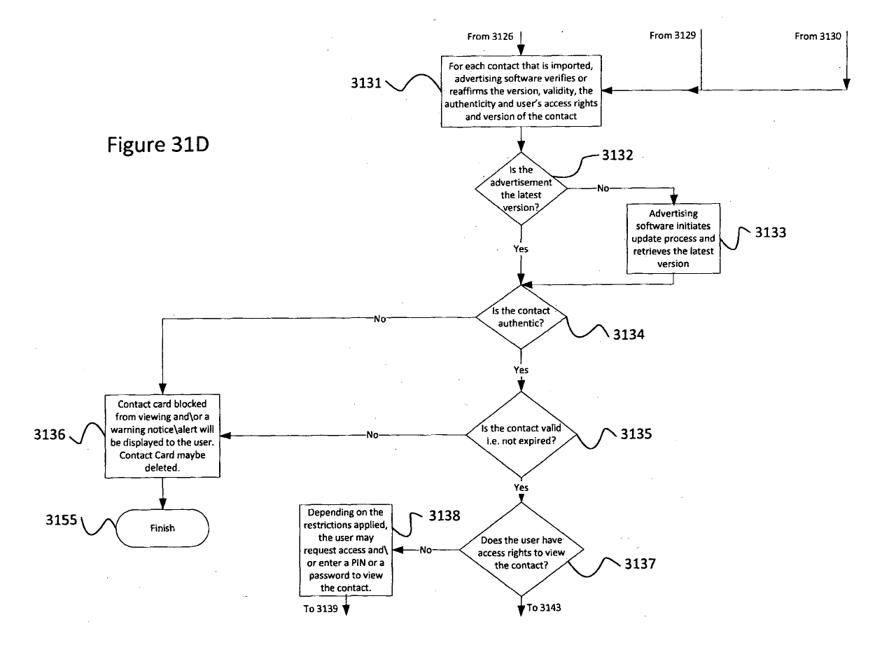

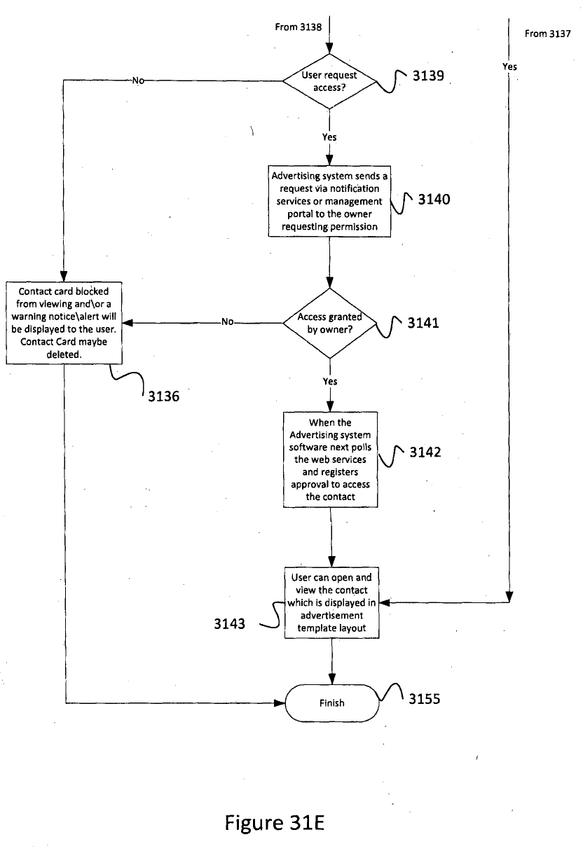

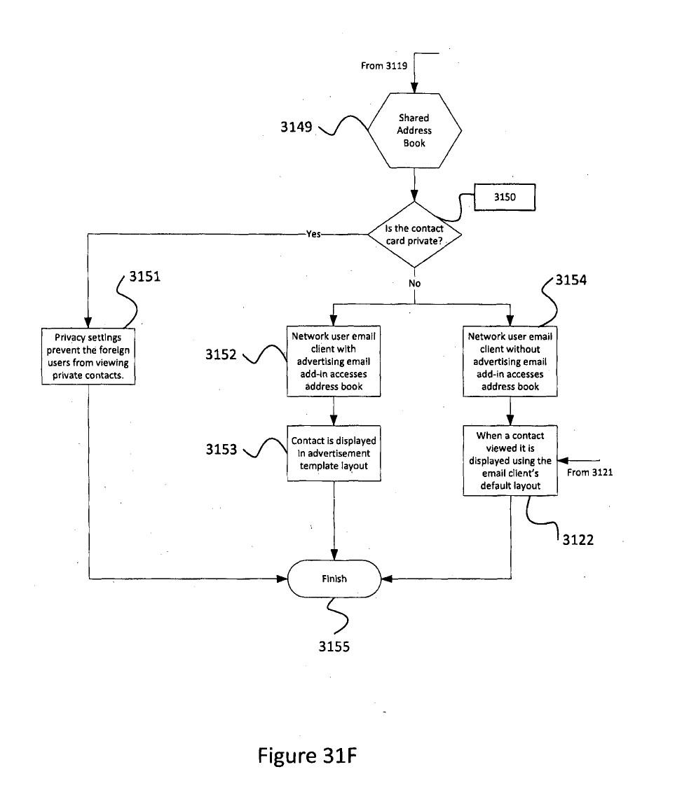

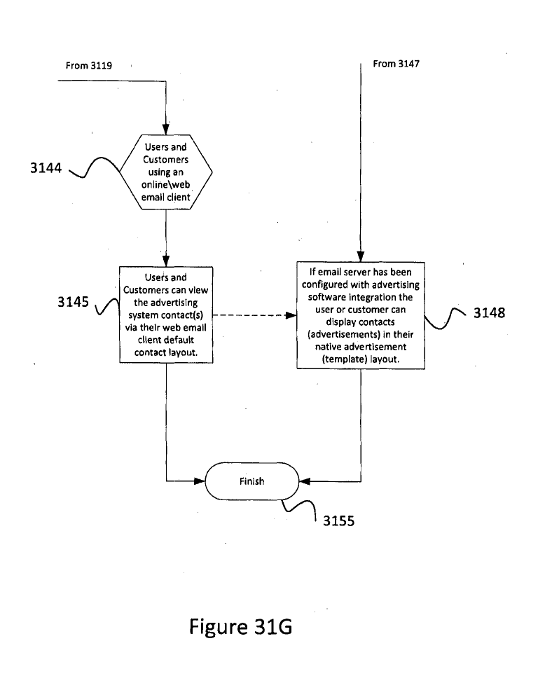

For the Web-access email clients 1105 that may attach to email servers with the plugin installed, these clients 1105 can view the contact card in its native advertising template layout. For the emails clients 1102 and web-access email clients 1106 that may attached to email servers without the email server program plugin these clients 1105 and 1106 can still display the default\standardised contact information, if any, contained within an advertisement and, depending on the email program, clients 1105 and 1106 may be able to view limited advertisement imagery, and\or the advertisement's main subject matter and any additional imagery may be substituted with a Uniform Resource Identifier (URI) 1108 such as a hyperlink, linking to Web Services 100 enabling the user and\or customer to a web browser 1106 and view the advertisement online. This will be further described with reference to FIGS. 31a to 31g.

The last element for the receiving process in FIG. 11b gives a basic visual representation of a privacy protected contact card 1109 being blocked 1110 from import\view by customer 103 either due to denied requests or unknown PIN access or simple due to no entitlement, as determined by the email server program plugin.

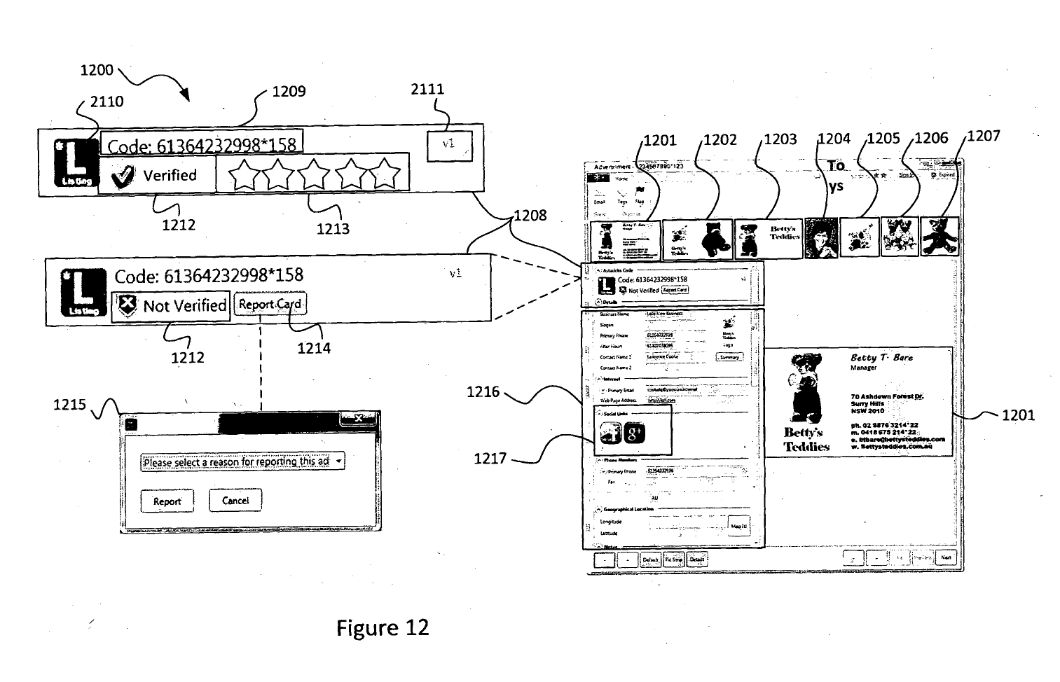

FIG. 12 is a sample screen shot of a software application, which may also be integrated into an email application by the way of an add-in, for employing the system and method of the present invention. In this case the advertising which is being created and sent to a customer or user is in the form of a business card 1201. The business card follows a template as defined by the invention and one or more photos 1203, 1204, 1205, 1206, 1207 have been included as defined by the template. The metadata associated with the card is shown in the magnified offset of 1208. Details such as 1209 being the advertisement unique code i.e. primary and secondary identifiers are provided, but may show any unique code such as the alpha-short code. 2110 is an icon representing the advertisement card type, 2111 is the version of the advertisement card, 1212 is the verification status of the card (may display ‘Verified’ [shown], ‘Pending’ or ‘Not Verified’ [shown]), and in the instance that an advertisement card passes verification tests, the level to which the card passes may be represented by icons such as stars 1213. An example of the verification tests may be by the way of company letterhead, company tax number and business name checks, SMS phone number and SMS PIN response all of which may be submitted to the advertisement company to ensure that the company or personal details match details portrayed in an advertisement. In the instance that the advertisement fails verification the user or customer may report the card via the ‘Report Card’ button 1214 whereby a dialogue box 1215 will be displayed to the end user and they can chose the reason why and can supply additional details about the advertisement card being reported. The contact details are stored in 1216 and various social media contacts are shown in box 1217. It will be appreciated that the user can select from one or more of the photos to view the photos and/or return to the traditional business card as shown in 1201. Advantageously, a photo of the person who owns the business card may be provided and/or additional product information may be associated with the card. In a further advantage every time the card is updated by the owner of the card or administrator of the card through the method and system of the present invention the information contained in the card may be changed automatically.

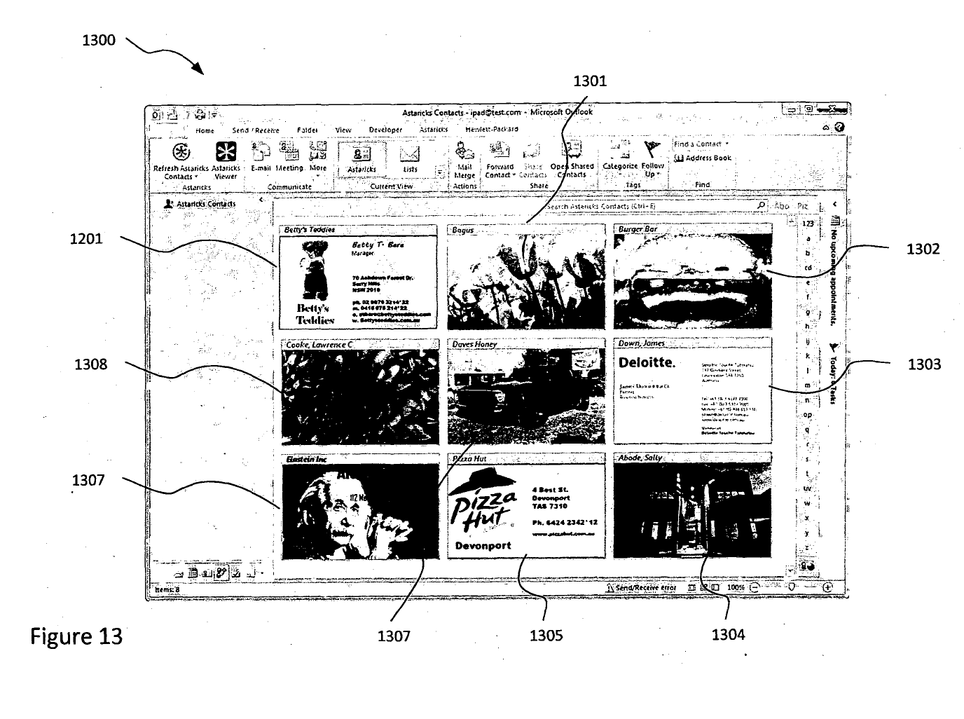

FIG. 13 is a further screen shot showing a number of cards and advertisements which have been generated by the method and system of the present invention. 1301, 1302 may be coupons for redemption at a later time. Advantageously, the coupons may be extended or may expire early as determined by the owner of the coupon and this information is disseminated to everybody who has a copy of the advertisement. 1201 is a business card, 1303 and 1304 are advertising in the form of grocery catalogues which may, for example be updated weekly or during the course of a week if an item is sold out in that particular location confirming that the item has sold out and that a range check is possible, for example. The updating of advertisements may be based on geographical location. 1305, 1306, 1307 and 1308 are coupons which may be associated with a business card and are generated by a template by the system and method of the present invention. For example, in the context of advertising coupons, if a user is in a different location they can search within their previously collected advertising coupons (via their mobile communication device or computer) to display coupons relevant for that particular geographic location. If we refer to fast food chain coupons for example—typically a fast food chain coupon in the southern states of Australia are accepted (e.g. VIC, NSW and TAS). So if a user was walking with the proximity of business that accepted a coupon that they held they may be alerted\notified to the fact. It is also possible that if, for example a book chain were out of stock of a particular book in a particular geographic location (e.g. somewhere in Tasmania) but the user is presently located in the state of Victoria, they are then alerted to the closest cook chain in that state that has that book.

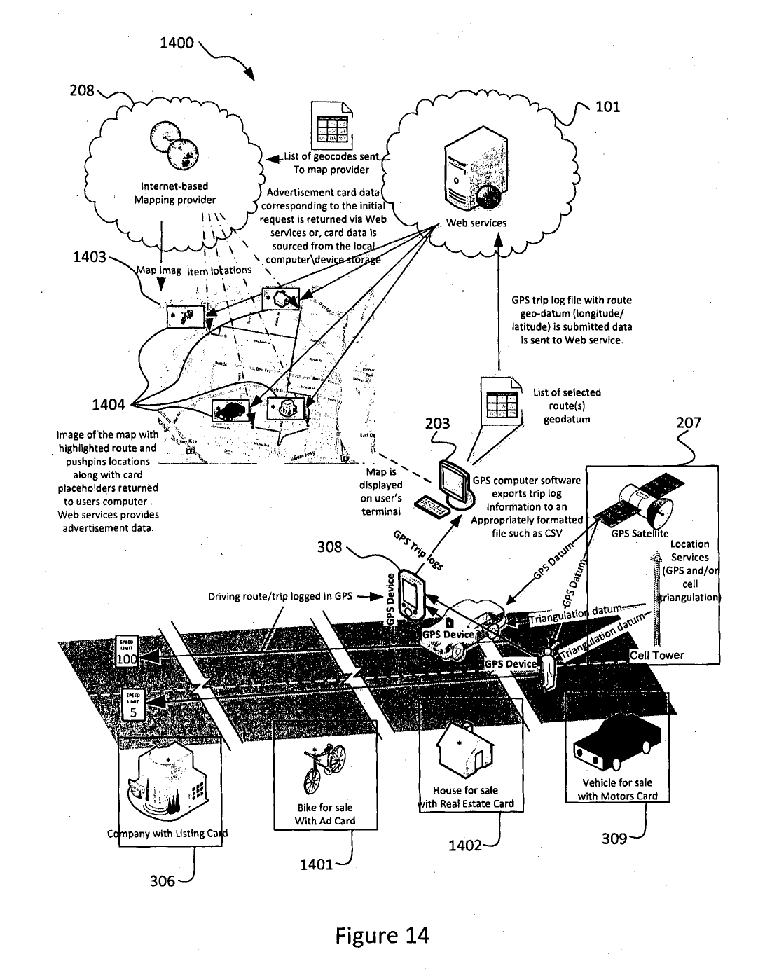

FIG. 14 is a schematic diagram of the system according to the present invention for obtaining advertisements based on geographic location through near field communication. In operation, a user in a vehicle or walking through a particular location with their mobile communication device 308 may walk a particular route and while walking that route, by a near field communication device associated with the mobile communication device, advertising is logged on the mobile communication device for later review by the user. The system includes a server 101, internet-based mapping provider 208, a mobile communication device used by user 305, which is, in turn, connected to a GPS and the user uploads their GPS data to a personal computer owned by the user 103.

Advantageously, the user when walking or driving around an area, can, without actively seeking any information, obtain information about for example, a company 306, a bicycle for sale 1401, a house for sale 1402, or a vehicle for sale 309. For example, the user could be travelling in a car and drive past any one of these advertisements, but need not actively obtain, for example, a mobile telephone number or remember which street the item for sale was in. Rather, the system of the present invention may attain the unique primary and secondary identifiers associated with each of the advertisements (namely company with listing 306, bicycle for sale 1401, house for sale 1402 or vehicle for sale 309) and this information which uniquely identifies the advertisement, together with date, time and location, may be stored in the GPS data of the user's mobile communication device. Then, once the user returns to their computer, they can optionally interrogate the GPS data to find out any, or obtain any, advertisements that may have been of interest that day. They can then selectively ask to receive data relating to the one or more advertisements. The user may narrow down the search options to a particular geographic location or to a particular time or a particular day in the event that there are a number of advertisements which have been captured. Place holders 1403 and 1404 may be provided which allow a user graphically see the locations of advertisements.

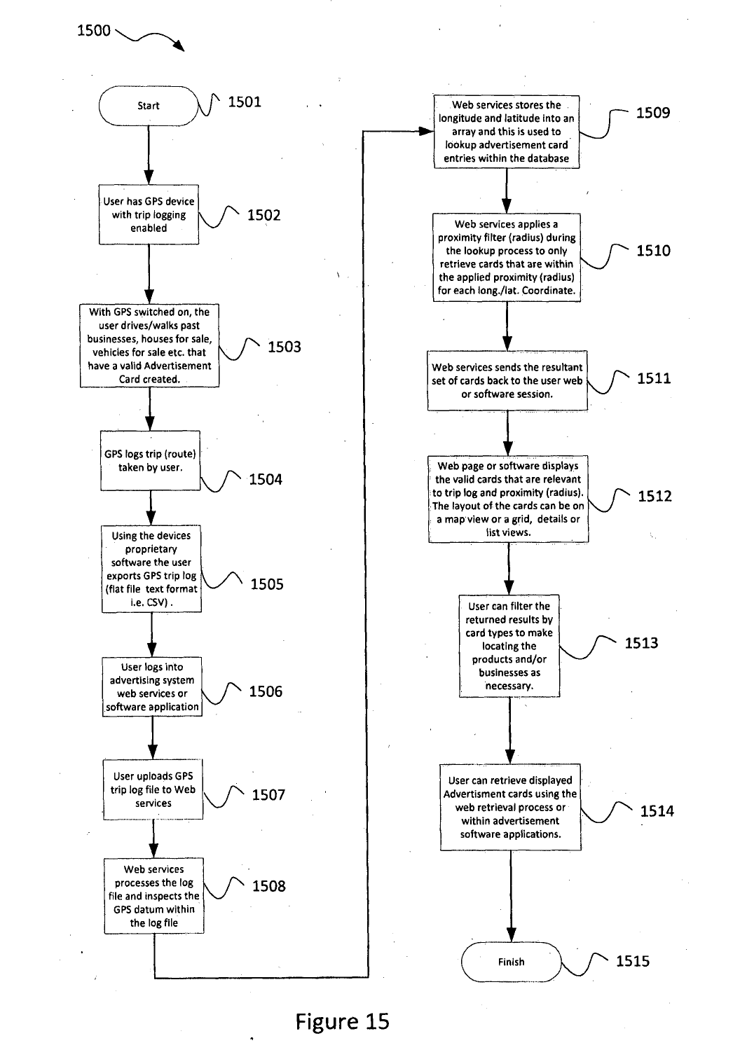

FIG. 15 is a flow chart for a method according to the invention for receiving advertising information based on location. The Method 1500 starts at 1501 and the user 103, for example, has a GPS device with trip logging enabled or mobile communication device with GPS location services. The GPS device may be located on their mobile telephone or maybe a stand-alone GPS unit which they have in their vehicle, for example.

Control then moves to step 1503 in which, with the GPS on, the user drives or walks past businesses, houses for sale, vehicles for sale, etc., each having a valid unique primary and secondary identifier associated with the advertisement. Importantly, it is not essential that the user notices whether or not there is an advertisement. Advantageously, the driver, for example, does not have to stop to gather information and even driving past at speed will not prevent the data from being uploaded to the GPS. The user can then optionally and selectively recall that advertising information later if requested.

At step 1504 the GPS logs the trip or route taken by the user and at step 1505 the user uploads the GPS trip log to their computer. At step 1506 the user may log into the server 101 associated with the method and system of the present invention and at step 1507 the user can upload the GPS trip log. At step 1508 the server 101 interrogates the log file, at step 1509 the server 101 stores the latitude and longitude into an array and looks up the unique primary and secondary identifiers within the database. Control then moves to step 1510 in which the server 101 applies a proximity filter (radius) during the lookup process to only retrieve cards which are within the applied proximity radius for each latitude and longitude coordinate.

Control then moves to step 1211 where the resulting set of advertisements are sent back to the user. Control then moves to step 1512 where the server 101 displays the valid advertisements that are relevant to the trip log and the proximity. The layout of the cards may be in a map view or a grid detail or a list view. Control then moves to step 1513 in which the user can filter the return result by card type or by date or by time. Advantageously, filtering out card types removes the clutter (even though the user can keyword search on the results). A GPS trip log may return hundreds of results and the user may remove the advertising types they are not interested in. The user may also filter by time, for example, if a user drives past a car for sale on the side of the road at 3:15 pm and then the car owner moved the car at 4:00 pm, the set of a 4:30 pm search may show the car as being moved by having a GPS log to match.

Control then moves to step 1514 where the user can then retrieve the advertisements and store them on their computer or mobile communication device. Control then moves to step 1515 where the method finishes.

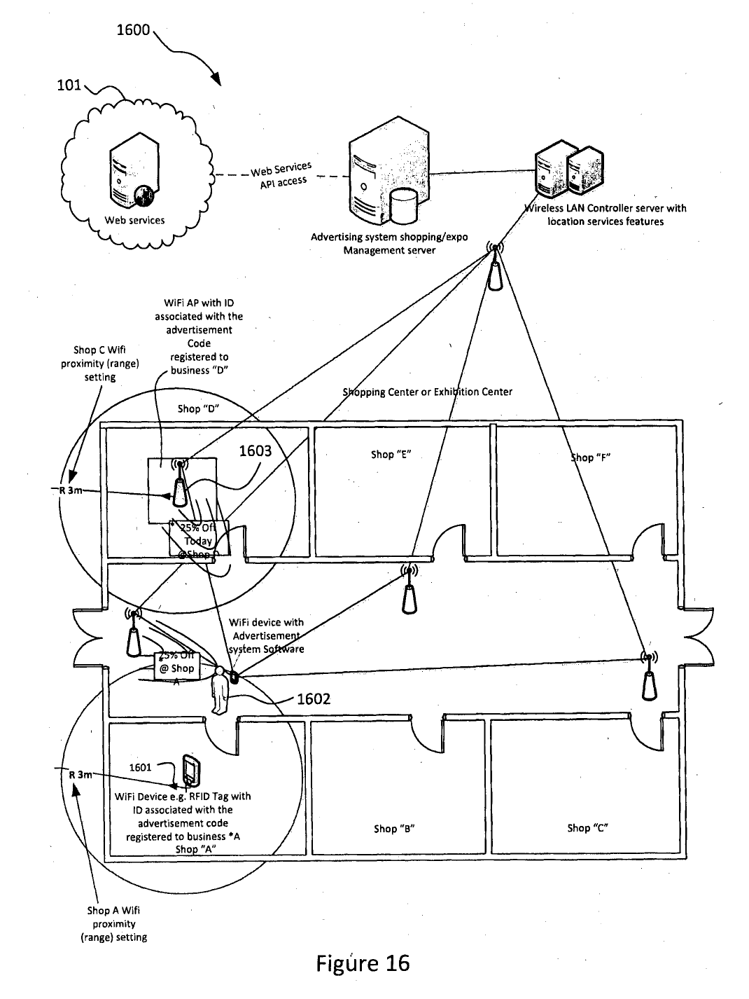

FIG. 16 shows an application of the system and method of the present invention, in which a Wi-Fi device with a primary and secondary identifier is provided and the Wi-Fi device 1601 has a range ‘A’ such that when a user who has a mobile communication device 1602 walks within the range of A, they are presented with an offer, for example, 25% off today only. However, the user 1602 in this case only receives the offer if they already have an advertisement associated with the Wi-Fi device A, which is typically associated with a shop or store at an exhibition stand. This arrangement allows a user to choose to receive solicited or unsolicited ads from business and\or ads with proximity push settings. All ads can be further “restricted” so the user only receives ads that they have subscribed to and\or matches their needs, wants and desires in their preferences. For example, in an exhibition environment, and since an exhibition is about marketing and attracting attendees to stands, the exhibition preferences will most likely not be controllable by the attendee, they will be served advertisements at the discretion of the exhibition organiser (as paid for by the exhibitors/stall holders) but it still may be tailored to the users registered interest and line of business, products and service specified during the even registration process for example.

Since the user is not within the range of Wi-Fi device 1603, they will not receive any communication from the Wi-Fi device 1603, however, if they walk within the range D of Wi-Fi device 1603 and have already downloaded an advertisement associated with the shop which is using Wi-Fi device 1603, they will be presented with an offer. Since the user 1602 does not have any advertisements from shops B, C, E or F, no offer is made despite being within a range of those shops.

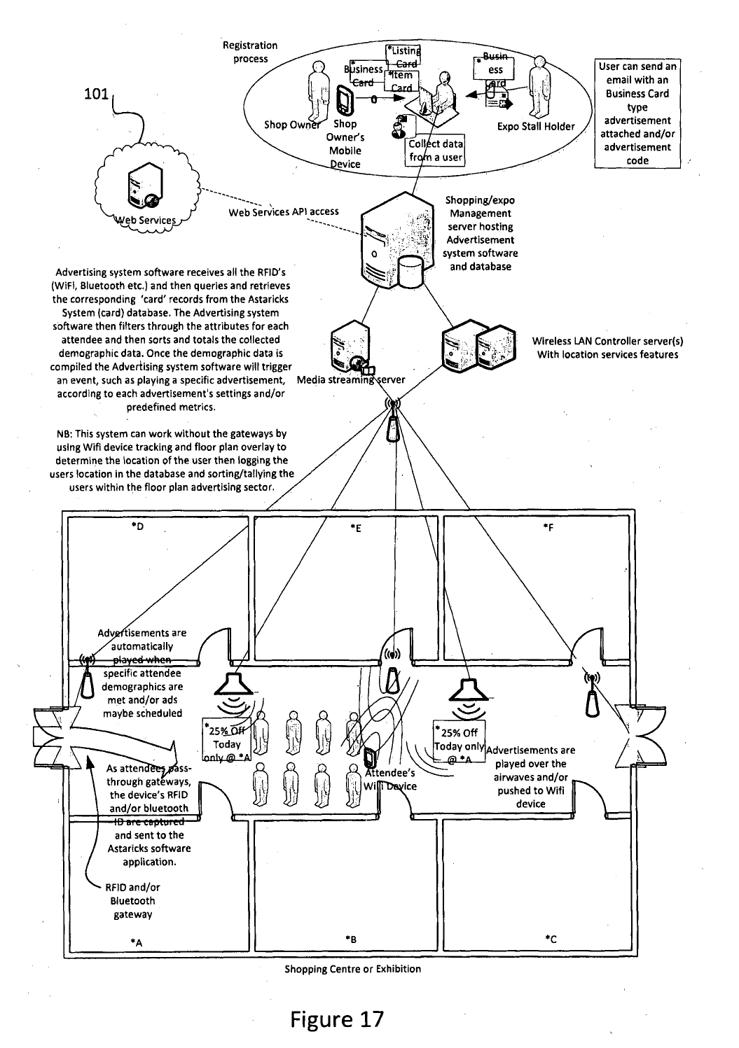

FIG. 17 is a schematic diagram of a management system for an exhibition in which one or more advertisements are provided to one or more users. Advertising system software receives all the RFID's (WiFi, Bluetooth etc.) and then queries and retrieves the corresponding ‘card’ records from the Advertisement System (card) database. The Advertising system software then filters through the attributes for each attendee and then sorts and totals the collected demographic data. Once the demographic data is compiled the Advertising system software will trigger an event, such as playing a specific advertisement, according to each advertisement's settings and/or predefined metrics.

It will be appreciated that the system may work without the gateways by using Wifi device tracking and floor plan overlay to determine the location of the user then logging the users location in the database and sorting/tallying the users within the floor plan advertising sector.

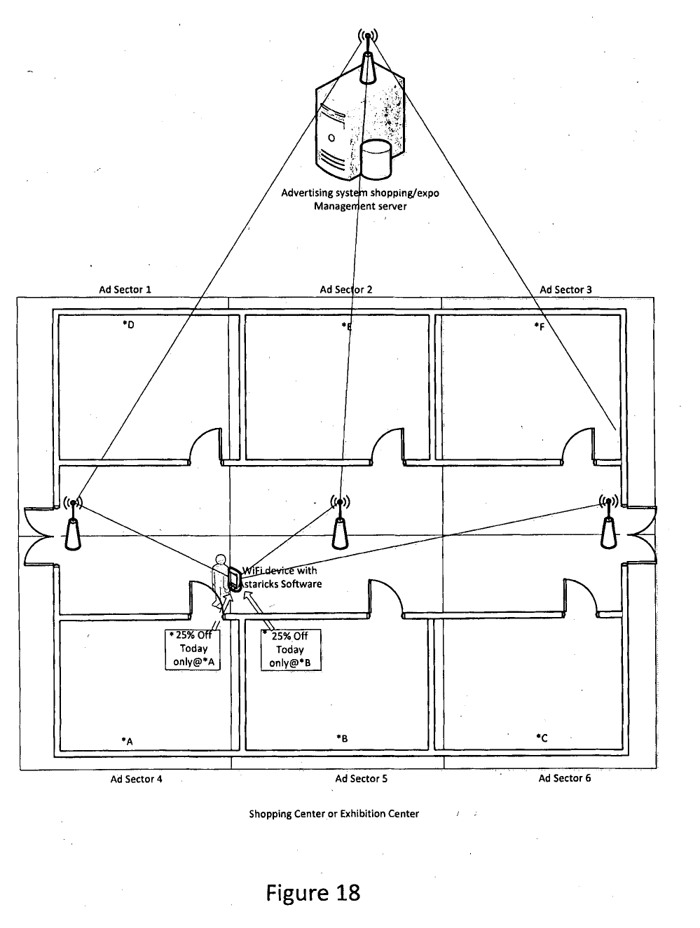

FIG. 18 is a graphical representation showing the system and method of the present invention detecting an end user carrying a device which has an advertisement which has been downloaded from a particular advertising sector which results in the advertisement belonging to a particular shop, in this case shop A and shop B being pushed to the end user device. FIG. 18 shows how the system works with a logical grid-division floor plan overlay for the proximity advertising pushes (i.e. that it is not dependant on the stalls\shops having a Wi-Fi\RFID device within the shop).

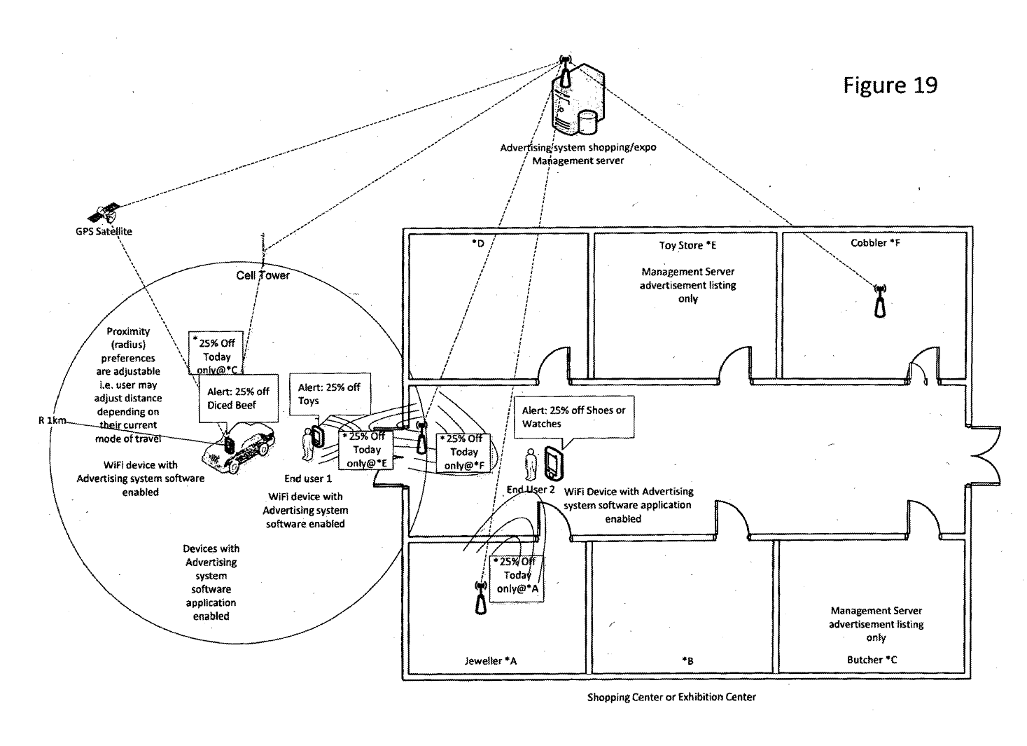

FIG. 19 is a graphical overview of the system of the present invention in which it detects an end user carrying a device in which advertising targeted at the user is provided based on the user's preferences. FIG. 19 alerts and aims to lure customers into the shopping center or arcade for the shops that have push out a new advertisement (i.e. that the system may extend beyond the confines of the building). FIGS. 17, 18 and 19 allow for proximity ‘push’ advertisements—for users with a mobile communication device that has location services capabilities. As will be described with reference to FIGS. 21 to 24a and 24b, the user can filter advertisements according to a starting point and the radial distance from this point both of which may be specified during a search. Alternatively, reverse location online searching may be provided in which the customer submits GPS device activity\trip log that contain the geographical datum points of a previous route, which the systems then matches and retrieves adverts according to a specified radial distance based along the route.

In the case of proximity push advertisements, a customer 103 has the ability to enable proximity advertisements and subsequently can manage what category of advertisements they what to receive including the ability to specify specific keywords and even price threshold for the advertisements to be received via their account manage portal, but more appropriately what distance they are from the advertisement subject matter as to when they receive an advertisement. This advertisement management mechanism is to ensure that each customer 103 has complete control over advertisement as necessary to avoid possible spam from users 102.

Advantageously, customers can enable location services for the advertisement application on their device and travel within the proximity of an advertisement subject matter, and they will receive an advertisement via the advertisement system's SMS or Email provider 210 and\or notification services 211 only for the advertisements that meets the customer's 103 chosen proximity advertisement settings.

For example, if a customer 103 specifies to receive any advertisements with the keyword and\or keywords such as “ladies shoes” “30%” and a proximity of 1 km, then when this customer 103 is within this proximity from an advertisement subject matter i.e. within 1 km of the outside of a shopping mall, or even within said shopping mall in some instances, and there is an advertisement that matches the customer's proximity keyword preferences, then the customer will receive the advertisement via the customer's chosen notification methods those being SMS, Email, or software application push notification. Furthermore, an advertisement may contain a map and\or floor-plan of the shopping center pin-pointing the location and detailing the directions to the advertisement's subject matter.

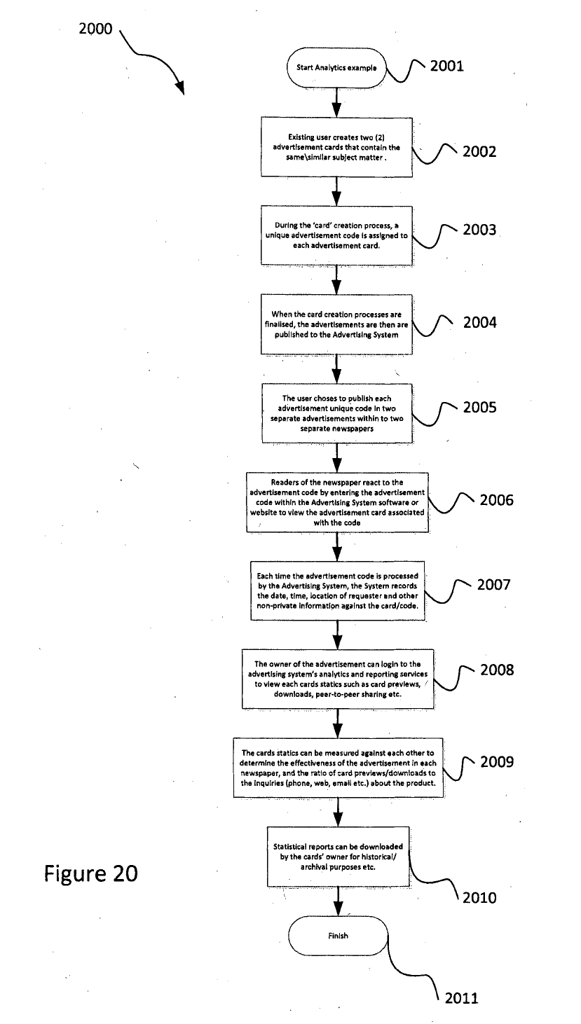

FIG. 20 is a method according to the present invention in which analytics against advertising downloads and views are provided to the owner of an advertisement. At step 2001 the process starts and at step 2002 the existing user creates one or more advertisements. Once the advertisements are created and during the creation process at step 2003, a unique primary and secondary identifier is assigned to each advertisement.

Control then moves to step 2003 in which, once the advertising creation process has been finalised, the advertisements are assigned a unique primary and secondary identifier and then are published in the overall system. Control then moves to step 2005 in which the user chooses to publish the primary and secondary identifier in one or more publications or media, each of the publications or media being uniquely identified by the secondary identifier. For example, the secondary identifier may be *ABC as a reference to the number location:
A=Card Type
B=Sub-card Type
C, D, E, . . . =Card ID

For example, if a department store runs an advertising campaign/product in a local newspaper (with code HN*555) and a corresponding the television advertisement for the same campaign/product (with code HN*595), the breakdown of the secondary identifier and the meaning being the position is as follows: the first number is the card type and 5=advertising card (as opposed to a business card or a coupon); the second number is the sub-type so in the example above 9=television advertisement and 5=newspaper advertisement; the third number is the card logical ID C=#5 and C=#5 also. This is allowable, but if, for example the department store wanted to run advertisements in two local newspapers, then HN*555 will not be unique so for one card it would need be HN*556 for example.

At step 2006 readers or users of newspaper or television in which the advertisements have been placed will react to the code provided by entering in the code within software or their mobile communication device to view the advertising details associated with the code. For example, in the case of a print advertisement, there may be a picture of a product and for more information on the product, the user simply enters in the unique primary and secondary identifiers. Control then moves to step 2007 in which each time a secondary identifier is processed by the server 101, the server 101 records the date time, location of the request and other known private information against the code. Control then moves to step 2008 in which the owner of the advertisement can use reporting services to view statistics for each advertisement, such as advertising previews, advertising downloads, forwarding of the advertisement. Where possible, a register that the card has been sent and opened on a PC but no recordal of user ID against the card are provided until the user has instigated a download or, if it is a Request Only or PIN then this will be registered when they log in to complete the Request Only and\or PIN process.

Control then moves to step 2009 in which each advertising statistics based on the secondary identifier can be measured against each other to determine the effectiveness of the advertisement. For example, the effectiveness of the advertisement in a newspaper, the ratio of the advertising previews to downloads to enquiries about the product, for example.

Control then moves to step 2010 in which statistical reports can be downloaded by the advertising owner for review. The method finishes at step 2011.

FIG. 21 is a schematic diagram showing a system 2100 of the present invention for retrieving advertising without reference to proximity.

The system 2100 for retrieving advertising without reference to proximity includes a user 102 who creates an advertisement with an advertising code, in this case code 417 and geographical code that is assigned. The advertisement may be a company with a listing advertisement, a bike for sale with an advertisement, house for sale with a Real Estate advertisement, vehicle for sale with a motor advertisement or a printed or electronic business card with which the advertising code 417 associated. The user is connected via a network such as the internet to a server 101 which includes a reporting service 105, master database 107, storage blob 108 and web role 104 (as described with reference to FIG. 1). The server 101 is in communication with the user 102 via analytics and reporting and also map provider 208, email provider service 210, customer 103 and third party notification services 211. The user 102 may also be connected to email provider service 210. The end customer 103 who enters the advertising code 417 into a search field within their web browser or software application, either on a computer or mobile device is connected to the server 101, mapping provider 208, third party notification services 211 which may provide a response to the customer on whether or not they were a winner in a competition or the response may be in the form of a discount coupon, location services 207 and the advertising code 417.

FIGS. 22a and 22b illustrates a method of retrieving advertising without reference to proximity as shown in the system of FIG. 21. Control starts at step 2201 where user 102 publishes an advertisement having code 417 on an online or offline medium, in this case it may be an advertisement on the side of the road, a physical business card or an electronic advertisement available online and the like. Control then moves to step 2202 where the customer 103 enters user 102 advertisement code 417 into a search field which is located on a web page in their browser or on a software application which may be associated with their mobile communication device.

Control then moves to step 2203 where web services 101 receives the advertisement code 417 and the customer 103 account details. Control then moves to step 2204 where web services 104 queries the advertisement code 417 against database 107. Control then moves to step 2205 where database 107 searches for advertisement code 417.

Control then moves to step 2206 where it is determined whether or not the database 107 has found a record entry for the advertisement code 417. In the event that it has not, control moves to step 2207 where the web services component 104 displays an unsuccessful retrieval code or display to the customer 103. Control then moves to step 2208 where customer 103 is determined whether or not the customer has entered another code. If not the process finishes at 2223, otherwise control returns to step 2202. If at step 2206 the database 107 found a record entry for advertisement code 417, control moves to step 2209 where web services 104 extracts the advertisement details from database 107. Control then moves to step 2210 where web services 104 checks customer 103 details with regard to validation and authorisation with respect to user 102 and their advertisement security and privacy settings.

Control then moves to step 2211 where it is determined whether security settings are applied to user's 102 advertisement. In the event that no security is applied to the advertisement, control moves to step 2212 where the web service 104 returns the user 102 advertisement to the customer 103 via their mobile communication device and/or computer. The same time at step 2213 location services 207 provides proximity in distant to the advertisement. Step 2214 via mapping provider 208 sends map and navigation information for the advertisement. Step 2215 notification services 211 may send notification to user 102 and optionally at step 2217 analytical and reporting database 105 or database 107 may record statistics on demographic data against the advertisement. Control then moves to step 2216 where the customer 103 is presented with an option to store or keep the advertisement on their computer or mobile communication device. Control then moves to step 2218 and it is determined whether or not the customer wishes to retrieve the advertisement. In the event the customer does not wish to retrieve the advertisement the method finishes at step 2223 otherwise control moves to step 2219 where the completed advertisement including the code 417 is stored on the customer 103 computer or mobile communication device or blob storage 108. Blob storage can be allocated to each customer (and user alike) for storage of advertisements, either partially or wholly which may be used for backup purposes and/or for the management portal to and display the advertisements that have been retrieved by the customer/user.

At step 2219 it is also possible for analytical and reporting database 105 or database 107 to record statistical and demographic data against the advertisement at step 2217. Control then moves to step 2220 where database 107 records the customer 103 as “holding” the advertisement. The advertisement may be updated at any time at step 2221 as previously described with reference to FIG. 2.

Otherwise or at the same time the process finishes at step 2223. If at step 2211 there were security measures associated with the user's 102 advertisement, control moves to step 2222 where it is determined whether or not the customer 103 passes the security measures. In the event that they do, control moves to step 2212 and the method continues as described above. Otherwise control moves to step 2223 where the method ends.

FIG. 23 is a schematic diagram showing a system 2300 of the present invention for retrieving advertising with reference to proximity. The advertising retrieval system 2300 includes the user 103, who creates an advertisement which has an advertising code, in this example the code is 417 and geographical code are assigned. The advertisement may be a company with a listing advertisement, a bike for sale with an advertisement, a house for sale with a real-estate advertisement, a vehicle for sale with a motor advertisement or a printed or electronic business card for example. The user 102 is in communication with a server 101, email provider service 210 and location services 207. The server 101 may include a database 107 and web roll 104 which in turn is connected to an end customer 103 who would enter the advertisement code 417 into a search field within their web software application or mobile communication device. The customer 103 is connected to another server 101. The customer is also connected to a mapping provider 208, third party notification services 211, the advertisement 417, location services 207. The server 101 is also connected to email provider service 210, the user 102, mapping provider 208, third party notification services 211.

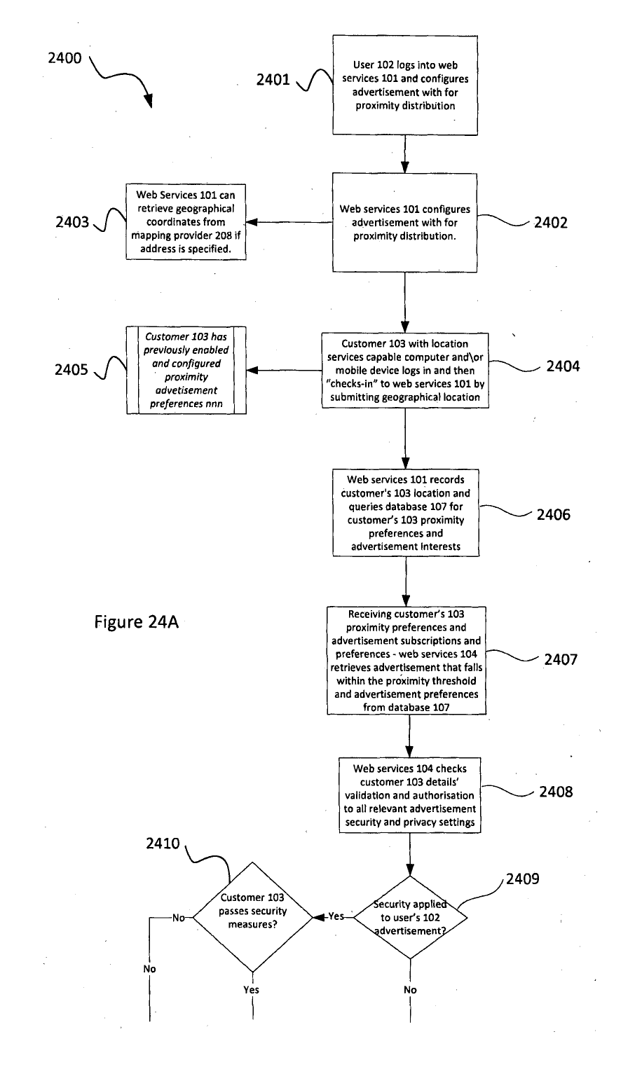

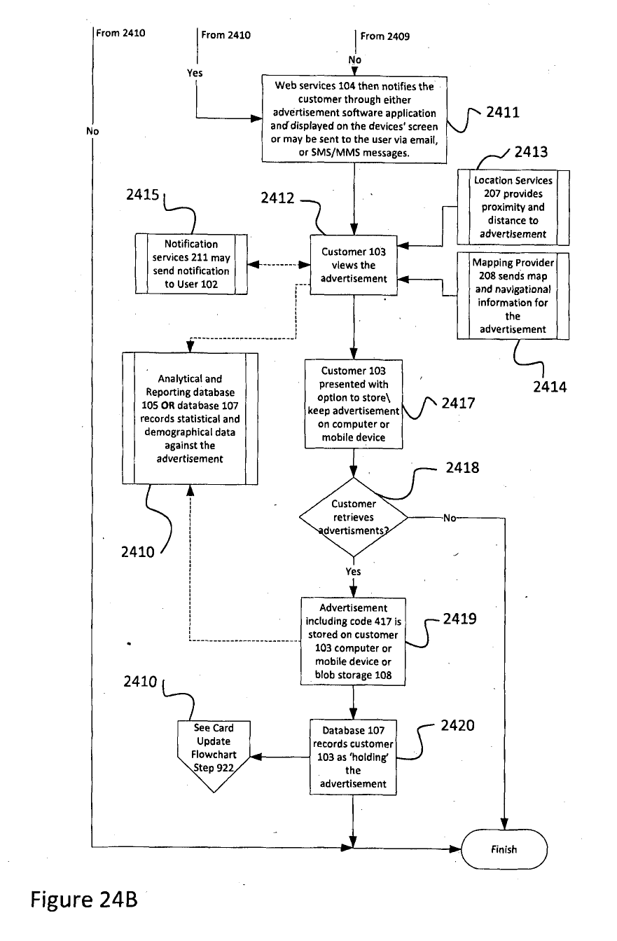

The operation of this system will be further described with reference to FIGS. 24a and 24b which illustrates an advertisement retrieval method 2400 for retrieving advertising with reference to proximity. The method starts at step 2401 in which a user 102 logs into web services 101 and configures an advertisement for proximity distribution. Control then moves to step 2402 where web services 101 configures the advertisement for proximity distribution. At step 2403 web services 101 can retrieve geographical recording and that is from mapping 208 if an address is specified. Control then moves to step 2404 where customer 103 with location services enabled on their computer and/or mobile communication device logs into the system and checks web services 101 by submitting a geographical location. At step 2405 the customer 103 has previously enabled and configured proximity advertisement preferences—the customer 103 may specify what advertisement types (types pertaining to the advertisement system) and\or categories\keywords\tags applied to advertisements allowing for the customer to tailor\filter the advertisements that the customer 103 wants to receive.

At step 2406 web services 101 records customer 103 location and queries database 107 for customer 103 to proximity preferences and advertisement interests. Control then moves to step 2407 where the customer 103 proximity preferences and advertisement descriptions and preferences are received and web services 104 retrieves advertisements that fall within the proximity threshold and advertisement preferences from database 107. At step 2408 web services 104 checks customer details 103 validation and authorisation to relevant advertisement security and privacy settings. Control then moves to step 2409 where it is determined whether or not security has been applied to the user 102's advertisement. In the event that there has been security applied control moves to step 2410 where it is determined whether or not the customer 103 passes the security measures. In the event that they do not control step 2422 where the method ends otherwise control moves to step 2411. In the event there was no security applied to the user's advertisement at 2409 control also moves to step 2411 where web services 104 then notifies the customer through either an advertisement software application and displays on the device screen or may be sent via the user's email or sms or mms messages. Control then moves to step 2412 where the customer 103 views the advertisement and at step 2413 location services 207 provides proximity and distance to the advertisement. Step 2414 provides via mapping provider 208 a map and navigational information for advertisement. Step 2415 via notification services 211 sends notification to the user 102 optionally. Step 2416 optionally analyses and reports via database 105 or database 107 statistical and demographic data writing to the advertisement. Control then moves to step 2417 where the customer 103 is presented with an option to store or keep the advertisement on their computer or mobile communication device. At step 2418 it is determined whether or not the customer wishes to retrieve the advertisements. In the event that they do not control moves to step 2422 where the method finishes, otherwise control moves to step 2419 where the advertisement including the code, in this case 417 is stored on the customer 103 computer or mobile communication device or blob storage 108. Blob storage can be allocated to each customer (and user alike) for storage of advertisements, either partially or wholly which may be used for backup purposes and/or for the management portal to and display the advertisements that have been retrieved by the customer/user.

At the same time if not already done at step 2416 analytical and reporting database 105 or database 107 may record statistical and demographic data against the advertisement. Control then moves to step 2420 where database 107 records the customer 103 as ‘holding’ the advertisement. At step 2421 the advertisement may be updated periodically as being described with reference to FIG. 2.

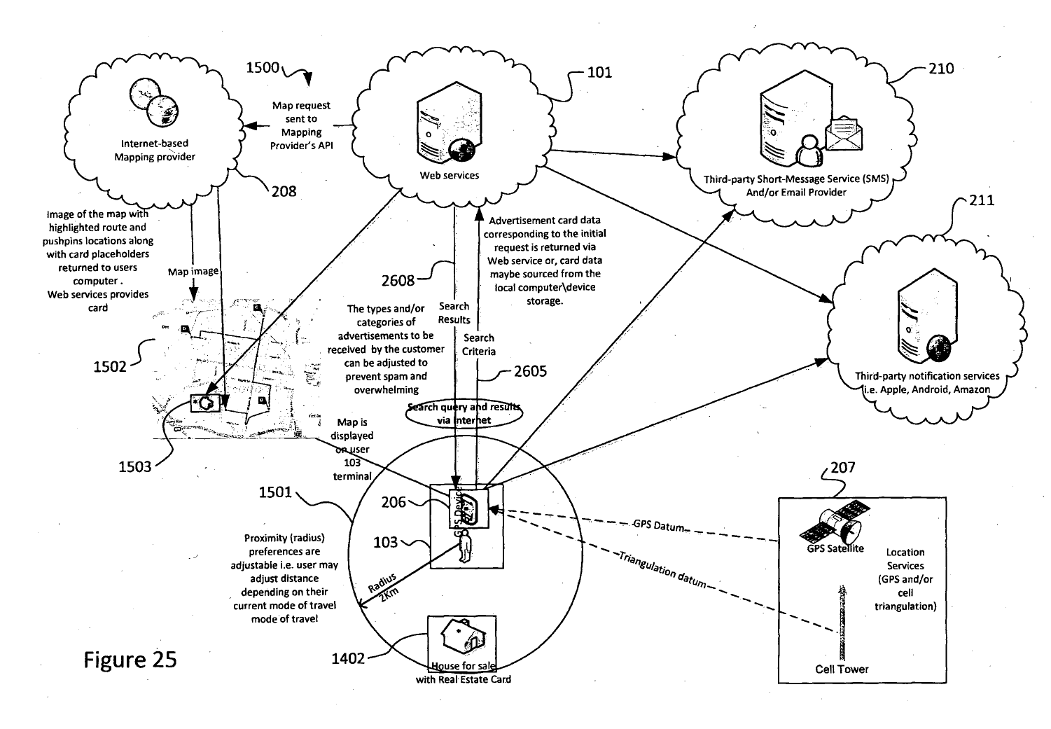

FIG. 25 is a schematic diagram of the advertising system search process with location services. The diagram depicts a customer 103 having searched for properties (in this case) within 2 kms, possibly with a selection of search filters\keywords that were entered within the search query, and one valid advertisement (search result) being sent and subsequently viewed upon device 206.

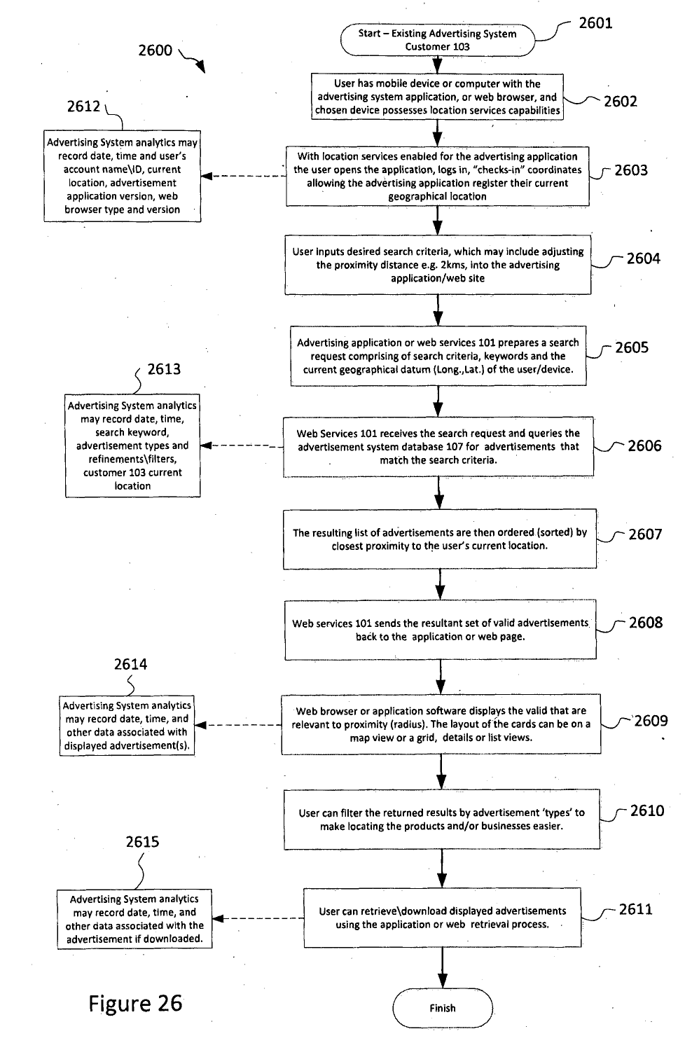

FIG. 26 is a flow diagram illustrating an example method 2600 relating to the advertisement system proximity search schematically shown in FIG. 25. Step 2601 is an existing Customer 103 of the advertising system. At step 2602, the customer 103 has a device or computer with the advertising system software application and\or internet connectivity and the chosen peripheral has location services capabilities. At step 2603 it is determined that that the customer has enabled location services for their device 206, has opened the advertising application or uses a web browser to the advertising web site and has satisfied any advertising system login, in conjunction with location services 207. The customer 103 can then submit or “check-in” their geographical coordinates, at which point the application or web browser may begin to track the customer 103. At step 2604 the customer 103 inputs desired search criteria that may include specific filters such as categories or keywords\tags. At step 2605 the advertising system software application or web browser constructing the search request and submits the search to web services 101. At step 2606 a search request is provided and the database 107 is queried for any advertisements that matched the search criteria. Optional step 2613 provides the ability for the advertising system analytical recording data such as date, time, search keyword, advertisement types and refinements\filters, and\or customer 103 current location. At step 2607 the database 107 returns a list of matching advertisements, which may be ordered (sorted) by closest proximity to the user's current location. At step 2608, web services 101 sends the resulting set of valid advertisements back to the application or web page. Next at step 2609 the web browser or application software displays the advertisements that are relevant to customer 103 based on proximity (radius). The layout of the advertisements, if multiple advertisements are returned, may be provided in a map view represented by ‘pushpins’ 435 or a grid, details or list views. Services receiving the search 1402 is a valid advertisement within the advertising system, the web services 101 triggers an advertisement notification process and notification services 210 and\or SMS and email service 211 sends a notification to customer 103 device 206. The advertisement data payload of any notification method may contain the an advertisement with the entire details or a subset of information i.e. a Uniform Resource Identifier (URI) of the real estate advertisement. As will be further described with reference to FIGS. 31a to 31g, a Customer 103 and their device 206 having received an advertisement notification, which in the example given was contained a URI (hyperlink) to the mapping provider 208. The customer 103 may actioned the URI and programmatically trigger a map 1502 indicating the location of the property via a pushpin 435 being sent to and ultimately displayed on the device 206. The pushpin 435 may be an advertisement tailored to suit the devices 206 screen size and may be active upon a customer 103 action\click\select\open on pushpin 435. When the pushpin 435 it actioned, provided the device 206 has the advertising system software application installed, the customer 103 may preview the advertisement and\or download then view the advertisement in its native advertisement (template) layout.

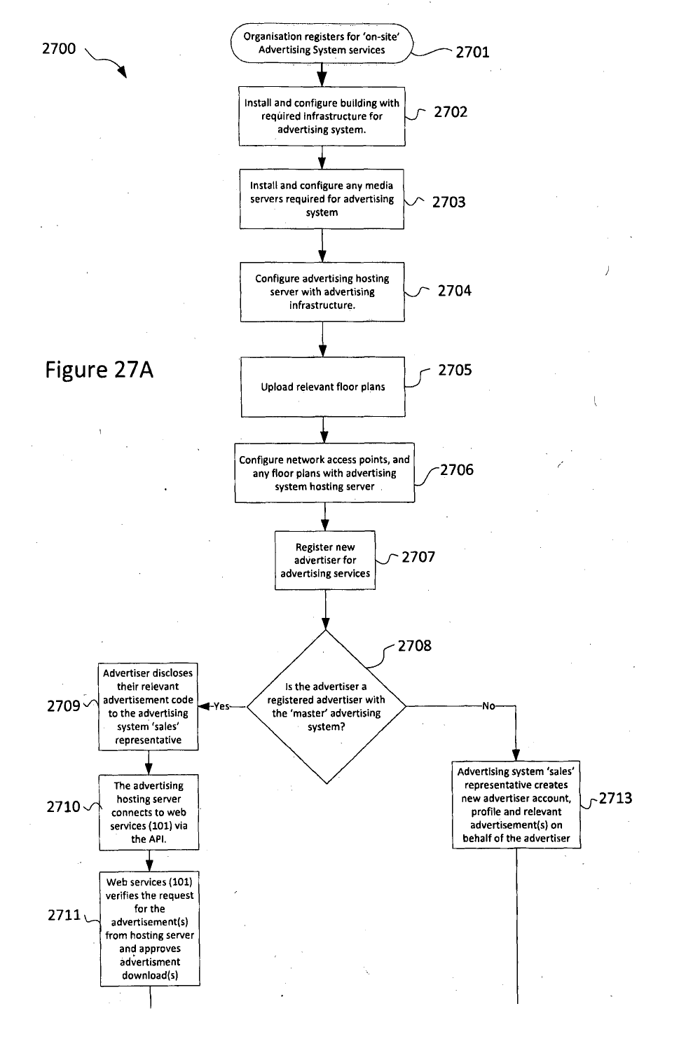

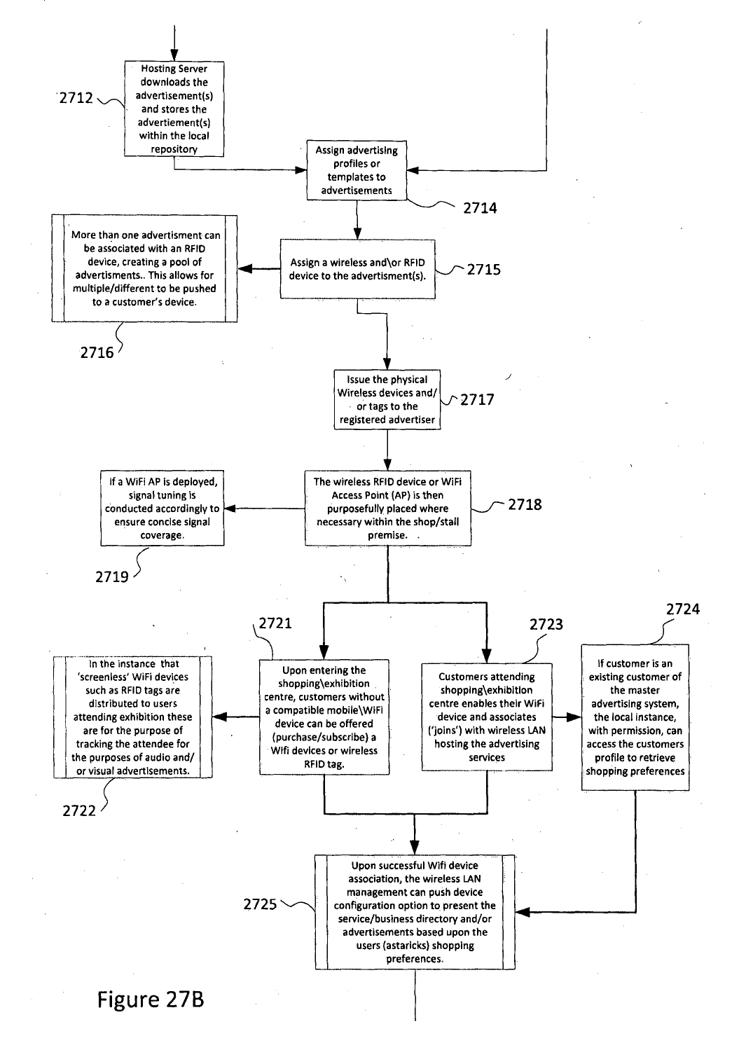

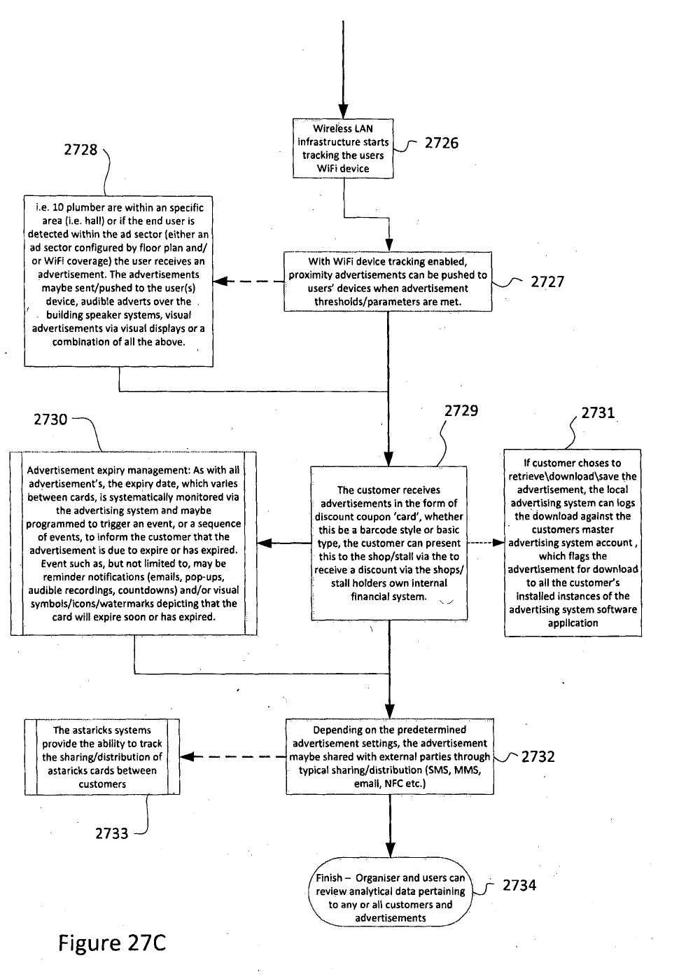

FIGS. 27a, 27b and 27c is a flow diagram illustrating an example method 2700 relating to ‘on premises’ wireless device tracking and proximity advertising. It beings with step 2701 whereby an organisation, be it the operator of a shopping mall, or exhibition operators, requests access to the advertising system services, allowing the organiser to deploy the advertising system on site, which may be a standalone instance of the advertising system. Where necessary, step 2702 may include the installation and configuration of the required wireless network infrastructure, which may be third-party hardware and\or third-party software, for the advertising system within the building or site. The building\site may be configured with new proprietary wireless device location controller and supporting wireless networking equipment, although the existing wireless local network infrastructure may be sufficient and integrated accordingly. Any new/existing network access points are strategically positioned and\or signal strength tuned to provide unambiguous floor coverage throughout the building\site to ensure wireless devices can connect and communicate with the network to provide accurate wireless device triangulation. At step 2703 installation and configuration of media servers required for the playback of any audio\visual advertisements may be provided. Once the required wireless networking infrastructure has been configured, step 2704 is the deployment of the advertising system ‘hosting’ server, an on premise server that takes on the role of web services 101, which can be configured on one or a similar number of servers as web services 101 depending on the system performance requirements usually proportional to the number of users and customer. The hosting server may be configured and connected to existing/new wireless LAN infrastructure and, where necessary, any media streaming equipment within shopping/exhibition centre. Additionally, at step 2704 the default visual/audio advertisement playback settings i.e. advertisement triggers, thresholds and parameters can be customised as necessary. At step 2705, digital representations of the building\site floor plan may be uploaded to the local advertisement system and, uploaded to the wireless network controller if not already done during the configuration of the wireless infrastructure. Step 2706 is the configuration and logical positioning of the wireless access points on the uploaded floorplan(s) for both the wireless network and local advertising system. The uploading of floorplans plays an integral part for not only the wireless network configuration and the visual display of device tracking but importantly it simplifies how advertisements are administered allowing for the ‘drag-n-drop’ of advertisements to be assigned to ad sectors, being the area\location for which any given advertisement is configured for delivery\playback to customers. At step 2707 users may be registered (stall holder, exhibitors and the like) within the newly configured local advertising system. The user can chose the advertising plan that may be based upon: What advertisement to deliver? How is the advertisement delivered? Where to deliver? When to deliver? In addition there may be other services offered by the organiser such as inclusion in the local business directory, external advertising, and analytics. At step 2708, the user's details and\or advertisements are collected by the organiser whereby the user is asked if they are any existing users of the master advertising system. If yes, step 2709 the user can tell the organiser the advertisement codes associated with the advertisement system advertisements and business\contact card. The sales agent then enters these codes into the local hosting server advertisement application. At step 2709, the codes may be transferred to the local advertising application via Near Field Communication (NFC), or may even be sent via email to the sales agent who then actions the URL within the email to retrieve the code and add the business card to the local advertising system. In step 2710, the hosting server connects to master advertising system web services 101 via an API. At step 2711, web services 101 verifies the request and approves the advertisements for download, which at step 2712 the corresponding advertisements are downloaded by the local hosting server and stored in the local advertising system database and storage repositories. Conversely, if at step 2708 the user is not an existing master advertising system user, at step 2713 a sales agent can register the user with the master advertising system on their behalf. Once the users details have been create\collected and an advertising system user account has been created on both master and local systems, at step 2714 the sales agent may create and assign advertisements on the local advertisement system instance via the API to the master advertising system installation, or, the existing advertisements previously created by the user may be downloaded. Next, step 2715 the sales agent logically assigns devices to the advertisements within the local instance. Side step 2716 is the provision for more than one WiFi access points, ad sectors, and\or RFID can be assigned against an advertisement, this allows for the same advertisement to be targeted and received at different locations throughout the building\site. At step 2717 the user, may be issued with physical WiFi\RFID devices if necessary and at step 2718 the assigned WiFi\RFID devices may be installed\positioned within the user's shop\stall. The purpose for physically deploying WiFi\RFID devices to each user is to make the local advertising system extremely flexible and manageable—Deploying these devices means that the digital floorplan topology can be dynamic and accurate i.e. contains correct user information and the precise physical location. Ultimately, the organisers need only to upload the floorplan, logically position the WiFi access points on the digital floorplan then, each time a WiFi\RFID device is physically associated\detected within the building\site, the users' location and the users' details are extracted from the local advertising system instance and the information can be published on screen and\or overlayed on the floorplan. Also, if a user needs to move shop or stall location, cancels their attendance or updates their details, then the local advertising system updates all the details as needed, which in turn allows for the updates to be reflected on any electronic event map, business directory or the like. One problem and cost concern that event organisers face today is that if and when any users' detail change any printed material and\or static web site content about the users is out-dated and a cost is typically incurred for the updating republishing of the information. At step 2719, the position of the WiFi\RFID devices allows for the signal tuning of the wireless access points to ensure advertisements can be accurately delivered to attending customers. Control moves to 2721 and 2723, which are divided stages. Step 2721 is the issuing of compatible mobile WiFi devices to customers who do not have such a device when attending the building\site i.e. entering the shopping\exhibition center. Compatible mobile WiFi devices may include but are not limited to tablet computers, smart phones, digital media players, and includes instances of such mobile WiFi capable devices fitted to shopping trollies, baskets, or, compatible mobile WiFi devices that have been purpose built, configure and locked down to the particular shopping\exhibition organiser outlets. The latter allows for competitive marketing strategies, and simply protects the organiser's investment for acquiring such specific devices. Step 2722 is an optional step and is cost alternative to issuing mobile Wifi devices whereby less expensive RFID tags can be given to customers upon entering\registering. Whilst RFID devices such as ‘tag’ types don't have visual displays, customer issued these devices are for the purposes of audio\visual advertisement playback and\or statistical data collection about the customers habits and interest. In any instance of 2721 and 2723 the sales agent can complete steps 2713 and 2714 creating an advertising system account an advertisement business\contact card on behalf of the customer. As mentioned, contrary to step 2721 is step 2723 and is for customers with a compatible mobile Wifi device or RFID ‘tag’. If the customer is a non-existing customer of the master advertising system, a sales agent can complete 2713 and 2714. If the customer is an existing advertising system user, and hasn't previously been registered with the shopping\exhibition centre's local advertising system instance the sales agent can complete steps 2709 to 2714, effectively registering the customer within the local advertising system instance. Step 2724 is optional and provides the ability for the local advertising system instance to retrieve the shopping preferences (i.e. wants, needs and interests) specified\published of the existing customer, although the customer may approve access to this information by the local instance. If these preferences are retrieved by the advertising system these can be associated with the customers WiFi\RFID device within the local advertising system instance. By doing so, this can establish an ad-hoc customer profile within the local advertising system instance. These collected shopping preferences or ‘interests’ are used to present targeted advertisements, such as specials, coupons, members only specials, to the customer that match their shopping preferences. The advertisements that are sent to the device offer the same functionality and detail as with any advertisement created by the main advertisement system e.g. item image, product specifications and pricing; business card image and contact information, but in addition the local instance can be deliver and display a floor plan or map highlighting the location of the business, including directions on how to get to the location. At step 2725 the customer's mobile WiFi device, namely smartphones, tablets, laptops\ultrabooks etc. having now been associated with the wireless location services infrastructure, may, in conjunction with the local advertising system instance, receive customisations, profiles and\or specific applications required for the customer's interaction with the advertising system, this may include the aforementioned main advertising system software application. (NB: due to the current technological design of numerous RFID devices, these are excluded from this step 2725.) With the WiFi\RFID devices registered, associated and configured\customised by the local advertising system where necessary, control moves to step 2726 and the wireless location services infrastructure begins tracking the customer's WiFi\RFID. With the customers being tracked via their registered WiFi\RFID device, then at step 2727 advertisements can now be delivered and\or played back according to each advertisement's triggers and\or thresholds as specified at step 2714. Side step 2728 is the local advertisement system instance receiving tracking feeds from the wireless device location services tracking, being the combined systems, have tracked ten (10) customers, who's occupation is registered as being a plumber, or associated there with, and when these ten ‘plumbers’ are detected within the ad sector an audio advertisement that is associated with the ad sector, and a playback trigger count of ten customers with plumbing attributes, the advertisement is played. In step 2729 is an example whereby the customer received an advertisements in the form of discount coupon ‘card’, whether this be a barcode style or basic type, the customer can then present this to the shop/stall via the to receive a discount via the shops/stall holders own internal financial system. Step 2730 is an example of advertisement management coming into effect regarding the expiry date of an advertisement. As with all advertisements, the expiry date of the advertisement is systematically monitored by either the local and master advertising system and maybe programmed to trigger an event, or a sequence of events, to inform the customer that the advertisement is due to expire or has expired. Event such as, but not limited to, may be reminder notifications (emails, pop-ups, audible recordings, countdowns) and/or visual symbols/icons/watermarks depicting that the card will expire soon or has expired. As mentioned, the master advertisement system can monitor the expiry date of the advertisements relating to the local advertisement system as to provide coverage for customers after their shopping\exhibition experience, and the master advertising system can subsequently trigger alerts and notifications or push advertisement updates to a customer's registered WiFi device or to the advertising system software application. At step 3731, if the customer choses to retrieve\download\save the advertisement, the local advertising system can connect to the master advertising system via the API and register the advertisement download against the customer's account, which in turn ‘flags’ the advertisement for download by any instance of the advertising system software application used by the customer. At step 3732, depending on the predetermined advertisement security settings, an advertisement maybe shared with other customers of either the local or master advertising system via typical sharing/distribution (SMS, MMS, email, NFC etc.) as programmed within the advertising system software application. If and when advertisements are shared between customers, side step 3733 mentions the ability for the local and\or master advertising system's analytics to record the event such as what was shared, when was it shared, who shared, who received, what happened when the receiving customer opened the advertisement, if the advertisement was opened, deleted etc. Finally, at step 3734 the organiser and the users can review all the advertisement and customer analytical data collected by the local and master advertising systems, such as customers' tracks, commonly called a spaghetti map taken from the Lean Sigma toolkit; customers' time spent within a shop\stall, customers' usage of advertisement system i.e. business directory usage, and, both the organiser and user can review an advertisement's collected statistics and determine its effectiveness.

FIG. 28 is a sub-process relating to FIGS. 9a and 9b (Advertisement Update Process). It will be appreciated that a user's imaging device may have the advertising software application installed, as with mobile devices (206), although it is possible for devices such as digital imaging devices (205) (including digital video cameras) will have the advertising system software application embedded, similar to how YouTube®, Facebook® and Flickr® are presently embedded in these devices. Have the advertising system software application available in one way or the other allow a user to login and upload images (and where possible, video) directly from the imaging device via WiFi internet communications to the advertising system whilst on location. At step 2801 the user is prompted to complete step 901 to step 906 of FIGS. 9a and 9b (e.g. connect to web services 101, login to account, select advertisement to edit) and then control moves to step 2802 where the user selects the option to update the geographical location of an advertisement, which in this example is a car being advertised for sale on the side of the road. At step 2803, the user may choose to use a geo-tagging capable imaging device or an alternative device. If the user has a geo-tagging capable imaging device control moves to step 2804, or, for alternative devices, control moves to step 2808. At step 2804 the user takes a photograph within a 3m proximity to the subject matter (the closer the better to ensure accurate positioning). Moving on to step 2805 the user selects the new image(s) containing the updated geographical datum and uploads the image(s) to the advertising system via the installed\embedded advertising system software application. At step 2806 the web service 101 receives the image(s) and extracts the geo-tag (and maybe other metadata) from the image(s) and updates the geographical location on the advertisement form. Then at step 2807 a visual representation of the item's geographical location of the can be displayed on screen via a pushpin on a digital map obtained via the internet-based mapping provider 208. However, for the users without an imaging devices or devices that are not capable of geo-tagging images, control moves from step 2803 to step 2808 querying the user if they have a device with location services or not. If the user has a device with location services the control moves to step 2809 where the user selects the update location button\check-in option located on the advertisement edit form. If the user does not have a device with location services, control moves from 2808 to step 2810 whereby the user may use a an internet-based mapping provider or application to determine the location then extract\copy the datum, which control moves to step 2811 where the user enter these values into the advertisement edit form. In either case of the method used to update the items location, control moves to step 2807 where a visual representation of the item's geographical location of the can be displayed on screen via a pushpin on a digital map obtained via the internet-based mapping provider 208. Once the coordinates at step 2812 are determined the user can confirm or reject the item's updated geographical location. If the item's ‘pushpin’ location is not correct as shown on the digital map, control moves back to step 2802 to repeat the steps in order to correct the location. If the user is happy with the item's new location, control moves to step 2813, which is the end of the FIG. 28 sub-process flowchart, and in summary, control returns to FIGS. 9a and 9b and continues from step 911 whereby the user is required to review the changes made to the advertisement before confirming privacy and security settings, accepts final review\changes, makes the necessary payments and the advertisement is saved and published via web services 101.

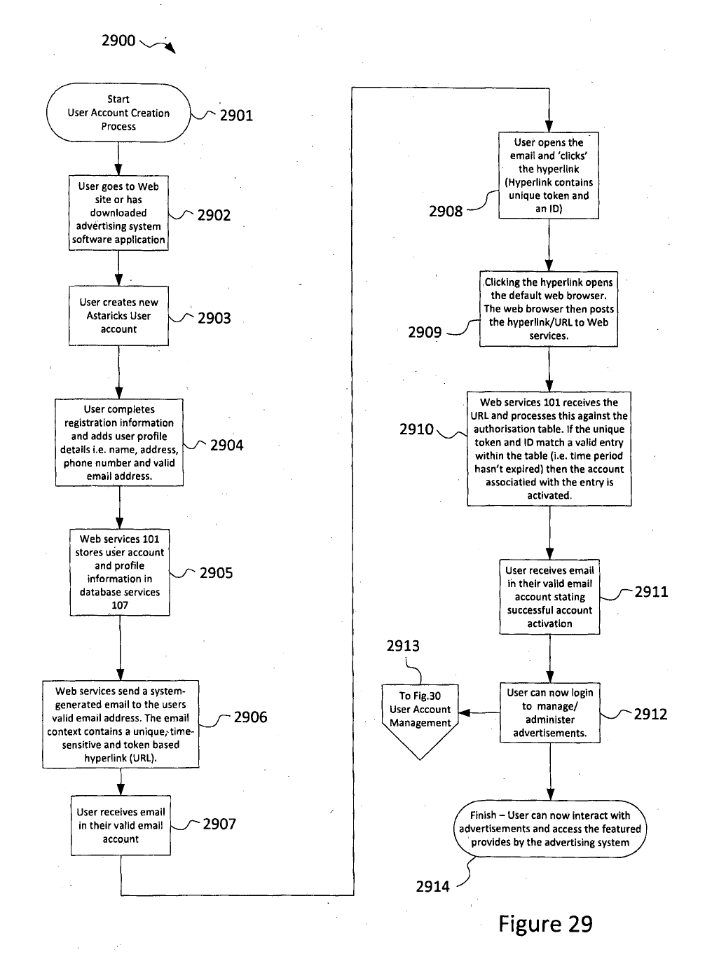

FIG. 29 is a flow diagram illustrating an example method 2900 illustrating user account creation. At step 2901 where a new user has decided to ‘join’ the advertising system (either via the advertisement systems' web site or software application) control moves to step 2902 and where the new user is prompted to “sign-up” to the system and at step 2903 the user completes the required registration information and enters their profile details i.e. name, address, phone number and valid email address via a typical form\method associated with most internet-based user accounts. Once completed, control moves to step 2904 where Web services 101 stores user account and profile information in database services 107. Next at step 2905 Web services 101 sends a system-generated email via Email services 210 to the users valid email address. The email context contains a unique, time-sensitive and token based URL, maybe in the form of a hyperlink or button. Step 2907 the new user receives email in their valid email account. Control moves to step 2908 where the user opens the email and actions the URL. As an example, step 2909 portrays a situation whereby the user actions the hyperlink causing the devices default web browser to open and the web browser then posts the URL to Web services 101. Control then moves to step 2910, Web services 101 receives the URL and processes this against the authorisation table. If the unique token and ID match a valid entry within the table (i.e. time period hasn't expired) then the account associated with the entry is activated. Once the account has been successfully activated, control moves to step 2911 and web services 101, via email services 210, send a confirmation email back to the user's email account informing the user that their advertising system user account creation was successful. Control then moves to step 2912 mentioning that the user can now login to the advertising system and begin managing advertisements, which is shown on the flowchart as a step 2913. Control moves to the finishing step 2914 and the user now interact with the advertisements associated with the advertising system and access advertisement features provided by the system.

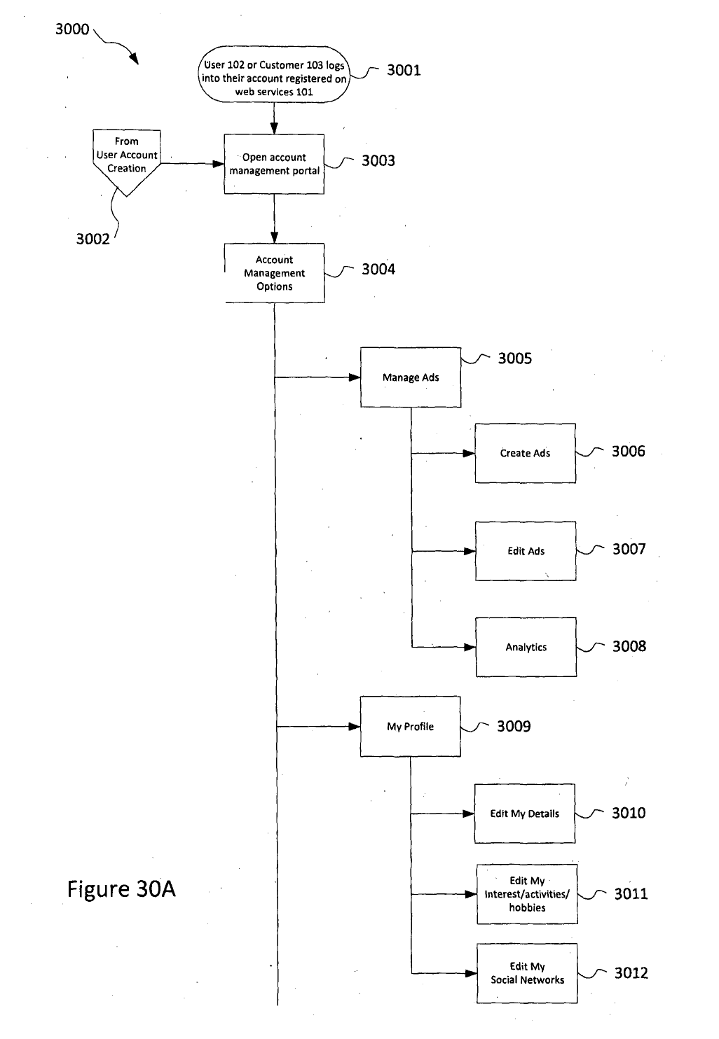

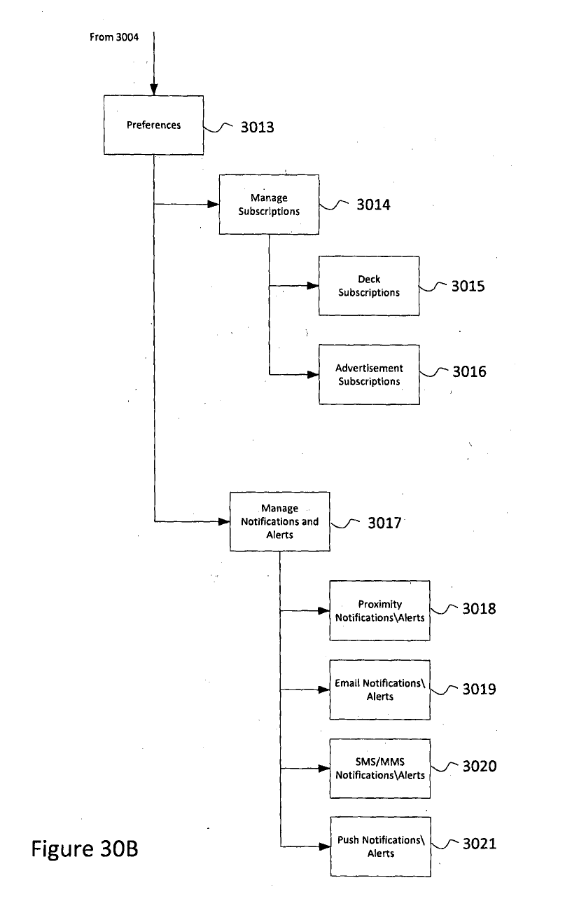

FIGS. 30a and 30b is a flow diagram illustrating an example method 3000 of operation of the user account management portal. Whilst it is referred to as a ‘user’ account, customers fall within the term ‘user’ with respect to using the management portal. Starting at step 3001 the user logs into their advertising system account via web services 101. Step 3002 is joined to step 2913 of FIG. 29 after a new user account has been created. at step 3003 the user opens the management portal and at step 3004 the user selects the account management link\button, exposing the numerous options and features pertaining to the advertising system, examples such as: step 3005 “Manage Advertisements”, step 3006 “Create Ads”, step 3007 “Edit Ads”, step 3008 “Analytics”, step 3009 “My Profile”, step 3010 “Edit My Details”, step 3011 “Edit My Interests\Activities\Hobbies”, step 3012 “Edit My Social Networks”, step 3013 “Preferences”, step 3014 “Manage Subscriptions”, step 3015 “Deck Subscriptions”, step 3016 “Advertisement Subscriptions”, step 3017 “Manage Notifications and Alerts”, step 3018 “Proximity Notifications\Alerts”, step 3019 Email Notifications\Alerts, step 3020 “SMS\MMS Notifications\Alerts”, step 3021 “Push Notifications\Alerts”.

FIGS. 31a to 31g is a flow diagram illustrating the method of FIGS. 11a and 11b in more detail, namely the sending, receiving, sharing and synchronising of advertisements though via email system, in the context of a business network email service, such as Microsoft Exchange® Server and Microsoft Outlook (client) including web client. As described in FIGS. 11a and 11b, the flow diagram details the circumstances from the receiving side, which is the same user receiving the same and\or updated contact from the email server and\or from the advertising system, and, the circumstances if and when a customer receives the contact i.e. if the contact is shared via the email system. The advertising system email client-server integration caters for two instances—both with and without email server integration. For the instance of an email server without integration, FIG. 31a begins with step 3101 with the user 102, who has an email account and necessary email client software which is associated with an email server that allows for synchronisation such as Microsoft Exchange or Lotus® Domino®. In this instance, at step 3102 the user 102 downloads the Advertising System software and then at step 3103 the user installs the software on to their local computer and\or mobile device with the option to include the email client add-in. Control moves to step 3104 with the user opening their email client, which leads to step 3105 whereby the new installed advertising system add-in prompts the user login with their Advertising System username and password. Step 3106 of the process allows for the interpretation for whether or not the user is an existing user or not. If they are not an existing user, control moves to step 3108 allowing for the user to register for a new advertising system account. Once the user has registered or, the user is an existing user, control moves to step 3107 whereby the user logins in to the advertising system via the software. Following a successful login, control moves to step 3109 and the advertising software will download to the advertising system software any new or previous advertisements that the user may have requested and\or retrieved. After the retrieval of the advertisements, control moves to step 3110 with the advertising system email add-in scanning the downloaded advertisements for any applicable advertisements typically contact cards such as company listing cards, business cards and personal cards. After scanning, control moves to step 3111 and for any contact cards that have privacy protection applied, these are process and may be exclude from importing into the email client software as a means to prevent circumventing any privacy protection in place. Once the email add-in has correlated the advertisements to be imported into the email client software control moves to step 3112 and the user may be prompted with a list of advertisements e.g. contact cards that are available for importing. Control moves to step 3113 whereby the user confirms the selection of contact cards to be imported into an address book or the like within the email client. Control moves to step 3114 where the advertising system software email add-in creates the address book. Whilst it is not absolutely necessary to create a new address book solely for the import and management of advertising system contact-type advertisements, but doing so allows the email add-in to apply, better and simplistic management and set specific security settings. Control moves to step 3115 and the email add-in extracts the contact card dataset from the downloaded cards and imports the data into a new contact for each, which the contact being created may be in a native format to the email client. Control moves to step 3116 whereby any advertising system contact card that is private and is permitted to be imported into email clients may have a specific, reduced dataset that is stored within a new native contact. Again, this is for security measures to ensure that if a user ever removes the advertising system email add-in or, a virus is coded to “scrape” and forward the infected user's address book that the data accessible is not private data as specified by the advertisement's creator. For cards that are private, control side-steps to step 3117 whereby the email add-in will set the email client's native privacy\security settings for each applicable new contact. Control moves to step 3118, which takes into account the native email client-server synchronisation as defined by the server\client settings. Control moves to step 3119 which highlights that the server-side address book of the user's email account will contain a replica of the newly created contact now stored in the local address book. As previously mentioned, local address book contacts that were created from imported advertising system contact cards only have the contacts advertising system's ‘public’ dataset extracted to ensure that private data is not stored on the email server, which could potentially undermine the contact card's advertising system privacy and security settings. From step 3119, control breaks out into three different scenarios—step 3120 is applicable to the same user but on a different computer\mobile device with or with the email add-in installed; step 3144 is applicable to users and customers using an online\web accessible email client; and step 3149 is applicable to a shared address book scenario and whether the address book is shared from the email client or the email server. For the step 3120 scenario, for an email client without the advertising system software email add-in and is in an email client-server relationship, control moves to step 3121 whereby the email client will synchronise the local address book with the server-side address book as defined by the server\client settings, and any new (or updated) contacts irrespective of origin will be imported. Control moves to step 3122 which depicts that a user has opened a contact that is of the advertising system origin and the contact is displayed in a view that is the standard\native contact view applicable to the email client in question. Returning to step 3120, for email clients with the advertising system email add-in control moves to step 3123, again, here the email client will synchronise the local address book with the server-side address book as defined by the server\client settings, and any new (or updated) contacts irrespective of origin will be imported. If the user is not logged in, control moves to step 3124 and the user is prompted to log into their advertising system user account. Step 3124 is to ensure that the user wants to import advertising system originate contact cards, because in the instance of using a shared computer\device i.e. within an internet café, the user may not want to retrieve their advertising system contacts, or may unintentionally do so which is another means for the security of downloaded cards to be compromised (e.g. brute-force) by other users of the shared computer\device. With the login satisfied, control moves to step 3125 where the email add-in detects any new or updated contacts within the address book. For new contact cards i.e. contacts that don't exist in the advertising system software local installation, Control moves to step 3126 where the new contact cards are imported into the local instance of the advertising system software. For existing contact cards that are detected during the scanning process at step 2125, control moves to step 3127 to initiate the process where the version, date-time stamps and\or data difference of each existing contract card is compared with its counterpart stored within the advertising system software. Control moves to step 3128 where the email add-in verifies the results for each comparison. If there is an updated version of the contact card, control moves to step 3129 where the email add-in overwrites the earlier version with the latest version. The email add-in may backup the earlier version to allow the user to visual compare the differences between the versions of the contact card. For contact cards that are duplicate control moves to step 3130 where the duplicate cards are renamed e.g. filename may be appended with ‘_bak’, and the duplicate will be moved or purged depending on the option chosen by the user. Once the scanning for new/updated/duplicated cards has been completed, control moves to step 3131. At Step 3131 the email add-in in conjunction with the advertising system software verifies or reaffirms the version, validity, the authenticity, user's access rights and version for each contact card. Control then moves to step 3132 whereby the advertising system software checks for the latest version of the contact card. Step 3132 is necessary at this point as the user may not have used the shared device for some time and the locally stored version of the contact card may be out-dated. If the contact card it out-dated, control moves to Step 3133 whereby the advertising system software initiates the update process and retrieves the latest contact card data. Once the contact card is at the latest version, if not already, control moves to step 3134 where the advertising system software checks the authenticity (e.g. checksum). If the contact card is authentic, control moves to step 3135 where the advertising system software checks that each contact card has not expired. If either check from step 3134 or step 3135 fails control moves from the respective step to step 3136 whereby the advertising system email add-in blocks the contact card from being viewed and\or may display a warning notice to the user highlight what security checks have failed. In the event that the checks and measures from the step 3134 and step 3135 pass the tests (e.g. expiry date, checksum), control moves to step 3137. Step 3137 is a check pertaining to the privacy settings applied to the contact card and to verify that the user has access rights to view the contact card. Control moves to step 3143 if the user is has access rights to the contact card, whether this access be due to a public contact card or the users have previously satisfied the PIN restriction or has previously requested and subsequently been granted access by the contact card owner. If the user does not have access to the contact card control moves to step 3138 and depending on the privacy settings restrictions applied to the card the user is presented with a choice to request access and\or enter a PIN or password to view the card, whichever is applicable. Control moves to step 3192 where the user is asked whether or not to request access. If the user declines to the option to request access control moves to step 3155, however if the user requests access control moves to step 3140. At step 3140 the advertising system software sends a request via notification services and\or the management portal to the card owner with the basic information about the user who is requesting access. Control moves to step 3141 whereby the owner accepts or rejects the user's request for access. If the owner rejects the request control moves to step 3136 whereby the advertising system email add-in blocks the contact card from being viewed and\or may display a warning notice to the user highlighting what security checks have failed. If the owner approves access control moves to step 3142 whereby the advertising system software on the user's computer\device next polls the advertising system for any updates, approval to view the contact card will be set. Once the approval ‘flag’ has been set for the relevant contact card, control moves to step 3143 whereby the user can now open and view the contact card in its native advertising system template view as depicted by FIG. 12. Control moves to step 3155 to complete the first scenario. In the second scenario where users and customers are using an online\web email client to interact with their respective email server control moves from step 3120 to 3144 and control moves to 3145, whereby users and computer can view the advertising system contact cards via their web email client's default contact\address book layout. Control moves to 3155 to complete the first scenario. In the third scenario where the user's address book is shared amongst other networked users of the same email server, control moves from step 3120 to 3149 to being this scenario. Control moves to step 3150 where the email add-in checks the privacy settings applied to each advertisement system contact card. If the contact is private, control moves to step 3151 whereby the native email client's privacy settings, set via the email add-in, will prevent network users from viewing private contacts. For each contact card that is not private, control moves to either 3153 or 3154 whether or not the network user has the advertising system software and email add-in installed or not. Control moves to step 3152 if the network user email client with advertising system software and email add-in accesses address book, then control moves to 3153 whereby if and when a network user opens a shared contact card, the contact is displayed in the advertisement template view (see, for example, FIG. 13). Alternatively, control moves to step 3154 if the network users' email client does not have the advertising add-in accesses address book, control moves to step 3122 whereby if and when a network user opens a shared contact card, the Contact is displayed in the email client's default contact view. For the instance of an email server with the advertising system software integration, the control begins with step 3146 whereby the email server administrator may download and install the Advertising system software on the email server to integrate advertising system software and by doing so, control moves to step 3147. At step 3147, the email administrator configures the now integrated advertising system software, which provides additional and efficient functions for communication with advertisement system. Such functions and efficiency are, for example, allows for the onsite caching for downloaded advertising system business cards and advertisements, which saves on internet bandwidth and cost; Lightweight Directory Access Protocol (LDAP) configuration to allow for the seamless creation of business cards when a new user is added to the businesses' network and/or email server; LDAP configuration also allows for the seamless management and updating of advertisements, typically business cards in this example; and, as reference to by Step 3148, the integration allows for the display of advertisements within the web-access portal.

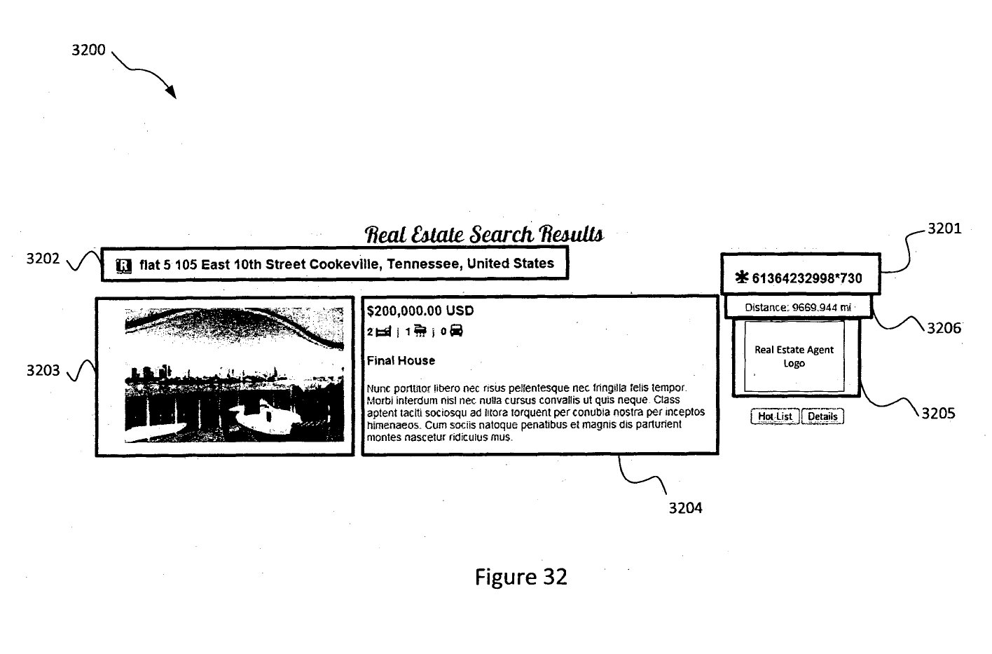

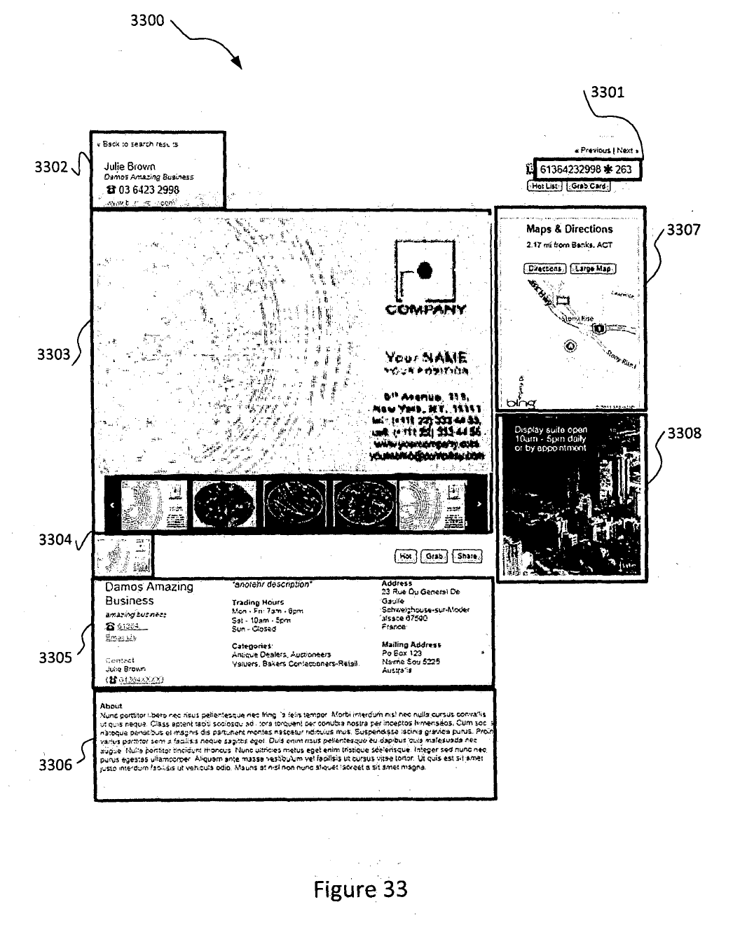

FIG. 32 is an example screen shot 3200 of a web browser search result preview based upon an advertisement real estate card template according to the invention. Features displayed on this preview search result is the complete preview of an “exact match” search result, meaning only one (1) advertisement will be returned if a valid advertisement exists on the system. In the example shown, a customer has entered the advertisement code displayed at item 3201. In this example, the code's secondary identifier “730” begins with a ‘7’ and, a familiar user of the advertising system would have expected to see a real estate advertisement search result displayed. In this example given, if all secondary identifiers began with a ‘7’, only advertisements based upon a real estate template would be returned. Subsequently, a user can pre-empt what advertisement type will be returned, which can assist in determining the authenticity and security of the advertisements; if a non-real estate advertisement was returned the user would be wary to progress any further. Feature 3202 is the title for the advertisement, which is extracted from a mandatory, unchangeable data field, the address field, entered in at time of the real estate advertisement's creation. Feature 3203 is the feature image of the property uploaded by the user at time of advertisement creation. Whilst this image may be mandatory, it may be update\changed, but not removed. Feature 3204 is the short description input by the user at advertisement creation; it too can be updated, but not removed. Feature 3205 is a provision made for the real estate agent's logo, which may be an active section on the screen whereby the customer may ‘click’ on this logo (or URL shortcut) and a new web browser window/page may ‘pop-up’ and the real estate agent's ‘business card’, which currently resides on the advertising system can be displayed (see FIG. 33). It is important to note that this provides another security measure, which can be used to reassure the customer that the advertisement's creator (the user) is ‘traceable’ and the user has been verified and authenticated by the administrators of the advertising system. Feature 3206 is the distance to the advertisement's subject matter and in the example given is the distance to the house from the customer's current/chosen location.

FIG. 33 is an example screen shot a web browser displaying the details and features within an advertisement search result based upon a ‘business card’ advertisement template according to the invention. Feature 3301 is the advertisement code, comprising of the primary and secondary identifiers. Note the secondary identifier “263” begins with a ‘2’, which in this example, ‘2’ is associated with business card advertisements. Feature 3302 is a summary of the business card i.e. name, business name, phone number, web site URL. Feature 3303 is a picture and/or video display panel. The example shown is a common ‘filmstrip’ picture viewing control. All images/videos associated with an advertisement will be able to be viewed within this panel directly and/or can be opened and viewed within a new window. Feature 3305 is an area that displays advertisement details, which may be specific details extracted and shown as per the example, namely the business name, contact details, trading hours and addresses. Feature 3306 is the location where more details about the person and/or business they represent. In other advertisement template, this area would be used to display product information, specifications, features and the like. Feature 3307 is the location for an interact map displaying the geographical location of the address of the business or the location of the item for sale. Feature 3308 is a location that is mostly reserved for advertisement, both advertisements that belong to the advertising system, but may also be extended to include advertisement or social networking ‘feeds’ from third-parties.

1. A computer implemented method for generating advertisements including the steps of:
selecting from one or more advertisement templates;
selecting an advertisement type from the one or more advertisement templates;
associating one or more unique primary identifiers with the advertisement;
and associating a secondary identifier with each of the one or more unique primary identifiers.

2. The method of claim 1, wherein the secondary identifier is comprised of on one or more of: the advertising type, an advertising medium, a publication, a geographic location or an internal reference ID.

3. The method of claim 1, wherein the method further includes uploading content to the advertising template and storing content in a database on a computer network.

4. The method of claim 1, wherein the method further includes modifying uploaded content in response to a request.

5. The method of claim 4, wherein upon receiving modified uploaded content, the method further includes the steps of providing the modified content to one or more users who have engaged with the advertisement.

6. The method of claim 1, wherein the advertising type includes a business card, online advertisement, physical advertisement, coupon, recipe, attractions, events, tours, advertisements for real estate, motor vehicles, accommodation, business listings, business departments, business divisions, classified advertisements, product information and specifications, catalogue, newspaper, magazine advertisements, timetables, resume's, billboard advertisements, personal contact information, yard sale advertisements, advertisements for apps, air, rail, road and/or sea travel advertisements, points of interest, dating or social media profiles, newspaper articles, magazine articles, restaurant menus, television and/or radio advertisements.

7. The method of claim 1, wherein the method further includes the step of providing one or more privacy options associated with the advertisement.

8. The method of claim 1, wherein the method further includes the step of providing one or more privacy options associated with the unique primary identifier.

9. The method of claim 1, wherein the method further includes the step of indexing the advertisement in the database such that the advertisement is searchable over the computer network.

10. The method of claim 1, wherein the unique primary identifier is any one or more of: a telephone number or an alias code associated with the telephone number.

11. The method of claim 10, wherein the alias code is alphanumeric text.

12. The method of claim 1, wherein the method further includes the step of providing payment for the advertisement based on any one or more of: advertising type, number of images associated with an advertisement, changes to details of an existing advertisement, time and date range of the advertisement, position of advertisement, size of the advertisement or enhancements to the advertisement.

13. The method of claim 1, wherein the method further includes the step of associating geographic coordinates with the advertisement.

14. The method of claim 1, wherein the method further includes the step of determining a location, address or geographic coordinate and associating it with advertisement.

15. The method of claim 14, wherein the location, address or geographic coordinate is associated with the advertising content via one or more uploaded images, the uploaded images including geo-datum, extracting the geo-datum from each image and associating the geo-datum with the advertisement.

16. The method of claim 1, wherein the method further includes the step of dynamically updating an advertisement's geographical location via a GPS enabled device.

17. A method of obtaining information from an advertisement including the steps of:
receiving, via a mobile device, one or more unique primary identifiers and secondary identifiers, associated with one or more advertisements; and
storing the unique primary identifiers, secondary identifiers and GPS information on the mobile device.

18. The method of claim 17, wherein the one or more unique primary identifiers and secondary identifiers, associated with one or more advertisements are received on the mobile device via near field communication.

19. The method of claim 17, wherein the method further includes the retrieving via the unique primary identifier, advertisements associated with the unique primary identifier.

20. The method of claim 17, wherein the method further includes the step of selectively retrieving via the unique primary identifier, advertisements associated with the unique primary identifier based on GPS location.

21. The method of claim 17, wherein the method further includes the step of selectively retrieving via the unique primary identifier and secondary identifier, advertisements associated with the unique primary identifier based on a date range.

22. The method of claim 17, wherein the method further includes the step of selectively retrieving via the unique primary identifier and secondary identifier, advertisements associated with the unique primary identifier based on a time period.

23. A method of obtaining information from an advertisement including the steps of:
receiving, via a computing device, at least one primary identifier and at least one secondary identifier, associated with at least one advertisement; and
storing the unique primary identifier and secondary identifier on the computing device.

24. The method of claim 23, wherein the method further includes the retrieving via the unique primary identifier, advertisements associated with the unique primary identifier.

25. A method of retrieving analytic information related to one or more advertisements including the steps of:
providing one or more advertisements created according to the method of claim 1;
updating a database record each time a primary and secondary identifier associated with an advertisement is requested;
identifying the advertisement data from the primary identifier;
identifying analytical data from the secondary identifier;
storing the number of requests associated with the advertisement; and
providing analytical data based on the secondary identifier.

26. The method of claim 25, wherein the secondary identifier is comprised of on one or more of: the advertising type, an advertising medium, a publication, a geographic location or an internal reference ID.

27. The method of claim 25, wherein the database record is further updated with the date, time and geographic location of the advertisement request.

28. A system for generating advertisements including:
a client-server component for selecting from one or more advertisement templates;
the client-server component providing one or more advertisement type for selection from the one or more advertisement templates;
the client-server component associating one or more unique primary identifiers with the advertisement;
and the client-server component associating a secondary identifier with each of the one or more unique primary identifiers.

29. A system for obtaining information from an advertisement including:
a client-server component for receiving, via a mobile device, one or more unique primary identifiers and secondary identifiers, associated with an advertisement;
the client-server component storing the unique primary identifier, secondary identifiers and GPS information on the mobile device.

30. A system for obtaining information from an advertisement including:
a client-server component for receiving, via a computing device, at least one primary identifier and at least one secondary identifier, associated with at least one advertisement;
the client-server component storing the unique primary identifier and secondary identifier on the computing device.

31. A system for retrieving analytic information related to one or more advertisements including:
providing one or more advertisements created according to the system of claim 28;
a database component for updating a database record each time a primary and secondary identifier associated with an advertisement is requested;
the database component identifying advertisement data based on the primary identifier;
the database component identifying the analytical data based on the secondary identifier;
the database component storing the number of requests associated with the advertisement; and
the database component providing analytical data based on the secondary identifier.
